(19) United States
(12) Patent Application Publication
(10) Pub. No.: US 2026/0211504 A1
(43) Pub. Date: Jul. 23, 2026

(54) Inter-Channel Electrode Arrangement for Components Used to Detect Neuromuscular Signals

(71) Applicant: Meta Platforms Technologies, LLC, Menlo Park, CA (US)

(72) Inventors: Jess Brandon Pool, Garnet Valley, PA (US); Nathalie Therese Helene Gayraud, Long Island City, NY (US); Daniel Wetmore, Brooklyn, NY (US)

(21) Appl. No.: 19/574,156

(22) Filed: Mar. 20, 2026

Related U.S. Application Data
(63) Continuation of application No. 17/687,488, filed on Mar. 4, 2022.
(60) Provisional application No. 63/156,364, filed on Mar. 4, 2021.
(60) Provisional application No. 63/238,062, filed on Aug. 27, 2021.

(51) Int. Cl. G06F 3/01; G06F 1/16

(52) U.S. Cl. CPC G06F 3/015; G06F 1/163

(57) ABSTRACT

A system for shielding components used to detect neuromuscular signals is disclosed. The system includes a circuit board that includes a bottom surface coupled with a neuromuscular sensor, a top surface, positioned opposite the bottom surface, coupled with at least one analog component for processing neuromuscular signals detected by the neuromuscular sensor. The first side surface disposed between the top and bottom surfaces, and a second side surface, positioned opposite the first side surface, disposed between the top and bottom surfaces. The system further includes an electromagnetic (EM) shield that is shaped to surround (i) at least part of the first side surface of the circuit board, (ii) at least part of the second side surface of the circuit board, and (iii) the at least one analog component, the EM shield being configured to mitigate power line interference present in the neuromuscular signals.

### RELATED APPLICATIONS

This application is a continuation of U.S. patent application Ser. No. 17/687,488, filed Mar. 4, 2022, which claims priority to U.S. Provisional Application No. 63/156,364 filed Mar. 4, 2021, and to U.S. Provisional Application No. 63/238,062 filed Aug. 27, 2021, each of which is incorporated by reference herein in its respective entirety.

### TECHNICAL FIELD

The present disclosure relates generally to systems used to shield neuromuscular sensors used with wearable devices for sensing neuromuscular signals (e.g., used to determine motor actions that the user intends to perform with their hand), and more particularly, to arm-wearable (including wrist-wearable) devices including a wearable structure (e.g., a watch band) configured to be worn by a user and the wearable structure can include an electromagnetic shielding structure to shield neuromuscular sensors in a manner that can both minimize power line interference while also having a small enough thickness to ensure that the wearable structure remains thin and not bulky.

### BACKGROUND

Some wearable devices include sensors for sensing neuromuscular signals (e.g., surface electromyography signals) to allow the devices to predict motor actions a user intends to perform. These sensors can have different performance variances based on a variety of factors, including, e.g., demographic factors, such as age, body fat, hair density, skin moisture, tissue composition, anthropometric wrist variation (static), and anthropometric wrist variation during gesture (e.g., dynamic). The performance variances based on these variety of factors are not well understood in the art, which can create a number of challenges in designing wearable devices that can accurately sense neuromuscular signals, while also ensuring that the device has a socially-acceptable form factor and can be built using a fewer number of component parts. Current designs of wearable devices for sensing neuromuscular signals can be large and bulky, often including a large number of sensors to detect neuromuscular signals (and often including components used for electromagnetic shielding that can further exacerbate the bulkiness issues). The large and bulky wearable devices can be uncomfortable to a user and can also make the devices less practical and socially-acceptable for day-to-day use.

As such, it would be desirable to provide wearable devices with a user-friendly (and aesthetically-pleasing, such as a less bulky) form factor for sensing neuromuscular signals, including by using only as many sensors as are needed to detect neuromuscular signals to enable accurate predictions of motor actions, as well as using shielding structures that avoid the exacerbation of bulkiness issues.

### SUMMARY

The wearable device for sensing neuromuscular signals described herein makes use of pairs of sensors, which allows for optimal placement of a smaller number of sensors (relative to some current designs that include 20 or 30 or more sensors), which reduces the total number of sensors needed (e.g., from 20 or 30 sensors down to 12 sensors in one embodiment), and reduces the size of the form factor of the wearable device, and reduces the overall cost of the wearable device. These improvements allow for the wearable device to be designed such that it is comfortable, functional, practical, and socially acceptable for day-to-day use.

In some embodiments, the sensors for the wearable device can also make use of an electrode with an optimally-shaped design (e.g., including the spherical cap shape described herein) to ensure that the electrode does not cause discomfort to a user while it is sensing neuromuscular signals (e.g., the electrode can accurately detect the signals even at a shallow skin-depression depth, such as a depth of 0.8 mm). This also helps to advance the improvements allowing for a wearable device that can be designed such that it is comfortable, functional, practical, and socially acceptable for day-to-day use.

Further, the wearable devices described herein can also improve users' interactions with artificial-reality environments and also improve user adoption of artificial-reality environments more generally by providing a form factor that is socially acceptable and compact, thereby allowing the user to wear the device throughout their day (and thus making it easier to interact with such environments in tandem with (as a complement to) everyday life). In the descriptions that follow, references are made to artificial-reality environments, which include, but are not limited to, virtual-reality (VR) environments (including non-immersive, semi-immersive, and fully-immersive VR environments), augmented-reality environments (including marker-based augmented-reality environments, markerless augmented-reality environments, location-based augmented-reality environments, and projection-based augmented-reality environments), hybrid reality, and other types of mixed-reality environments. As the skilled artisan will appreciate upon reading the descriptions provided herein, the novel wearable devices described herein can be used with any of these types of artificial-reality environments.
(A1) In accordance with some embodiments, an arm-wearable device for sensing neuromuscular signals using pairs of sensors using a small and predetermined intra-channel separation distance is provided. The arm-wearable device includes a wearable structure configured to be worn by a user, six pairs of sensors configured to detect neuromuscular signals (e.g., travelling through the neuromuscular pathways within the user's wrist or forearm), and one or more processors. The wearable structure has an interior surface and an exterior surface, the interior surface being configured to contact a user's skin when the arm-wearable device is donned by the user. Each respective pair of the six pairs of sensors is aligned along a distinct widthwise segment of the interior surface to form a respective channel for detecting neuromuscular signals. A first pair of the six pairs of sensors is positioned at a first widthwise segment of the interior surface of the wearable structure (e.g., a widthwise segment of the widthwise segments 220a-220f as shown in FIG. 2D) such that when the wearable structure is worn by the user a portion of each respective sensor of the first pair extends beyond the interior surface of the wearable structure and contacts the user's skin above a first set of neuromuscular pathways of the user. A second pair, distinct from the first pair, of the six pairs of sensors is positioned at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin above a second set of neuromuscular pathways of the user. Sensors in the first and second pairs of the at least six pairs of sensors are spaced apart within respective widthwise segments of the interior surface of the wearable structure by a predetermined intra-channel separation distance of no more than 9 mm (e.g., separation distance d2 shown between sensor 118c and sensor 118i within widthwise segment 220f as shown in FIG. 2D). The one or more processors are configured to receive data about the neuromuscular signals to determine a motor action that the user intends to perform with their hand. Use of the predetermined intra-channel separation distance can also be employed in conjunction with the use of predetermined inter-channel separation distance (e.g., the separation distances between different channels as compared to the distances separating sensors within one channel). The use of inter-channel spacing distances is described in more detail below (e.g., in connection with FIGS. 29-35).
(A2) In some embodiments of A1, the predetermined intra-channel separation distance is approximately 7 mm (e.g., +/−. 2 to 0.3 mm of 7 mm, so between 6.7 to 7.3 mm).
(A3) In some embodiments of A1, the respective pairs of sensors in all the six pairs of sensors are spaced apart within respective widthwise segments of the interior surface of the wearable structure by the predetermined intra-channel separation distance.
(A4) In some embodiments of A3, the respective pairs of sensors in all of the six pairs of sensors are spaced apart within respective widthwise segments of the interior surface of the wearable structure by a predetermined intra-channel separation distance of approximately 7 mm (e.g., +/−0.2 to 0.3 mm of 7 mm, so between 6.7 to 7.3 mm).
(A5) In some embodiments of any of A1-A4, the first and second sets of neuromuscular pathways comprise the muscles used for moving each of the user's digits (e.g., including neuromuscular pathways that are on ventral and dorsal sides of the user's wrist including flexors responsible for causing each of the user's digits to move).
(A6) In some embodiments of any of A1-A5, at least two pairs of the six pairs of sensors are positioned on top of the user's wrist or forearm (e.g., the sensors of the at least two pairs of sensors make contact with a top of the user's forearm or wrist, as is shown for sensors 118a and 118b in FIG. 1A and FIG. 1C as these sensors are contact the top 135a of the user's wrist).
(A7) In some embodiments of A6, the first widthwise segment of the interior surface of the wearable structure and the second widthwise segment of the interior surface of the wearable structure are positioned such that when the wearable structure is worn by the user a portion of each respective sensor of the first pair and the second pair extends beyond the interior surface of the wearable structure and contacts the user's skin above the respective neuromuscular pathways on top of the user's wrist or forearm.
(A8) In some embodiments of any of A1-A5 and A7, at least two pairs of the six pairs of sensors are positioned on bottom of the user's forearm or wrist (e.g., the at least two pairs of sensors make contact with a bottom of the user's wrist 135b, as is shown for sensors 118e and 118d in FIG. 1C). In some embodiments, at least one pair of sensors positioned on bottom of the user's forearm or wrist can be separated by a second predetermined intra-channel separation distance that is distinct from the predetermined intra-channel separation distance. The second predetermined intra-channel separation distance can be less than the predetermined intra-channel separation distance, such as a value of approximately 4 mm (e.g., within +/−2 to 0.3 mm of 4 mm, so between 3.7 mm to 4.3 mm).
(A9) In some embodiments of any of A1-A8, a third pair of the six pairs of sensors is positioned at a third widthwise segment, distinct from the first and the second widthwise segments, of the interior surface of the wearable structure such that when the wearable structure is worn by the user a portion of each respective sensor of the third pair extends beyond the interior surface of the wearable structure and contacts the user's skin above a first subset of the second set of neuromuscular pathways of the user. And, a fourth pair of the six pairs of sensors is positioned at a fourth widthwise segment, distinct from the first, second, and third widthwise segments, of the interior surface of the wearable structure such that when the wearable structure is worn by the user a portion of each respective sensor of the fourth pair extends beyond the interior surface of the wearable structure and contacts the user's skin above a second subset of the second set of neuromuscular pathways of the user.
(A10) In some embodiments of any of A1-A9, the arm-wearable device further includes a pair of electrodes forming ground and shield. The pair being different from the six pairs of sensors, the pair of electrodes positioned on the wearable structure between the at least two pairs of the six pairs of sensors that are positioned on top of the user's wrist or forearm. The ground and shield electrodes in the pair of electrodes being spaced apart by an additional predetermined intra-channel separation distance (e.g., predetermined intra-channel separation distance d4 shown between sensor ground 120 and shield 210 as shown in FIG. 2D) that is larger than the predetermined intra-channel separation distance between respective electrodes of the first and second pairs of electrodes (e.g., as shown in FIG. 2D, d3 is depicted as having a relatively larger size than d2, e.g. d3 can be 15 mm while d2 is no more than 9 mm).
(A10.5) In some embodiments of any of A1-A9, the arm-wearable device further includes a pair of electrodes forming ground and shield, the pair of electrodes forming ground and shield positioned on the wearable structure between the first widthwise segment of the interior surface of the wearable structure and the second widthwise segment of the interior surface of the wearable structure.
(A11) In some embodiments of any of A1-A10.5, each sensor of the six pairs of sensors includes an internal shield enclosing one or more analog components configured to sense neuromuscular signals, and each respective internal shield is distinct from the shield in the pair of electrodes forming ground and shield. Additional details concerning structure and function of an example of the internal shield are provided below in reference to I1-I17, as well as in connection with the illustrations and descriptions of FIGS. 20-28.
(A12) In some embodiments of any of A1-A11, at least three pairs of the six pairs of sensors are positioned on bottom of user's forearm or wrist (e.g., as shown in FIG. 1C, four pairs of sensors (note that one sensor 118c-118f of each pair is visible in FIG. 1C based on the depicted viewpoint) are depicted as contact the bottom 135b of the user's wrist).
(A13) In some embodiments of any of A9-A12, a fifth pair of the six pairs of sensors is positioned at a fifth widthwise segment, distinct from the first, second, third, and fourth widthwise segments, of the interior surface of the wearable structure such that when the wearable structure is worn by the user a portion of each respective sensor of the fifth pair extends beyond the interior surface of the wearable structure and contacts the user's skin above a third subset of the second set neuromuscular pathways of the user.
(A14) In some embodiments of any of A1-A13, at least four pairs of the six pairs of sensors are positioned on bottom of the user's forearm or wrist.
(A15) In some embodiments of any of A13-A14, a sixth pair of the six pairs of sensors is positioned at a sixth widthwise segment, distinct from the first, second, third, fourth, and fifth widthwise segments, of the interior surface of the wearable structure such that when the wearable structure is worn by the user a portion of each respective sensor of the sixth pair extends beyond the interior surface of the wearable structure and contacts the user's skin above a fourth subset of the second set neuromuscular pathways of the user.
(A16) In some embodiments of any of A1-A15, the wearable structure has a fixed size so that the respective locations of the six pairs of sensors over the neuromuscular pathways remain substantially constant for different users each having substantially a same wrist circumference size.
(A17) In some embodiments of any of A1-A16, each sensor of the six pairs of sensors is a gold-plated electrode having a spherical cap shape with a radius of 5 mm (e.g., the gold-plated electrode with the spherical cap shape described in more detail below in reference to FIGS. 9A-9C, which can be used as the sensors for all of the sensors in the six pairs of sensors).
(A18) In some embodiments of any of A1-A17, each sensor of the six pairs of sensors extends beyond the interior surface of the wearable structure by a distance of at least 2 mm, such that when each sensor is depressed into the user's skin it reaches a skin-depression depth of at least 0.8 mm.
(A19) In some embodiments of any of A1-A18, the motor action is associated with one or more input commands, and the one or more processors are further configured to provide the one or more input commands associated with the motor action to a computing device to cause the computing device to perform the one or more input commands in an artificial-reality environment.
(A20) In some embodiments of any of A1-A18, the one or more processors are further configured to provide data regarding the motor action to a computing device to cause the computing device to interpret the motor action and perform the one or more input commands associated with the motor action in an artificial-reality environment.
(A21) In some embodiments of any of A1-A20, the motor action is associated with one or more interface control commands, and the arm-wearable device further includes a capsule including a display configured to present a user interface, and the one or more processors are further configured to cause the performance of the one or more user interface control commands in the user interface presented at the display based on the motor action.
(A22) In some embodiments of any of A1-A21, the six pairs of sensors are at least six pairs of sensors, including one of (i) exactly six pairs of sensors, (ii) exactly seven pairs of sensors, (iii) exactly eight pairs of sensors, (iv) exactly nine pairs of sensors, and (v) exactly ten pairs of sensors.
(B1) In accordance with some embodiments, a method for sensing neuromuscular signals using pairs of sensors with a small and predetermined intra-channel separation distance is provided. The method is performed at an arm-wearable device including (i) a wearable structure configured to be worn by a user, the wearable structure having an interior surface and an exterior surface, (ii) six pairs of sensors, each respective pair of the six pairs of sensors aligned along a distinct widthwise segment of the interior surface to form a respective channel for detecting neuromuscular signals, and (iii) one or more processors. The method includes contacting a user's skin with the interior surface when the arm-wearable device is donned by the user. The method includes detecting, by a first pair of the six pairs of sensors, neuromuscular signals at a first set of neuromuscular pathways of the user. The first pair of the six pairs of sensors is positioned at a first widthwise segment of the interior surface of the wearable structure such that when the wearable structure is worn by the user a portion of each respective sensor of the first pair extends beyond the interior surface of the wearable structure and contacts the user's skin above the first set of neuromuscular pathways of the user. The second pair of the six pairs of sensors is distinct from the first pair, and is positioned at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin above the second set of neuromuscular pathways of the user. The sensors in the first and second pairs of the at least six pairs of sensors are spaced apart within respective widthwise segments of the interior surface of the wearable structure by a predetermined intra-channel separation distance of no more than 9 mm. The method further includes receiving, by the one or more processors, data about the neuromuscular signals, and determining, by the one or more processors, a motor action that the user intends to perform with their hand.
(B2) In some embodiments of B1, the arm-wearable device is also configured in accordance with any of A2-A22.
(C1) In accordance with some embodiments, a method of manufacturing an arm-wearable device for sensing neuromuscular signals using pairs of sensors with a small and predetermined intra-channel separation distance is provided. The method includes providing a wearable structure configured to be worn by a user, the wearable structure having an interior surface and an exterior surface, the interior surface being configured to contact a user's skin when the arm-wearable device is donned by the user. The method also includes providing six pairs of sensors configured to detect neuromuscular signals, each respective pair of the six pairs of sensors aligned along a distinct widthwise segment of the interior surface to form a respective channel for detecting neuromuscular signals. A first pair of the six pairs of sensors positioned at a first widthwise segment of the interior surface of the wearable structure such that when the wearable structure is worn by the user a portion of each respective sensor of the first pair extends beyond the interior surface of the wearable structure and contacts the user's skin above a first set of neuromuscular pathways of the user. A second pair, distinct from the first pair, of the six pairs of sensors positioned at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin above a second set of neuromuscular pathways of the user. Sensors in the first and second pairs of the at least six pairs of sensors are spaced apart within respective widthwise segments of the interior surface of the wearable structure by a predetermined intra-channel separation distance of no more than 9 mm. The method includes providing one or more processors configured to receive data about the neuromuscular signals to determine a motor action that the user intends to perform with their hand.
(C2) In some embodiments of C1, the arm-wearable device is further configured in accordance with any of the arm-wearable devices of A2-A22.
(D1) In accordance with some embodiments, an arm-wearable device configured to perform one or more input commands based on user motor action is provided. The arm-wearable device includes a display configured to present a user interface. The arm-wearable device includes a wearable structure configured to be worn by a user, the wearable structure having an interior surface and an exterior surface, the interior surface being configured to contact a user's skin when the arm-wearable device is donned by the user. The arm-wearable device further includes six pairs of sensors configured to detect neuromuscular signals using pairs of sensors, each respective pair of the six pairs of sensors aligned along a distinct widthwise segment of the interior surface to form a respective channel for detecting neuromuscular signals. A first pair of the six pairs of sensors positioned at a first widthwise segment of the interior surface of the wearable structure such that when the wearable structure is worn by the user a portion of each respective sensor of the first pair extends beyond the interior surface of the wearable structure and contacts the user's skin above a first set of neuromuscular pathways of the user. A second pair, distinct from the first pair, of the six pairs of sensors positioned at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin above a second set of neuromuscular pathways of the user. Respective sensors in the first and second pairs of the at least six pairs of sensors are spaced apart within respective widthwise segments of the interior surface of the wearable structure by a predetermined intra-channel separation distance of no more than 9 mm. The arm-wearable device further includes one or more processors configured to receive data about the neuromuscular signals to determine the motor action that the user intends to perform with their hand, the motor action being associated with one or more user interface control commands. The one or more processors are further configured to cause the performance of the one or more user interface control commands in the user interface presented at the display based on a determined motor action.
(D2) In some embodiments of D1, the motor action is associated with one or more input commands, and the one or more processors are further configured to provide the one or more input commands to a computing device to cause the computing device to perform the one or more input commands.
(D3) In some embodiments of D1, the motor action is associated with one or more input commands, and the one or more processors are further configured to provide the motor action to a computing device to cause the computing device to perform the one or more input commands associated with the motor action.
(D4) In some embodiments of any of D1-D3, the arm-wearable device is configured in accordance with any of A2-A22 described above.
(E1) In accordance with some embodiments, a system for performing one or more commands at a computing device based on neuromuscular signals sensed by an arm-wearable device is provided. The system includes an arm-wearable device and the computing device. The arm-wearable device includes a wearable structure configured to be worn by a user, the wearable structure having an interior surface and an exterior surface, the interior surface being configured to contact a user's skin when the arm-wearable device is donned by the user. The arm-wearable device includes six pairs of sensors configured to detect neuromuscular signals, each respective pair of the six pairs of sensors aligned along a distinct widthwise segment of the interior surface to form a respective channel for detecting neuromuscular signals. A first pair of the six pairs of sensors positioned at a first widthwise segment of the interior surface of the wearable structure such that when the wearable structure is worn by the user a portion of each respective sensor of the first pair extends beyond the interior surface of the wearable structure and contacts the user's skin above a first set of neuromuscular pathways of the user. A second pair, distinct from the first pair, of the six pairs of sensors positioned at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin above a second set of neuromuscular pathways of the user. Respective sensors in the first and second pairs of the at least six pairs of sensors are spaced apart within respective widthwise segments of the interior surface of the wearable structure by a predetermined intra-channel separation distance of no more than 9 mm. The arm-wearable device further includes one or more processors configured to receive data about the neuromuscular signals, determine a motor action that the user intends to perform with their hand, the motor action being associated with one or more commands, and provide the one or more commands associated with the motor action to the computing device. The computing device provides an augmented reality environment and is configured to perform one or more actions in the augmented reality environment based on the one or more commands provided by the arm-wearable device.
(E2) In some embodiments of E1, the arm-wearable device in the system is configured in accordance with any of A2-A22 described above.

Having summarized the use of a small and predetermined intra-channel separation distance for neuromuscular sensors of an arm-wearable device, another aspect will now be summarized that relates to an advantageous design for an electrode that can be used as one or more of the neuromuscular sensors (e.g., as a part of one of the arm-wearable devices discussed above).
(F1) In accordance with some embodiments, an electrode for sensing neuromuscular signals is provided. The electrode includes an area of electrically conductive material shaped to have a cylindrical body shape and a spherical cap shape. A portion of the area of the electrically conductive material that is shaped to have the spherical cap shape is configured to contact the user's skin to sense neuromuscular signals travelling to the user's hand. When the portion of the area of the electrically conductive material that is shaped to have the spherical cap shape is contacting the user's skin at a first skin-depression depth, a first impedance value is present between the electrode and the user's skin. For purposes of this disclosure, a skin-depression depth is a distance between a point on the user's skin when that skin is not being depressed and the same point on the user's skin when that skin is being pushed down (e.g., depressed) by the portion of the area of the electrically conductive material that is shaped to have the spherical cap shape. This concept is illustrated in FIGS. 10A-10D, which are described below. When the portion of the area of the electrically conductive material that is shaped to have the spherical cap shape is contacting the user's skin at a second skin-depression depth that is larger than the first skin-depression depth, a second impedance value is present between the electrode and the user's skin. When the portion of the area of the electrically conductive material that is shaped to have the spherical cap shape is contacting the user's skin at a third skin-depression depth that is larger than the first and second depths, the second impedance value remains present between the electrode and the user's skin.
(F2) In some embodiments of F1, the second skin-depression depth is 0.8 mm.
(F3) In some embodiments of any of F1-F2, wherein the electrode is configured to re-establish a skin-depression depth of at least 0.8 mm once a user moves their hand in order to stabilize impedance value at a shallow skin depth.
(F4) In some embodiments of any of F1-F3, the cylindrical body portion of the area of electrically conductive material includes an electrical shielding, such that when the user's skin contacts the cylindrical body portion, an impedance value at the electrode is substantially unaffected.
(F5) In some embodiments of any of F1-F4, the electrode is a gold-plated electrode.
(F6) In some embodiments of any of F1-F5, the electrode further includes a connection component configured to allow a removable connection between the electrode and a wearable structure of a wearable device worn by a user.
(F7) In some embodiments of F6, the wearable device is a device that is in communication with one or more processors (e.g., local to the wearable device or remotely located at a separate head-mounted display or other processing device), the one or more processors configured to detect motor actions intended to be performed by the user based on the sensed neuromuscular signals.
(F8) In some embodiments of F7, the detected motor actions can be interpreted by the one or more processors as gestures for causing performance of an action within (i) a display that is coupled with the exterior surface of the wearable structure and/or (ii) an artificial reality environment being presented via a head-mounted display that is separate from the wearable device.
(F9) In some embodiments of any of F1-F8, the electrode is paired with another electrode having a same structure as the electrode to create a channel for sensing neuromuscular signals, and the electrode and the other electrode are coupled with an arm-wearable device.
(F10) In some embodiments of F9, the electrode and the other electrode are removably coupled with the arm-wearable device.
(F11) In some embodiments of any of F1-F10, the electrode is configured to be pressed into the user's skin by way of a spring, the spring having a pogo spring rate of 100 g/mm or less (in some embodiments, the pogo spring rate is reduced to 60 g/mm. These values are significantly lower than other springs used with current neuromuscular sensors, which can have pogo spring rates up to 260 g/mm. By using a much smaller pogo spring rate, the designs described herein help to ensure that user's do not feel discomfort while wearing the wearable (e.g., discomfort caused by the electrode pushing into the user's skin too forcefully).
(G1) In accordance with some embodiments, a method of manufacturing an electrode for sensing neuromuscular signals is provided. The method includes forming the electrode with an area of electrically conductive material shaped to have a cylindrical body shape and a spherical cap shape. A portion of the area of the electrically conductive material that is shaped to have the spherical cap shape is configured to contact the user's skin to sense neuromuscular signals travelling to the user's hand. When the portion of the area of the electrically conductive material that is shaped to have the spherical cap shape is contacting the user's skin at a first skin-depression depth, a first impedance value is present between the electrode and the user's skin. When the portion of the area of the electrically conductive material that is shaped to have the spherical cap shape is contacting the user's skin at a second skin-depression depth that is larger than the first skin-depression depth, a second impedance value is present between the electrode and the user's skin. When the portion of the area of the electrically conductive material that is shaped to have the spherical cap shape is contacting the user's skin at a third skin-depression depth that is larger than the first and second depths, the second impedance value remains present between the electrode and the user's skin.
(G2) In some embodiments of G1, the electrode is further configured in accordance with any of the electrode devices of F2-F11.

While A1-A22 (and other aspects) discussed the user of at least six pairs of neuromuscular sensors, some arm-wearable devices can make use of any number of pairs of sensors, while still taking advantage of the use of the small and predetermined intra-channel separation distance noted above. This will now be briefly summarized.
(H1) In accordance with some embodiments, an arm-wearable device for sensing neuromuscular signals using pairs of sensors that each forms a respective neuromuscular-sensing channel is provided. The arm-wearable device includes a wearable structure configured to be worn by a user, pairs of sensors configured to detect neuromuscular signals (e.g., travelling through the neuromuscular pathways within the user's wrist or forearm), and one or more processors. The wearable structure has an interior surface and an exterior surface, the interior surface being configured to contact a user's skin when the arm-wearable device is donned by the user. Each respective pair of the pairs of sensors is aligned along a distinct widthwise segment of the interior surface to form a respective channel for detecting neuromuscular signals. A first pair of the pairs of sensors is positioned at a first widthwise segment of the interior surface of the wearable structure (e.g., a widthwise segment of the widthwise segments 220a-220f as shown in FIG. 2D) such that when the wearable structure is worn by the user a portion of each respective sensor of the first pair extends beyond the interior surface of the wearable structure and contacts the user's skin above a first set of neuromuscular pathways of the user. A second pair, distinct from the first pair, of the pairs of sensors positioned at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin above a second set of neuromuscular pathways of the user. Respective sensors in the first and second pairs of the pairs of sensors are spaced apart within the respective segments of the interior surface of the wearable structure by a predetermined intra-channel separation distance of no more than 9 mm (e.g., predetermined intra-channel separation distance d2 shown between sensor 118c and sensor 118i within widthwise segment 220f as shown in FIG. 2D). The one or more processors are configured to receive data about the neuromuscular signals to determine a motor action that the user intends to perform with their hand.
(H2) In some embodiments of H1, the pairs of sensors include a third pair and a fourth pair. The third pair, distinct from the first and second pair, of the pairs of sensors is positioned at a third widthwise segment, distinct from the first and second widthwise segments, of the interior surface of the wearable structure such that when the wearable structure is worn by the user the portion of each respective sensor of the third pair extends beyond the interior surface of the wearable structure and contacts the user's skin above a third set of neuromuscular pathways of the user. The fourth pair, distinct from the first, second, and third pair, of the pairs of sensors is positioned at a fourth widthwise segment, distinct from the first, second, and third widthwise segments, of the interior surface of the wearable structure such that when the wearable structure is worn by the user a portion of each respective sensor of the fourth pair extends beyond the interior surface of the wearable structure and contacts the user's skin above a fourth set of neuromuscular pathways of the user. Respective sensors in the third and fourth pairs of the pairs of sensors are spaced apart within respective widthwise segments of the interior surface of the wearable structure by a predetermined intra-channel separation distance of no more than 9 mm.
(H3) In some embodiments of any of H1-H2, the pairs of sensors include at least six pairs of sensors.
(H4) In some embodiments of any of H1-H2, the pairs of sensors include at least eight pairs of sensors.
(H5) In some embodiments of any of H1-H4, the arm-wearable device is further configured in accordance with any of the arm-wearable devices of A2-A21 described above.

Having summarized the above aspects related to small and predetermined intra-channel separation distances for arm-wearables, as well as advantageous designs for neuromuscular sensors, now will be summarized certain aspects related to an advantageous shielding design/system for use with the neuromuscular sensors.
(I1) In accordance with some embodiments, a system for shielding components used to detect neuromuscular signals is provided. The system includes a circuit board and an electromagnetic (EM) shield. The circuit board includes a bottom surface coupled with a neuromuscular sensor; a top surface, positioned opposite the bottom surface, coupled with at least one analog component for processing neuromuscular signals detected by the neuromuscular sensor; a first side surface disposed between the top and bottom surfaces; and a second side surface, positioned opposite the first side surface, disposed between the top and bottom surfaces. The EM shield is shaped to surround at least part of the first side surface of the circuit board, at least part of the second side surface of the circuit board, and the at least one analog component, the electromagnetic shield being configured to mitigate power line interference present in the neuromuscular signals.
(I2) In some embodiments of I1, the EM shield surrounds all of the first side surface and all of the second side surface.
(I3) In some embodiments of any of I1-12, mitigating power line interference present in the neuromuscular signals includes reducing the power line interference present in the neuromuscular signals by at least 20% as compared to use of the neuromuscular sensor without the EM shield.
(I4) In some embodiments of any of I1-13, the at least one analog component is part of an analog front end that is configured to receive the neuromuscular signals in an analog format and convert them to a digital format.
(I5) In some embodiments of any of I1-14, the bottom surface of the circuit board is further coupled with an additional neuromuscular sensor, the neuromuscular sensor and the additional neuromuscular signal each providing sensed neuromuscular signals to the at least one analog component.
(I6) In some embodiments of I5, the EM shield further surrounds a portion of the additional neuromuscular sensor and the neuromuscular sensor.
(I7) In some embodiments of any of I1-16, the EM shield is formed sheet metal that surrounds all of the first side surface and all of the second side surface.
(I8) In some embodiments of I7, the formed sheet metal extends beyond the first side surface and the second side surface of the circuit board. In some embodiments, the formed sheet metal extends beyond a thickness of the circuit board surrounding a portion of the additional neuromuscular sensor and the neuromuscular sensor. In some embodiments, the formed sheet metal extends into a portion of the elastomer band.
(I9) In some embodiments of any of I1-16, the EM shield is a metallic layer formed by a metallic spray distributed over at least the top surface of the circuit board, the at least one analog component, all of the first side surface, all of the second side surface, and a portion of the bottom surface of the circuit board, and an insulative material is disposed between the metallic layer and the at least one analog component.
(I10) In some embodiments of any of I1-19, the system further includes an elastomer band that surrounds at least a portion of the circuit board. In some embodiments, the circuit board is placed within a formed elastomer band. In some embodiments, the elastomer band surrounds all of the circuit board.
(I11) In some embodiments of I10, the elastomer band is configured to be worn around a user's wrist and contact a portion of the user's skin. In some embodiments, the elastomer band is configured to be worn around a portion of the user's arm (e.g., bicep, elbow, forearm, etc.) and contact a portion of the user's skin.
(I12) In some embodiments of I11, the neuromuscular sensor is an electrode that contacts the user's skin above a respective neuromuscular pathway when the elastomer band is worn by the user.
(I13) In some embodiments of any of I10-112, the elastomer band separates the EM shield from the user's skin.
(I14) In some embodiments of any of I10-I12, the EM shield is a conductive elastomer that is formed over the top surface of the circuit board, the at least one analog component, all of the first side surface, all of the second side surface, a portion of the bottom surface of the circuit board. The conductive elastomer surrounds the neuromuscular sensor and extends to a portion of the elastomer band such that it is configured contact a portion of the user's skin when the elastomer band is worn around a user's wrist. The system further includes an insulative material is disposed over the at least one analog component between the conductive elastomer and the top surface of the circuit board. In some embodiments, the conductive elastomer has a thickness of 0.10 mm.
(I15) In some embodiments of any 110-112, the elastomer band is formed of a first portion and a second portion. The first portion is formed using a non-conductive elastomer and formed over the second portion, and the second portion is formed using a conductive elastomer. The second portion forms the EM shield that surround at least part of the first side surface of the circuit board, at least part of the second side surface of the circuit board, and the at least one analog component. The second portion is configured to contact a portion of the user's skin. The system also includes an insulative material disposed over the at least one analog component between the second portion of the elastomer band and the top surface of the circuit board. In some embodiments, the second portion of the elastomer band has a thickness of 0.40 mm.
(I16) In some embodiments of any I10-115, multiple pairs of neuromuscular sensors are positioned along respective widthwise segments of the elastomer band, each pair being shielded together with a respective EM shield.
(I17) In some embodiments of any I1-116, the at least one analog component is housed within a portion of the neuromuscular sensor.
(J1) In accordance with some embodiments, a method of forming a system for shielding components used to detect neuromuscular signals is provided. In some embodiments, the method includes providing a circuit board that includes a bottom surface coupled with a neuromuscular sensor; a top surface, positioned opposite the bottom surface, coupled with at least one analog component for processing neuromuscular signals detected by the neuromuscular sensor; a first side surface disposed between the top and bottom surfaces; and a second side surface, positioned opposite the first side surface, disposed between the top and bottom surfaces. The method further includes providing an electromagnetic (EM) shield. The EM shield is shaped to surround at least part of the first side surface of the circuit board, at least part of the second side surface of the circuit board, and the at least one analog component, the electromagnetic shield being configured to mitigate power line interference present in the neuromuscular signals.
(J2) In some embodiments of J1, the method further includes providing an elastomer band that surrounds at least a portion of the circuit board.
(J3) in some embodiments of any of J1-J2, the method includes manufacturing the system for shielding components used to detect neuromuscular signals such that it is further configured in accordance with any of the system for shielding components of I2-I17.
(J4) In another aspect, a wearable device is provided (which can be a head-worn wearable (e.g., smart glasses) or wrist-worn wearable (e.g., smart watch, which is an example of the arm-wearable devices summarized above and elsewhere herein) device) that includes one or more of the systems of any of (I1)-(117). In aspects in which the wearable device includes a detachable capsule or watch display portion, the detachable capsule or watch display portion can include one or more processors that are configured to process the neuromuscular signals mentioned in conjunction with any of (I1)-(I17).

As was briefly mentioned above, the use of predetermined inter-channel separation distances can also advantageously assist with ensuring the smaller numbers of sensors can be utilized, while still ensuring a high-level of gesture-detection accuracy and diversity. This aspect will now be briefly summarized below.
(K1) In accordance with some embodiments, an arm-wearable device for sensing neuromuscular signals using pairs of sensors is provided. The arm-wearable device includes a wearable structure configured to be worn by a user, the wearable structure having an interior surface that is configured to contact a user's skin when the arm-wearable device is donned by the user. The arm-wearable device further includes pairs of sensors configured to detect neuromuscular signals, including: a first pair of sensors that is positioned near the interior surface of the wearable structure between (i) a second pair of sensors and (ii) a third pair of sensors. The first and second pairs of sensors are separated along the interior surface of the wearable structure by a first predetermined inter-channel separation distance and the first and third pairs of sensors are separated by a second predetermined inter-channel separation distance, distinct from the first predetermined inter-channel separation distance. The arm-wearable device further includes one or more processors configured to receive data about the neuromuscular signals to determine a motor action that the user intends to perform with their hand. In some embodiments, the respective predetermined inter-channel separation distances are center-to-center distances measured between, e.g., a center of a respective sensor in the first pair and a center of a respective sensor in the second pair.
(K2) In some embodiments of K1, the first predetermined inter-channel separation distance is less than the second predetermined inter-channel separation distance.
(K3) In some embodiments of K1-K2, the first, second, and third pairs of sensors are a first group of sensors, and the arm-wearable device further includes a second group of sensors. The second group of sensors includes pairs of sensors configured to detect neuromuscular signals, including: a fourth pair of sensors that is positioned near the interior surface of the wearable structure between (i) a fifth pair of sensors and (ii) a sixth pair of sensors. The fourth and fifth pairs of sensors are separated along the interior surface of the wearable structure by the first predetermined inter-channel separation distance and the fourth and sixth pairs of sensors are also separated by the first predetermined inter-channel separation distance. In other words, many different pairs of sensors can utilize the first predetermined inter-channel separation distance, while one particular pair of sensors (e.g., the first pair of sensors) makes use of a second predetermined inter-channel separation distance that can be larger than the first predetermined inter-channel separation distance to ensure that there is sufficient sensor coverage over the muscle groups responsible for thumb movements (as is described more below).
(K4) In some embodiments of K3, the first and second groups of sensors are separated along the interior surface of the wearable structure by a third predetermined inter-channel separation distance, distinct from the first and second predetermined inter-channel separation distances.
(K5) In some embodiments of K1-K4, the arm-wearable device further includes a capsule that forms a portion of the interior surface of the wearable structure such that, when the wearable structure is worn by the user, a portion of the capsule contacts the user's skin. The first, second, and third pairs of sensors are a first group of sensors, and the arm-wearable device further includes a third group of sensors, the third group of sensors including pairs of sensors configured to detect neuromuscular signals, including: a seventh pair of sensors that is positioned near a first portion of an interior surface of the capsule and an eighth pair of sensors that is positioned near a second portion of the interior surface of the capsule. The seventh and eight pairs of sensors are separated along the interior surface of the capsule by a fourth predetermined inter-channel separation distance, distinct from the first, second, and third predetermined inter-channel separation distances.
(K6) In some embodiments of K5, the portion of the capsule that contacts the user's skin is an interior (interior in that it contacts the user's skin, and it can also be referred to as a bottom surface) surface of the capsule, and the capsule further includes an exterior portion opposite the interior surface. The exterior portion includes a display configured to present a user interface.
(K7) In some embodiments of K1-K6, the first predetermined inter-channel separation distance is between 10 mm and 13 mm, and the second predetermined inter-channel separation distance is between 10 mm and 18.2 mm.
(K8) In some embodiments of K1-K7, the third predetermined inter-channel separation distance is between 16.1 mm and 25 mm.
(K9) In some embodiments of K1-K8, the fourth predetermined inter-channel separation distance is approximately 18 mm (e.g., +/−2 to 0.3 of 18 mm, so 17.7 to 18.3 mm).
(K10) In some embodiments of K1-K9, all sensors in each respective pair of sensors are spaced apart within respective portions of the interior surface of the wearable structure by one predetermined intra-channel spacing range that applies to all of the respective pairs of sensors. This can also be a small separate distance, such as the value of no more than 9 mm that was summarized above (which can also be approximately 7 mm). Alternatively, in other embodiments, different pairs can have distinct separation distances between sensors.
(K11) In some embodiments of K10, the predetermined intra-channel spacing range is between 4 mm and 10 mm.
(K12) In some embodiments of K10-K11, the predetermined intra-channel spacing range is approximately 7 mm (e.g., +/−0.2 to 0.3 of 7 mm, so 6.7 to 7.3 mm).
(K13) In some embodiments of K1-K12, the data received about the neuromuscular signals from the predetermined number of pairs of sensors is used to determine, by the one or more processors, a motor action that the user intends to perform with their thumb.
(K14) In some embodiments of K1-K13, the data received about the neuromuscular signals from the predetermined number of pairs of sensors is used to determine, by the one or more processors, an input at a virtual directional pad (d-pad), a virtual key stroke, a click gesture, and handwriting.
(K15) In some embodiments of K14, the pairs of sensors are eight pairs of sensors, and the one or more processors determine an input at the virtual d-pad with an improved accuracy of at least 47 percent over a configuration that includes 6 pairs of sensors for sensing neuromuscular signals.
(K16) In some embodiments of K14-K15, the pairs of sensors are eight pairs of sensors, and the one or more processors determine a virtual key stroke with an improved accuracy of at least 20 percent over a configuration that includes 6 pairs of sensors for sensing neuromuscular signals.
(K17) In some embodiments of K14-K16, the pairs of sensors are eight pairs of sensors, and the one or more processors determine a click gesture with an improved accuracy of at least 40 percent over a configuration that includes 6 pairs of sensors for sensing neuromuscular signals.
(K18) In some embodiments of K14-K17, the pairs of sensors are eight pairs of sensors, and the one or more processors determine handwriting with an improved accuracy of at least 28 percent over a configuration that includes 6 pairs of sensors for sensing neuromuscular signals. In K15-K18, references to 6 pairs of sensors can refer to a device that only has 6 pairs of sensors and can also refer to a device that includes more than 6 pairs of sensors, but only 6 pairs of sensors are used to sense the neuromuscular signals at a particular point in time (in either case the use or presence of 6 pairs of sensors allows for comparing the improved gesture-detection accuracies of the use or presence of 8 pairs of sensors with the predetermined inter-channel spacing distances discussed herein, which inter-channel spacing the inventors have discovered as helping to achieve the improved gesture-detection accuracies described herein).
(L1) A method for determining a motor action that a user intends to perform with their hand is provided. The method is performed at an arm-wearable device configured in accordance with any of K1-K18. The method includes receiving data about neuromuscular signals from one or more pairs of sensors positioned near the interior surface of a wearable structure of the arm-wearable device and determining a motor action that the user intends to perform with their hand based on the data about neuromuscular signals.
(M1) A non-transitory, computer-readable storage medium is provided. The medium includes instructions that, when executed by an arm-wearable device configured in accordance with any of K1-K18, cause the wrist-wearable device to determine a motor action that the user intends to perform with their hand based on the data about neuromuscular signals.

Note that the various aspects or embodiments described above can be combined with any other aspects or embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features as the person of skill in this art will appreciate upon reading this disclosure.

FIGS. 1A-1C illustrate a wearable device for sensing neuromuscular signals using pairs of sensors, in accordance with some embodiments.

FIGS. 2A-2D illustrate different view of the wearable device, in accordance with some embodiments.

FIGS. 3A and 3B illustrate one or more components within a wearable structure of the wearable device, in accordance with some embodiments.

FIGS. 4A and 4B illustrate the wearable device's ability to sense neuromuscular signals based on the number of pairs of sensors used, in accordance with some embodiments.

FIGS. 5A and 5B illustrate examples of minimum separation distances between the sensors in a respective pair of pairs of sensors for accurately sensing neuromuscular signals, in accordance with some embodiments.

FIGS. 6A-6D illustrate different fixed sizes for a wearable structure of the wearable device, in accordance with some embodiments

FIGS. 7A and 7B provide an electrical schematic of the wearable device, in accordance with some embodiments.

FIG. 8 provides a cross sectional view of a capsule portion of a wearable device, in accordance with some embodiments.

FIGS. 9A-9C illustrate different cross-sectional views of an individual electrode of a wearable device, in accordance with some embodiments.

FIGS. 10A-10C illustrate differently-shaped sensors contacting a user's skin and associated performance characteristics in FIG. 10D, in accordance with some embodiments.

FIGS. 11A-11D illustrate alternate designs of the pairs of sensors, ground electrode, and shield electrode under the capsule portion of the wearable device, in accordance with some embodiments.

FIG. 12 illustrates an example electromechanical architecture used for detecting neuromuscular signals, in accordance with some embodiments.

FIGS. 13A-13D illustrate a system for performing one or more commands at a computing device with a display at which an action is performed based on the neuromuscular signals sensed by a wearable device, in accordance with some embodiments.

FIGS. 14A-14D illustrate another system for performing one or more commands at a computing device with a display at which an action is performed based on the neuromuscular signals sensed by a wearable device, in accordance with some embodiments.

FIG. 15 is a flow diagram illustrating a method for sensing neuromuscular signals using pairs of sensors, in accordance with some embodiments.

FIG. 16 is a flow diagram illustrating a method of manufacturing a wearable device for sensing neuromuscular signals using pairs of sensors, in accordance with some embodiments.

FIG. 17 is a flow diagram illustrating a method of manufacturing an electrode for sensing neuromuscular signals, in accordance with some embodiments.

FIG. 18 is a block diagram illustrating the wearable device, in accordance with some embodiments.

FIGS. 19A and 19B illustrate block diagrams of a wearable device and an associated dongle, in accordance with some embodiments.

FIG. 20 illustrates a first embodiment of a shielding system for a wearable device, in accordance with various embodiments.

FIG. 21 illustrates a second embodiment of a shielding system for a wearable device, in accordance with various embodiments.

FIGS. 22A and 22B illustrate a third embodiment of a shielding system for a wearable device, in accordance with various embodiments.

FIGS. 23A and 23B illustrate a fourth embodiment of a shielding system for a wearable device, in accordance with various embodiments.

FIG. 24 illustrates a cross-section of a band portion of a wearable device and a plot including measurements of different shielding systems, in accordance with various embodiments.

FIGS. 25A-25D illustrate a first process of applying a metal spray to at least one analog component and a circuit board.

FIGS. 26A-26F illustrate a second process of applying a metal spray to at least one analog component and a circuit board.

FIGS. 27A and 27B are flow diagrams illustrating a method of manufacturing a shielding system for a wearable device, in accordance with some embodiments.

FIG. 28 illustrates a fifth embodiment of a shielding system for a wearable device, in accordance with various embodiments.

FIG. 29 illustrates a first embodiment of an 8-channel wearable device for sensing neuromuscular signals, in accordance with various embodiments.

FIG. 30 illustrates a second embodiment of an 8-channel wearable device for sensing neuromuscular signals, in accordance with various embodiments.

FIGS. 31A and 31B illustrate different fixed sizes of an 8-channel wearable device for sensing neuromuscular signals and associated tolerances for relative positions of each of the sensor channels around the circumference of the wrist, in accordance with various embodiments.

FIG. 32 illustrates sensor topology of an 8-channel wearable device for sensing neuromuscular signals, in accordance with various embodiments.

FIG. 33 illustrates measured improvements of different 8-channel wearable device configurations over a wearable device configuration that includes 6 pairs of sensors for sensing neuromuscular signals, in accordance with various embodiments.

FIG. 34 illustrates a comparison of the performance of an 8-channel wearable device configuration over a wearable device configuration that includes 16 pairs of sensors for sensing neuromuscular signals, in accordance with various embodiments.

FIG. 35 is a flow diagram illustrating a method for sensing neuromuscular signals using pairs of sensors using an 8-channel wearable device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

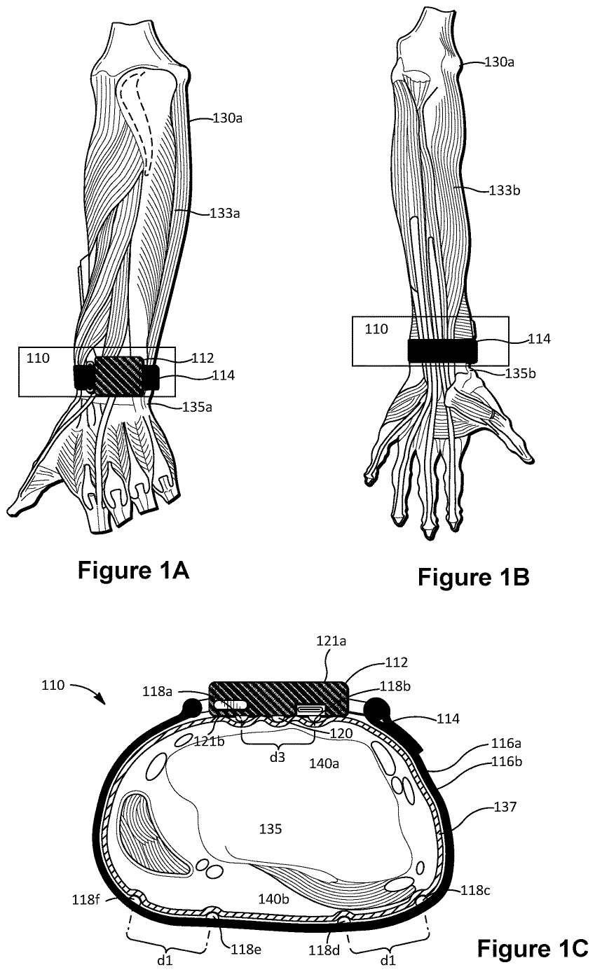

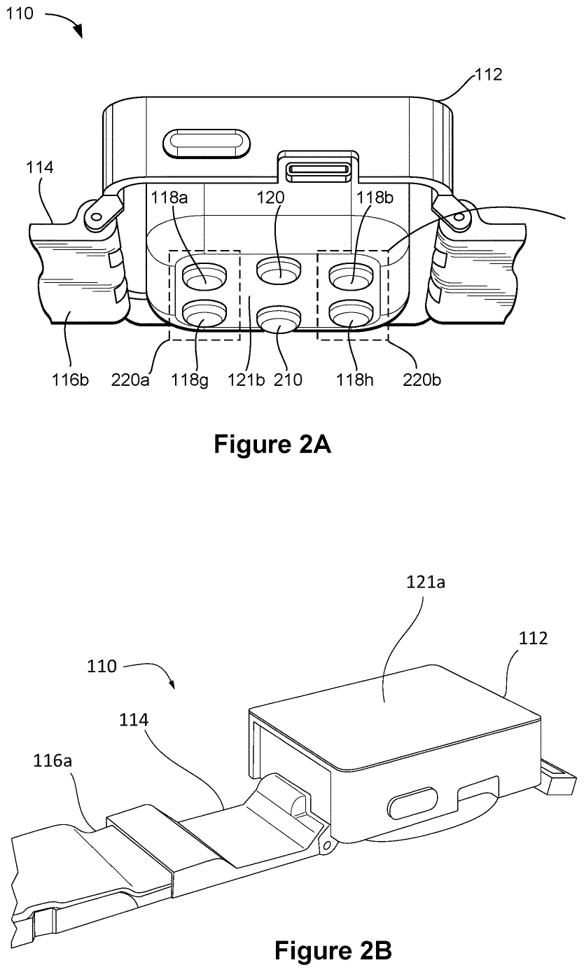

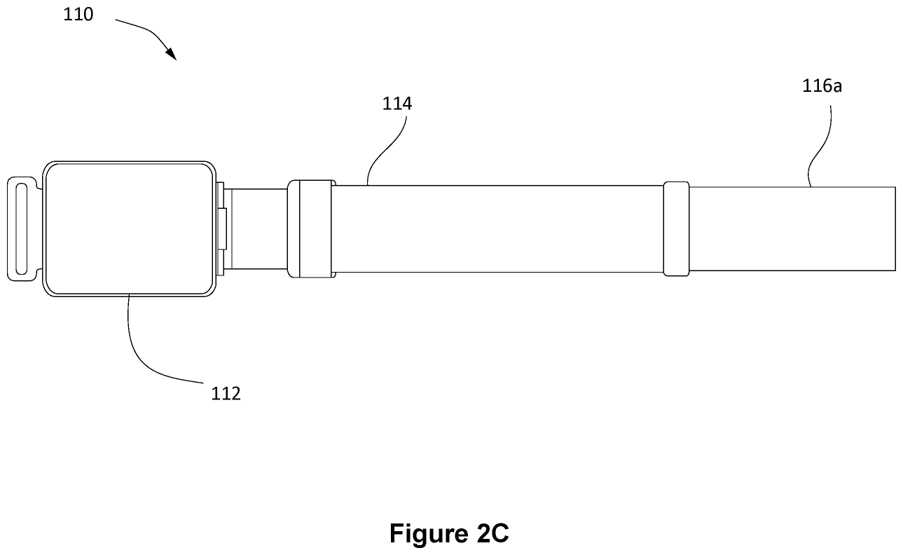

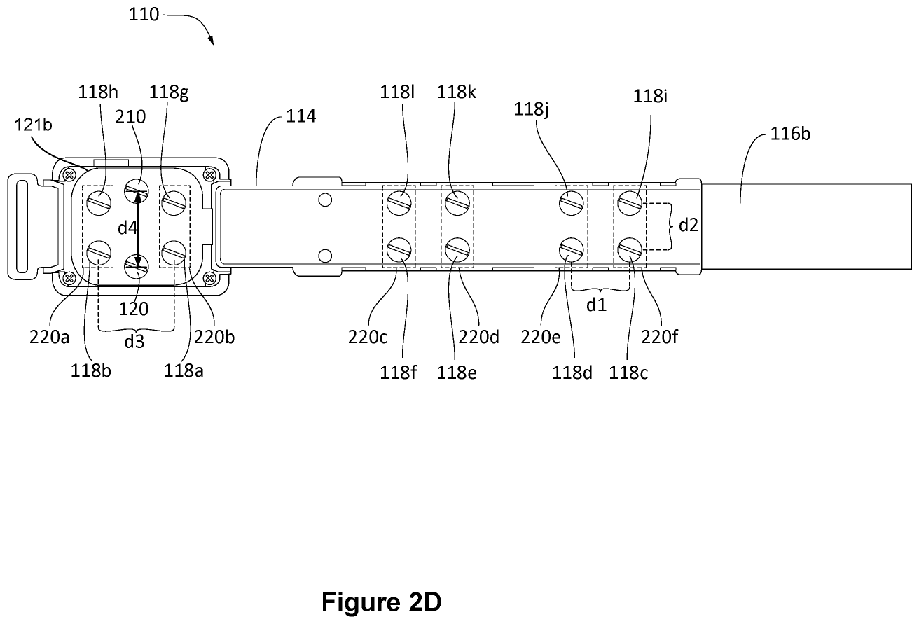

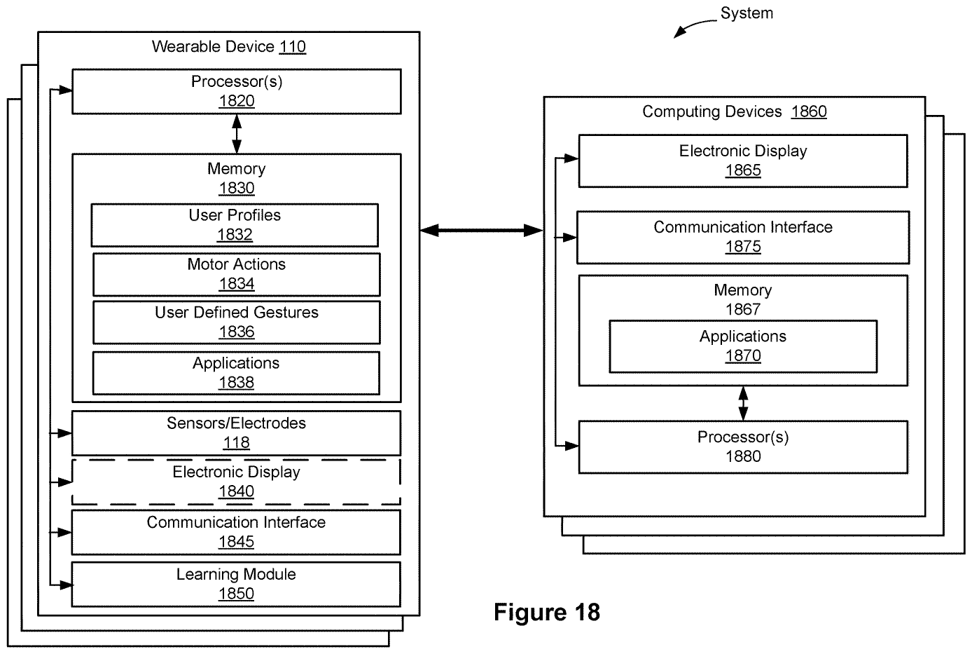

FIGS. 1A-1C illustrate a wearable device 110 (e.g., an arm-wearable device) for sensing neuromuscular signals using pairs of sensors, in accordance with some embodiments. The wearable device 110 includes a wearable structure (which can include a band portion 114, a capsule portion 112, and a cradle portion (not pictured) that is coupled with the band to allow for the capsule portion 112 to be removably coupled with the band portion 114) configured to be worn by a user, pairs of sensors configured to detect neuromuscular signals (e.g., one pair of sensors, three pairs of sensors, four pairs of sensors, or six pairs of sensors discussed below in reference to FIG. 2D). For embodiments in which the capsule portion 112 is removable, the capsule portion can be referred to as a removable structure, such that in these embodiments the wearable device includes a wearable portion (band portion and the cradle portion) and a removable structure (the removable capsule portion which can be removed from the cradle). As discussed in more detail in reference to FIG. 18 below, the wearable device 110 can also include one or more processors 1820 (e.g., the one or more processors 1820 may be included in a computing core or capsule portion 112. The one or more components of the wearable device 110 are discussed in turn below.

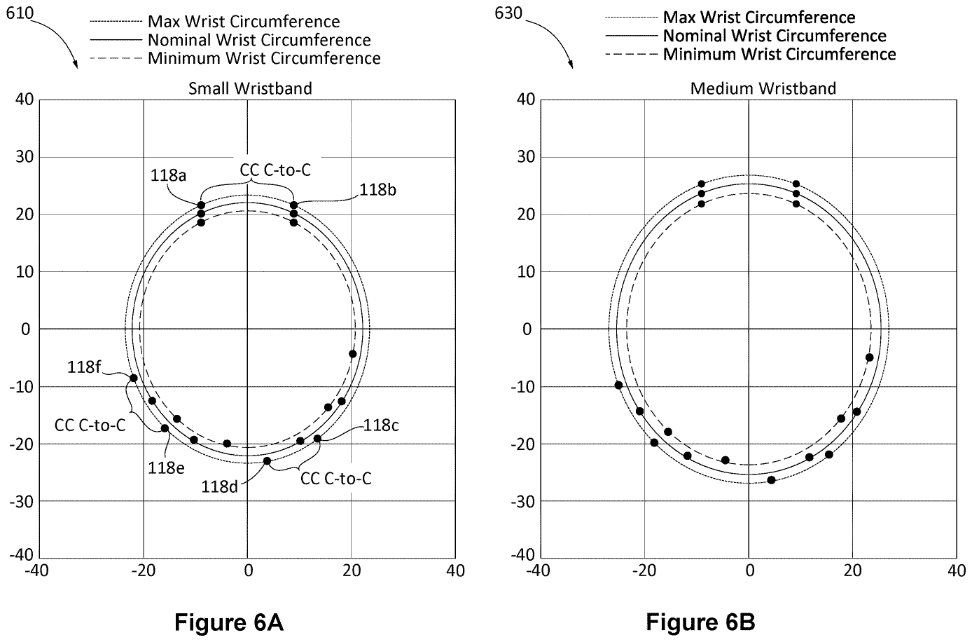

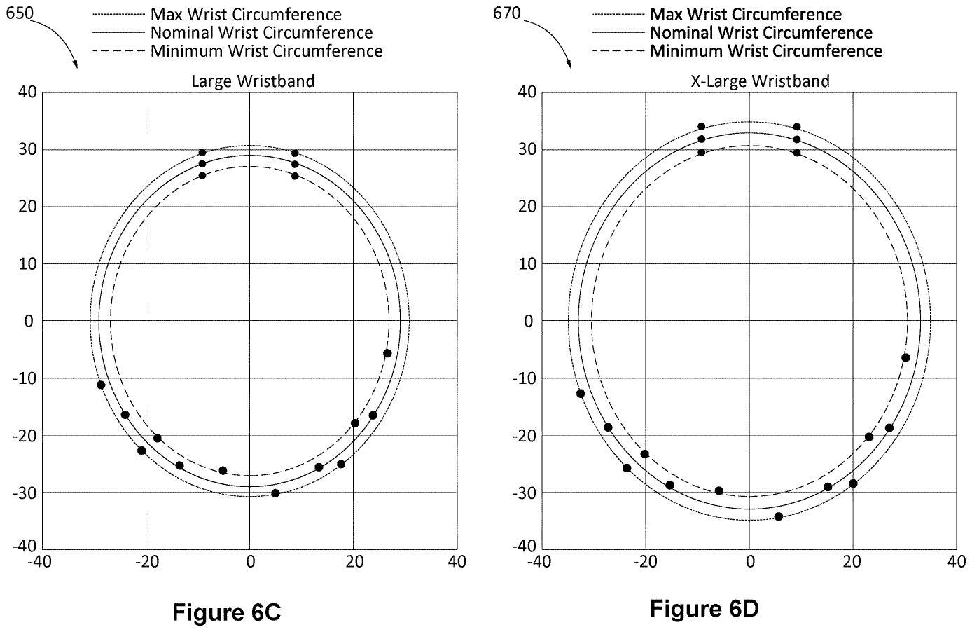

The wearable structure has an interior surface (which can include an interior band surface 116b, as well as an interior capsule surface 121b of the capsule portion) and an exterior surface (which can include an exterior band surface 116b, as well as an exterior capsule surface 121a of the capsule portion). The interior surface is configured to contact a user's skin 137 when the wearable device 110 is donned by the user (e.g., on user's arm as shown in dorsal arm view 130a and ventral arm view 130b of FIGS. 1A and 1B). In some embodiments, the wearable structure is configured to wrap around a user's wrist (e.g., dorsal wrist portion 135a and ventral wrist portion 135b as shown in FIGS. 1A and 1B). In some embodiments, the wearable structure has a fixed size (e.g., fixed circumferential size when the wearable structure surrounds a user's wrist when worn) so that the respective locations of the pairs of sensors over the muscle groups (e.g., dorsal muscles group and the ventral muscles group) is substantially constant or the same for different users each having substantially a same wrist circumference size (substantially means, in some embodiments, +/−1 to 2 mm in positional shift as different users wear the band). As discussed in more detail in reference to FIGS. 6A-6D, the wearable structure can be manufactured to have one of four fixed sizes, each associated with a different wrist circumference size. The muscle groups may be generally referred to as neuromuscular pathways 140. The dorsal muscles group and the ventral muscles group, for purposes of this disclosure, are generally referred to as a first set of neuromuscular pathways 140a and a second set of neuromuscular pathways 140b, respectively.

In some embodiments, the wearable device 110 includes a capsule portion 112 (referred to interchangeably as capsule or capsule portion 112). In some embodiments, the capsule 112 houses the one or more processors 1820. The capsule 112 can be a component part of the wearable structure (which can also include a band portion 114 and a cradle portion, as noted above). In particular, the capsule portion 112 is configured to be positioned on top of the user's wrist 135 or forearm 133 when the user is donning/wearing the wearable structure (with the band portion 114 surround a remainder of the user's wrist). As discussed below in FIGS. 2A-2D, in some embodiments, the capsule 112 includes one or more electrodes 118 (also referred to herein as sensors, neuromuscular sensors, or neuromuscular-signal sensors) such that when the capsule 112 is coupled to the wearable structure (either directly or by way of a removable connection to a cradle portion of the wearable structure), the one or more electrodes 118 of the capsule 112 operate in conjunction with electrodes 118 of a band portion 114 of the wearable structure. In some embodiments, the capsule 112 includes a display 1840 (FIG. 18) configured to present a user interface. In some implementations, the user interface includes one or more applications (or “apps” 1838; examples provide below in reference to FIG. 18), such as a clock, a calendar, a calculator, social media platforms, games, an email client, a browser, and/or other productivity and/or entertainment applications. Alternatively, in some embodiments, the capsule 112 does not include a display 1840 (and is used to house and protect the one or more processors 1820 as well as other components of the wearable device 110 discussed below in reference to FIG. 18).

While some of the examples discussed herein refer to the capsule portion 112 including a certain number of pairs of electrodes (e.g., two pairs of neuromuscular-signal-sensing electrodes and a pair of ground and shield electrodes) and the band portion 114 also include a certain number of pairs of electrodes (e.g., four pairs of neuromuscular-signal-sensing electrodes), one of skill in this art will appreciate that this example arrangement could be altered such that some of the pairs of electrodes on the capsule portion 112 are coupled with a cradle portion of the wearable structure instead (such that all or a portion of the pairs of electrodes are on the capsule and a remainder (or no) electrodes are coupled to the capsule).

Turning to FIG. 1C, each pair of the pairs of sensors aligns along a distinct widthwise segment of the interior surface 116b to form a respective channel for detecting neuromuscular signals. In some embodiments, each pair of sensors along a respective widthwise segment of the interior surface 116b forms a respective channel for sensing neuromuscular signals (e.g., such that the six pairs of sensors shown in widthwise segments 220a-220f of FIG. 2D form a six-channel arrangement for sensing neuromuscular signals). The neuromuscular signals travel through the neuromuscular pathways (e.g., first set of neuromuscular pathways 140a and second set of neuromuscular pathways 140b discussed below) within the user's wrist 135 (e.g., dorsal wrist portion 135a and ventral wrist portion 135b) or forearm 135 (e.g., dorsal forearm portion 133a and ventral forearm portion 133b).

The first set of neuromuscular pathways 140a and second set of neuromuscular pathways 140b include muscles (e.g., extensors and/or flexors) used for moving each of the user's digits. In some embodiments, first set of neuromuscular pathways 140a and second set of neuromuscular pathways 140b include neuromuscular pathways of the user's wrist 135 including extensors and flexors for the index and the middle digits. In some embodiments, the first set of neuromuscular pathways 140a are at a dorsal portion of the hand and/or wrist (e.g., upper portion of the hand) and are used to monitor extensor muscles. In some embodiments, the second set of neuromuscular pathways 140b are at a palmar portion of the hand and/or wrist (e.g., palm portion of the hand) and are used to monitor flexor muscles. In some embodiments, the first set of neuromuscular pathways 140a and the second set of neuromuscular pathways 140b allow for crosstalk such that a substantial number of extensor and flexor muscles are detectable.

For example, the first set of neuromuscular pathways 140a and/or second set of neuromuscular pathways 140b can allow for the detection of neuromuscular signals from one or more extensor muscles including one or more of extensor digiti minimi (which extends a pinky finger), extensor digitorum communis (which extends the medial four digits), extensor indicis (which extends an index finger), extensor pollicis longus (which extends a thumb), extensor carpi radialis (which extends a wrist in radial direction), and extensor carpi ulnaris (extends the wrist in ulnar direction). For example, the first set of neuromuscular pathways 140a and/or second set of neuromuscular pathways 140b can allow for the detection of neuromuscular signals from one or more flexor muscles including one or more of the flexor digitorum profundus (a muscle in the forearm of humans that flexes the digits), the flexor carpi radialis muscle (a muscle of the human forearm that acts to flex and (radially) abduct the hand), flexor carpi ulnaris muscle (a muscle of the forearm that flexes and adducts at the wrist joint), flexor Pollicis Brevis Muscle (a muscle in the hand that flexes the thumb), flexor digiti minimi Brevis Muscle of Hand (a hypothenar muscle in the hand that flexes the little digit (or pinkie digit) at the metacarpophalangeal joint), pronator quadratus (which controls roll movement of the wrist), flexor retinaculum of the hand (the roof of the carpal tunnel, through which the median nerve and tendons of muscles which flex the hand pass), the flexor digitorum superficialis muscle (whose primary function is flexion of the middle phalanges of the four digits (excluding the thumb) at the proximal interphalangeal joints, however under continued action it also flexes the metacarpophalangeal joints and wrist joint), and palmaris longus (which is not present in all humans). In some embodiments, the first set of neuromuscular pathways 140a and second set of neuromuscular pathways 140b provide neuromuscular signals for detecting hand movement, movement of one or more digits, gestures (e.g., pinch gestures in which one digit contacts another digit, clenching a hand (or forming a fist), etc.).

The neuromuscular signals are detected (or sensed) by electrodes 118 of one or more of the pairs of sensors. Each pair of the pairs of sensors includes two electrodes 118. Because only a single side of the wearable structure is visible in FIG. 1C, a single electrode of each pair of pair of sensors is visible from the depicted viewpoint (e.g., electrodes 118a-118f). In some embodiments, each pair of the pairs of sensors is positioned at a particular widthwise segment of the interior band surface 116b of the wearable structure such that when the wearable structure is worn by the user a portion of each respective sensor (e.g., electrode 118) of each pair extends beyond the interior band surface 116b of the wearable structure and contacts the user's skin 137 above a particular neuromuscular pathway (e.g., one or more neuromuscular pathways of the first set of neuromuscular pathways 140a or the second set of neuromuscular pathways 140b) of the user. For example, a third pair of the pairs of sensors (represented in FIG. 1C by electrode 118c) is positioned at a third widthwise segment of the interior band surface 116b of the wearable structure and extends beyond the interior band surface 116b of the wearable structure and contacts the user's skin 137 above a third subset of neuromuscular pathway of the second set of neuromuscular pathways 140b and a fourth pair of the pairs of sensors (represented in FIG. 1C by electrode 118d) is positioned at a fourth widthwise segment, distinct from the third widthwise segment, of the interior band surface 116b of the wearable structure and extends beyond the interior band surface 116b of the wearable structure and contacts the user's skin 137 above a fourth subset of neuromuscular pathways of the second set of neuromuscular pathways 140b. The fourth subset of neuromuscular pathways of the second set of neuromuscular pathways 140b can be distinct or the same as the third subset of neuromuscular pathways of the second set of neuromuscular pathways 140b. In some embodiments, adjacent pairs of sensors are separated by a predetermined distance d1. In some embodiments, pairs of sensors placed or coupled to the capsule 112 are separated by an additional predetermined distance d3, which can be the same or different than distance d1 for the pairs of sensors on the band portion 114 of the wearable structure. The different positions of the pairs of sensors (at widthwise segments of the interior surface 116b of the wearable structure) are discussed below in reference to FIGS. 2D and 5A-6B).

In some embodiments, at least two pairs of the pairs of sensors are positioned on top of the user's wrist (e.g., dorsal wrist portion 135a) or forearm (e.g., dorsal forearm portion 133a). For example, a first widthwise segment of the interior capsule surface 121b of the wearable structure, distinct from the third and fourth widthwise segments described above, can include a first pair of sensors (represented in FIG. 1C by electrode 118a) and a second widthwise segment of the interior capsule surface 121b of the wearable structure, distinct from the first, third, and fourth widthwise segments, can include a second pair of sensors (represented in FIG. 1C by electrode 118b) that is positioned such that when the wearable structure is worn by the user a portion of each respective sensor of the first pair and the second pairs extends beyond the interior capsule surface 121b of the wearable structure and contacts the user's skin 137 above the respective neuromuscular pathways (e.g., one or more neuromuscular pathways of the first set of neuromuscular pathways 140a) on top of user's wrist 135 or forearm 133. Alternatively, in some embodiments, one or more of the at least two pairs of the pairs of sensors that are positioned on top of the user's wrist or forearm (the sensors positioned along the third and fourth widthwise segments discussed above) can be coupled with a cradle portion of the wearable structure (instead of being coupled with the capsule portion of the wearable structure (such that when the capsule portion is removed from the cradle portion, the sensors that are coupled with cradle portion can continue to sense neuromuscular signals in some embodiments.

In some embodiments, at least two pairs of the pairs of sensors are positioned on bottom of user's wrist (e.g., ventral wrist portion 135b) or forearm (e.g., ventral forearm portion 133b). For example, continuing the example above, a third pair of the pairs of sensors (represented in FIG. 1C by electrode 118c) is positioned at a third widthwise segment and a fourth pair of the pairs of sensors (represented in FIG. 1C by electrode 118d) is positioned at a fourth widthwise segment, such that when the wearable structure is worn by the user a portion of each respective sensor of the third pair and the fourth pair extends beyond the interior band surface 116b of the wearable structure and contacts the user's skin 137 above the respective neuromuscular pathways (e.g., one or more neuromuscular pathways of the second set of neuromuscular pathways 140b) on bottom of the user's wrist 135 or forearm 133. In some embodiments, at least three pairs of the pairs of sensors are positioned on bottom of the user's forearm or wrist. For example, a fifth pair of the pairs of sensors (represented in FIG. 1C by electrode 118e) is positioned such that when the wearable structure is worn by the user (e.g., at a fifth widthwise segment distinct from the first, second, third, and fourth widthwise segments described above) a portion of each sensor of the fifth pair extends beyond the interior band surface 116b of the wearable structure and contacts the user's skin 137 above a respective neuromuscular pathways (e.g., one or more neuromuscular pathways of the second set of neuromuscular pathways 140b) on bottom of the user's wrist 135 or forearm 133. In some embodiments, at least four pairs of the pairs of sensors are positioned on the bottom of user's wrist 135 or forearm 133. For example, a sixth pair of the pairs of sensors (represented in FIG. 1C by electrode 118f) is positioned such that when the wearable structure is worn by the user (e.g., at a sixth widthwise segment distinct from the first, second, third, fourth, and fifth widthwise segments) a portion of each sensor of the sixth pair extends beyond the interior band surface 116b of the wearable structure and contacts the user's skin 137 above a respective neuromuscular pathways (e.g., one or more neuromuscular pathways of the second set of neuromuscular pathways 140b) on bottom of the user's wrist 135 or forearm 133.

The positions of the electrodes 118 shown in FIG. 1C are non-limiting. For example, in some embodiments, two electrodes 118 can be on the dorsal portion of the wrist and four electrodes 118 can be on the palmar portion of the wrist. In another embodiment, three electrodes 118 can be on the dorsal portion of the wrist and three electrodes 118 can be on the palmar portion of the wrist.

In some embodiments, the wearable device 110 includes a pair of electrodes forming ground 120 and shield 210 (shown in FIG. 2A). Because only a single side of the wearable structure is visible in FIG. 1C, only the ground electrode 120 is visible from the viewpoint of FIG. 1C. The pair of electrodes forming the ground 120 and shield 210 are different from the pairs of sensors. The pair of electrodes forming the ground 120 and shield 210 are positioned between the at least two pairs of the pairs of sensors that are positioned on top of the user's wrist 135a or forearm 133a (e.g., the ground and shield electrodes can be coupled to the capsule portion 120 or can be coupled to the cradle portion in some embodiments). For example, the pair of electrodes forming the ground 120 and shield 210 can be in between the first pair of sensors (represented in FIG. 1C by electrode 118a) and the second pair of sensors (represented in FIG. 1C by electrode 118b). The pair of electrodes forming the ground 120 and shield 210 are positioned such that when the wearable structure is worn by the user a portion of the ground 120 and shield 210 electrodes extends beyond the interior capsule surface 121b of the wearable structure and contacts the user's skin 137 above the respective neuromuscular pathways (e.g., one or more neuromuscular pathways of the first set of neuromuscular pathways 140a).

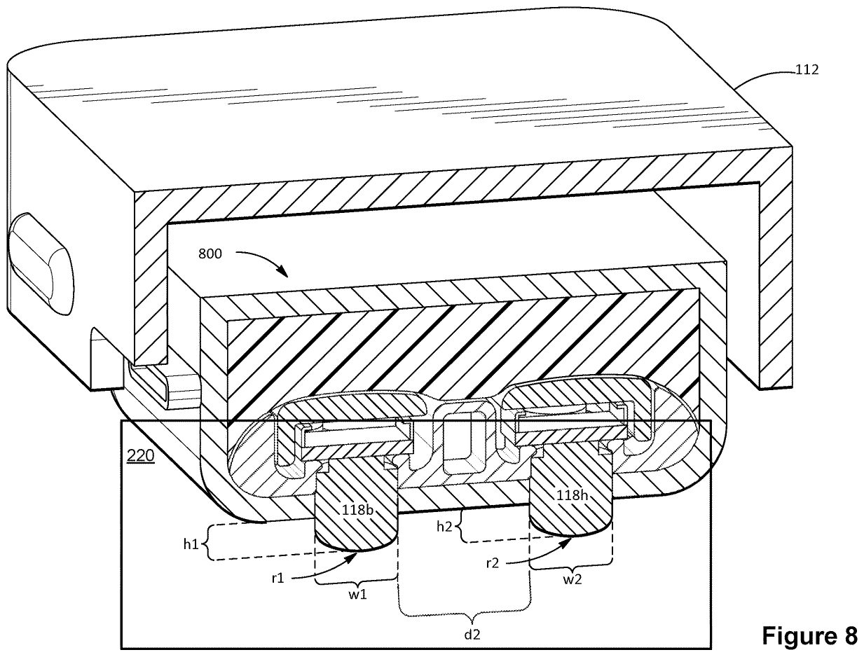

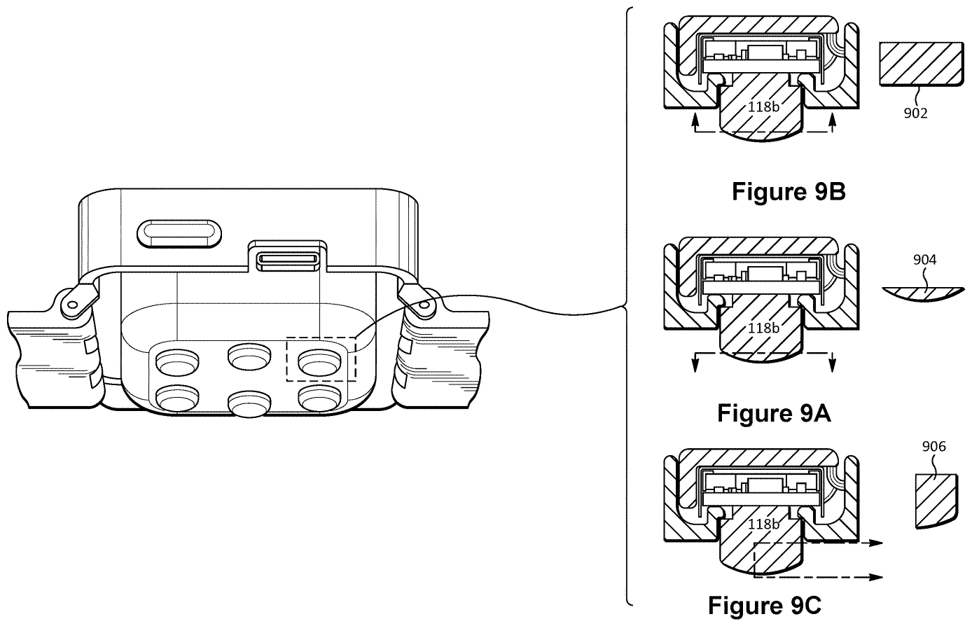

In some embodiments, the pair of electrodes forming the ground 120 and shield 210 and the pairs of sensors (represented by electrodes 118) are gold-plated electrodes having a spherical cap shape with a radius of 5 mm. The spherical shape and dimensions of the pair of electrodes forming the ground 120 and shield 210 electrodes 118 are described below in reference to FIGS. 8-9C. In some embodiments, each sensor (e.g., electrodes 118) of the pairs of sensors extends beyond the interior surface (which can include interior band surface 116b and interior capsule surface 121b and, in some embodiments, an interior cradle surface as well) of the wearable structure by a distance of at least 2 mm, such that when each sensor is depressed into the user's skin 137 it reaches a skin-depression depth of at least 0.8 mm.

The one or more processors 1820 (FIG. 18) are configured to receive data about the neuromuscular signals to determine a motor action that the user intends to perform with their hand. In some embodiments, the motor action is associated with one or more input commands, and the one or more processors 1820 are configured provide the one or more input commands associated with the motor action to a computing device to cause the computing device to perform the one or more input commands in an artificial-reality environment (e.g., augmented reality (AR) or virtual reality (VR) environment). For example, the determined motor action can be interpreted by the one or more processors 1820 as a gesture for causing performance of an action within (i) a display that is coupled with the exterior surface (e.g., as a part of the capsule 112) of the wearable structure and/or an artificial-reality environment being presented via a head-mounted display (or other computing device, such as a computer) that is separate from the wearable device 110. Alternatively, in some embodiments, the one or more processors 1820 are configured provide the motor action directly to a computing device to cause the computing device to perform the one or more input commands associated with the motor action. In other words, the computing device receives the motor action and interprets it as being associated with one or more input commands that are then caused to be executed at the computing device.

In some embodiments, the motor action is associated with one or more interface control commands, and the one or more processors 1820 are further configured to cause the performance of the one or more user interface control commands. For example, the wearable device 110 can include a capsule 112 that includes a display configured to present a user interface and, based on a determined motor action, the one or more processors 1820 cause one or more actions to be performed on the user interface (e.g., selecting a menu option presented within the user interface). In another example mentioned in the preceding paragraph, the one or more processors 1820 can be communicatively coupled (via a communication interface 1845) to a remote computing device (e.g., a phone, a computer, smart glasses, etc.) and the one or more the one or more processors 1820 cause one or more actions to be performed on the user interface of the remote computing device.

FIGS. 2A-2D illustrate different view of the wearable device 110, in accordance with some embodiments. FIG. 2A shows a bottom view of the wearable device 110 including a capsule 112. The bottom view of the wearable device 110 includes (i) pairs of sensors in widthwise segments 220a and 220b of the interior capsule surface 121b of the wearable structure, (ii) pair of electrodes forming the ground 120 and shield 210, interior band portion 116b, and interior capsule portion 121b.

In some embodiments, the capsule 112 is coupled to the band portion 114 either directly or by way of a cradle portion (not pictured). In some embodiments, the capsule 112 houses one or more processors 1820 and other components of the wearable device 110 (described below in reference to FIG. 18). In some embodiments, the capsule 112 includes a display 1840 (FIG. 18) configured to present a user interface or other information (e.g., a clock, a calendar, one or more applications, etc.) to a user. In some embodiments, the capsule 112 is coupled with the pairs of sensors in widthwise segments 220a and 220b of the interior capsule surface 121b of the wearable structure, and with the pair of electrodes forming the ground 120 and shield 210 on the interior capsule surface 121b (as shown in FIG. 2A). In some embodiments, the pairs of sensors in widthwise segments 220a and 220b of the interior capsule surface 121b of the wearable structure, and the pair of electrodes forming the ground 120 and shield 210 are removably coupled to the interior capsule surface 121b (e.g., by way of a threaded connection as discussed below) Additional details regarding the pairs of sensors in widthwise segments 220a and 220b of the interior band surface 116b and the interior capsule surface 121b of the wearable structure, and the pair of electrodes forming the ground 120 and shield 210 on the capsule interior surface 121b are provided below in reference to FIGS. 8-9C.

Each pair of the pairs of sensors in widthwise segments 220a and 220b of the interior band surface 116b and the interior capsule surface 121b of the wearable structure includes at least two electrodes 118. For example, in FIG. 2A, a first pair of sensors in widthwise segments 220a of the interior capsule surface 121b of the wearable structure includes electrodes 118a and 118g, and second pair of sensors in widthwise segments 220b of the interior capsule surface 121b of the wearable structure includes electrodes 118b and 118h. As described above in FIGS. 1A-1C, the respective pairs of the pairs of sensors are positioned at different widthwise segments 220 of the interior surface (interior capsule surface 121b in the depicted example of FIG. 2A) of the wearable structure such that when the wearable structure is worn by the user a portion of each respective sensor (electrodes 118) of the respective pairs extend beyond the interior capsule surface 121b of the wearable structure and contacts the user's skin 137 above neuromuscular pathways (one or more neuromuscular pathways of the first set of neuromuscular pathways 140a or the second set of neuromuscular pathways 140b) of the user. In particular, the first pair of sensors in a first widthwise segment 220a of the interior capsule surface 121b of the wearable structure and the second pair of sensors in a second widthwise segments 220b of the interior capsule surface 121b of the wearable structure in FIG. 2A are positioned such that their respective sensors (electrodes 118a, 118b, 118g, and 118h) contact the top of user's wrist 135a or forearm 133a. As discussed below in reference to FIG. 2D, the respective sensors in the pairs of the pairs of sensors are spaced apart within the different widthwise segments of the interior surface 116b of the wearable structure by a separation distance of no more than 9 mm. In some embodiments, the respective sensors in the pairs of the pairs of sensors are spaced apart within the different widthwise segments of the interior surface 116b of the wearable structure by a separation distance of 7 mm.

The pair of electrodes forming ground 120 and shield 210 are positioned between the first pair of sensors and the second pair of sensors in the example of FIG. 2A. More specifically, the electrodes forming ground 120 and shield 210 are positioned at another distinct widthwise segment of the interior capsule surface 121b of the wearable structure such that when the wearable structure is worn by the user a portion of each respective sensor (electrodes 118) of the respective pairs extend beyond the interior capsule surface 121b of the wearable structure and contacts the user's skin 137 above neuromuscular pathways 140 of the user. As mentioned above in reference to FIGS. 1A-1C, the pair of electrodes forming ground 120 and shield 210 are positioned such that they contact the top of the user's wrist 135a or forearm 133a. In some embodiments, placement of the electrodes forming ground 120 and shield 210 at the bottom surface of the capsule 112 provides greater design flexibility for the wearable structure such that the placement of the electrodes 118 in the other pairs of sensors (those forming the channels for sensing neuromuscular signals) is not constrained. As discussed below in reference to FIG. 2D, the pair of electrodes forming ground 120 and shield 210 are spaced apart by an additional separation distance (e.g., between 15-30 mm) that is larger than the separation distance between respective sensors of the pairs of sensors (e.g., first pair of sensors and the second pair of sensors).

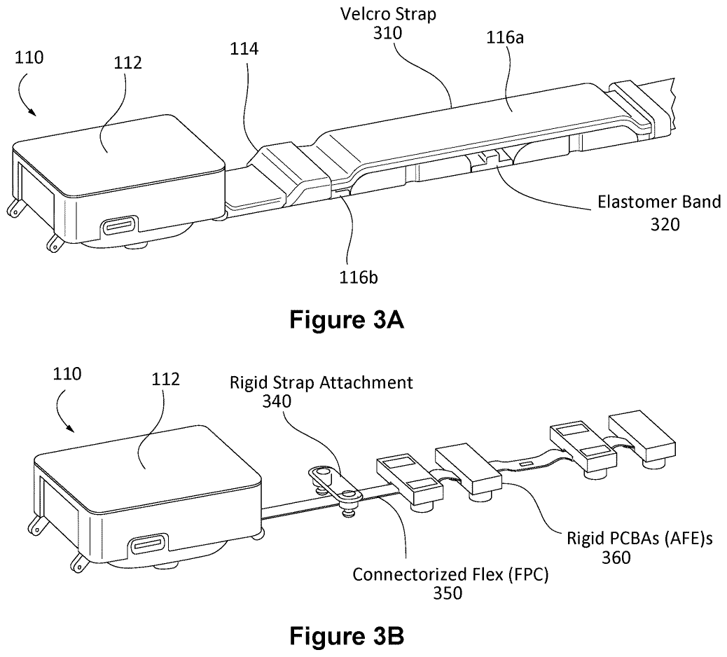

FIG. 2B shows a top view of the wearable device 110 including the wearable structure, which includes the band portion 114 and the capsule portion 112. The wearable structure is designed to improve anatomical conformity and improve comfort when worn by a user. In particular, the band portion 114 and the capsule portion 112 (e.g., exterior capsule surface 121a) provide a continuous surface that is comfortable and allows a user to wear the wearable device 110 for extended periods of times (e.g., half a day, a full day, overnight, multiple days). In some embodiments, the exterior band surface 116a of the wearable structure is configured to provide an external cover for one or more components of the wearable device 110. For example, the exterior band surface 116a of the wearable structure can be configured such that connectors and/or components along the wearable structure are not exposed (as described in detail below in reference to FIGS. 3A and 3B). In some embodiments, the exterior band surface 116a of the wearable structure provides a protective cover to the connectors and/or components along the wearable structure (e.g., to prevent exposed connectors from being accidentally pulled or from direct impact on the components). Further, the exterior band surface 116a of the wearable structure improves robustness of the wearable device 110 such that the wearable device 110 can be produced in higher quantities and at a lower price point.

FIG. 2C shows a top view of a portion of the wearable device 110 and the wearable structure with its capsule portion 112 and band portion 114.

FIG. 2D shows a bottom view of a portion of the wearable device 110. The bottom view of the wearable device 110 includes the wearable structure, the interior band surface 116b of the wearable structure, the interior capsule surface 121b, pairs of sensors (including respective electrodes 118a-1181), and the pair of electrodes forming ground 120 and shield 210.

As mentioned in reference to FIGS. 1A-1C above, the pairs of sensors are configured to detect neuromuscular signals travelling through the neuromuscular pathways within the user's wrist 135 or forearm 133, depending on where the wearable device is worn by the user. Each respective pair of the pairs of sensors is aligned along a distinct widthwise segment (e.g., widthwise segments 220a-220f) of the interior band surface 116b and the interior capsule surface 121b of the wearable structure to form a respective channel for detecting (or sensing) neuromuscular signals. In some embodiments, six pairs of sensors are positioned along distinct widthwise segments 220a-220f of the interior band surface 116b and the interior capsule surface 121b of the wearable structure forming six-channels for detecting (or sensing) neuromuscular signals. In contrast to some neuromuscular-sensing devices, the user of six channels (twelve total neuromuscular-sensing electrodes) represents a large reduction in the number of sensors utilized, while still ensuring accurate detection of neuromuscular signals. This helps to achieve a reduced prior point, ensure less points of failure in the system, and helps to achieve a more elegant and socially-acceptable form factor for the wearable device as a whole.

In some embodiments, respective sensors (e.g. electrodes 118a-1181) in each pair of the pairs of sensors is spaced apart within their respective widthwise segments 220a-220f of the interior band surface 116b and the interior capsule surface 121b of the wearable structure by a separation distance d2 (which can be referred to generally as a predetermined intra-channel separation distance as it describes a separation distance, within one channel, between two different sensors). In some embodiments, the separation distance d2 is no more than 9 mm, while in other embodiments the separate distance d2 is an exact value within this range (such as 7 mm). The separation distance d2 can be measured as the center-to-center distance between each sensor of the pair of sensors (e.g., separation distance between the center of the electrodes 118 in the pair of electrodes). For example, electrodes 118i and 118c of the sixth pair of sensors 220f are separated by a distance of d2. In some embodiments, the separation distance d2 between the respective sensors (electrodes 118) in each pair of the pairs of sensors 220a-220f is no more than 9 mm (e.g., +/−0.2 to 0.3 mm of 9 mm). Use of this small intra-channel separation distance can help to achieve improved gesture-detection accuracies as compared to devices that might use larger separation distances.

In some embodiments, at least two pairs of the pairs of sensors in widthwise segments 220a-220f of the interior band surface 116b and the interior capsule surface 121b of the wearable structure have the same separation distance d2 between their respective sensors. For example, electrodes 118a and 118g of a first pair of sensors in a first widthwise segments 220a of the interior capsule surface 121b of the wearable structure and the electrodes 118i and 118c of the sixth pair of sensors in a sixth widthwise segment 220f of the interior band surface 116b and the interior capsule surface 121b of the wearable structure can have the same separation distance d2 (e.g., 9 mm+/−0.2 to 0.3 mm). In some embodiments, the separation distance d2 is the same for each pair of the pair of sensors. Alternatively, in other embodiments, at least two pairs of the pairs of sensors have a distinct separation distance d2 between their respective sensors that remains within the range of not more than 9 mm, but is different than the separation distance d2 for another pair of sensors that is also within the range of not more than mm. For example, in these other embodiments, electrodes 118b and 118h of a second pair of sensors 220b and can have a first separation distance d2 (e.g., 4 mm+/−0.2 to 0.3 mm) and the electrodes 118i and 118c of the sixth pair of sensors 220f can have a second separation distance d2 (e.g., 7 mm+/−0.2 to 0.3 mm). In some embodiments, the separation distance d2 is distinct for each pair of the pair of sensors, yet remains no more than 9 mm for each of the respective separation distances within every channel.

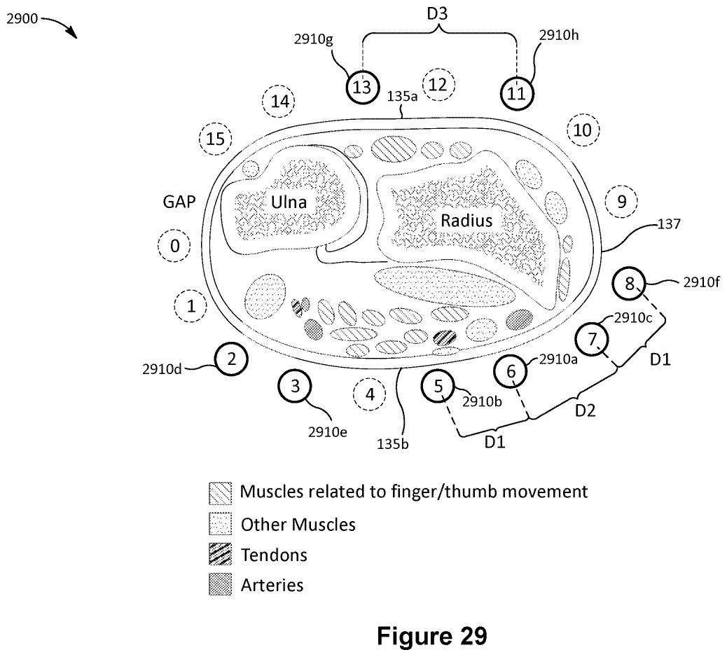

In some embodiments, adjacent pairs of the pairs of sensors are separated by a predetermined distance d1. As compared to the separation distances between sensors within one pair (the intra-channel separation distances discussed above), this distance between pairs themselves is referred to herein as an inter-channel separation distance. For example, as shown in FIG. 2D, a fifth pair of sensors in a fifth widthwise segment 220e of the interior band surface 116b and the interior capsule surface 121b of the wearable structure and the sixth pair of sensors in the sixth widthwise segment 220f of the interior band surface 116b and the interior capsule surface 121b of the wearable structure are separated by the predetermined inter-channel separation distance d1 (also referred to more simply as the predetermined distance d1). In some embodiments, the predetermined distance d1 is between 10-16 mm, and this range is provided to allow for manufacture of bands/wearable structures that can accommodate different wrist circumference sizes. The predetermined distance d1 can be measured as the center-to-center distance between of each sensor of the pair of sensors (e.g., separation distance between center of the adjacent electrodes 118 in distinct pairs of sensors (i.e., adjacent widthwise segments 220). In some embodiments, the predetermined distance d1 is based on the fixed size of the wearable structure (e.g., as described below in reference to FIGS. 6A-6D). In some embodiments, different adjacent pairs of the pairs of sensors can be separated by the same or distinct predetermined distances d1, each of which remains in the range of 10-16 mm. For example, a third pair of sensors in a third widthwise segment 220c of the interior band surface 116b and the interior capsule surface 121b of the wearable structure and a fourth pair of sensors in a fourth widthwise segment 220d of the interior band surface 116b and the interior capsule surface 121b of the wearable structure can be separated by a first predetermined distance d1 and the fifth pair of sensors in a fifth widthwise segment 220e of the interior band surface 116b and the interior capsule surface 121b of the wearable structure and a sixth pair of sensors in a sixth widthwise segment 220f of the interior band surface 116b and the interior capsule surface 121b of the wearable structure can be separated by a second predetermined distance d1. The first and second predetermined distances d1 can be the same or distinct. In some embodiments, pair of sensors at the interior capsule surface 121b are separated by an additional predetermined inter-channel separation distance d3 (referred to more simply as the additional predetermined distance d3). In some embodiments, the additional predetermined distance d3 can be approximately 18 mm (e.g., 18 mm+/−0.2 to 0.3 mm). The additional predetermined distance d3 can be measured as the center-to-center distance between each sensor of the pair of sensors (e.g., separation distance between the centers of the electrodes 118 in distinct pairs of sensors). Further details concerning the user of inter-channel separation distances are provided below in reference to FIGS. 29-35 (in particular, these further details highlight the selection of adequate inter-channel separation distances to ensure high gesture-detection accuracies while 8 pairs of sensors are utilized).

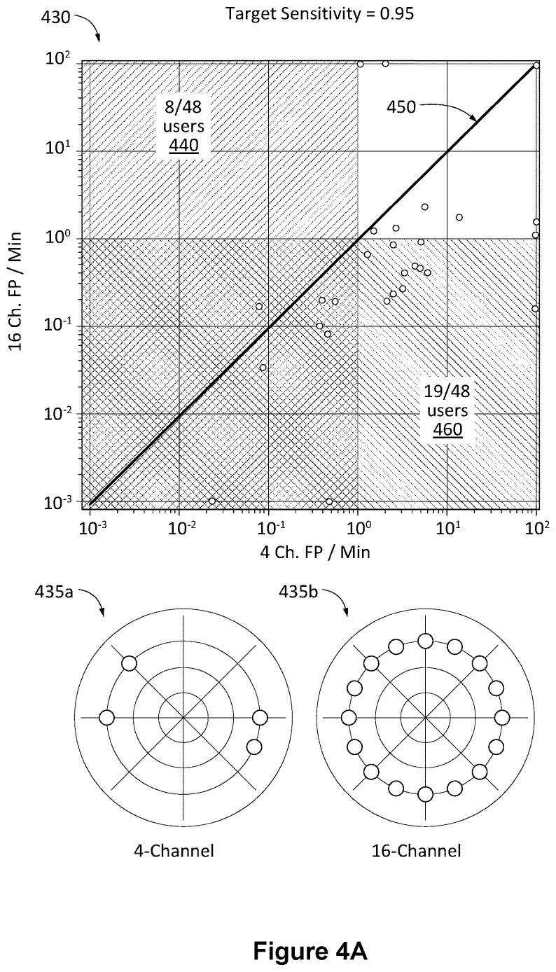

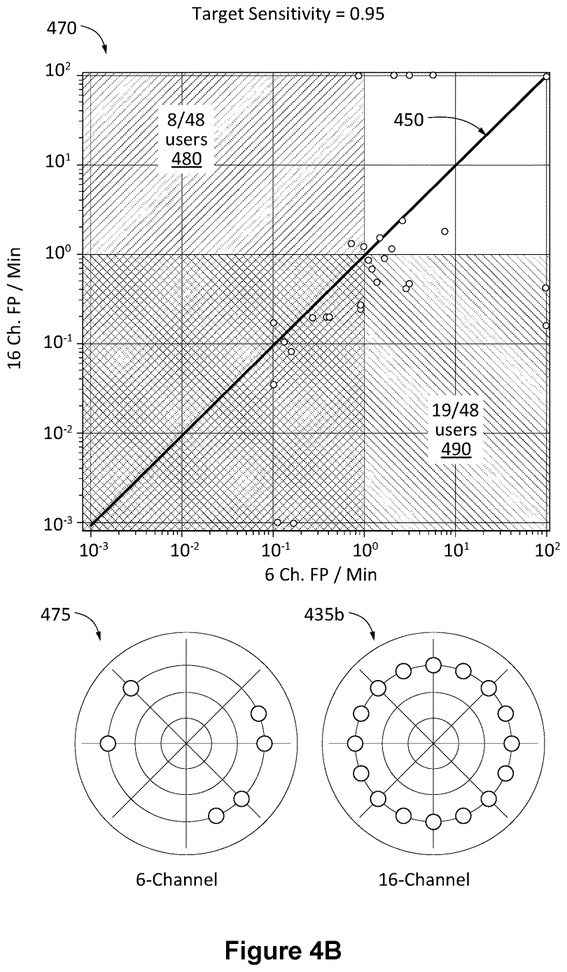

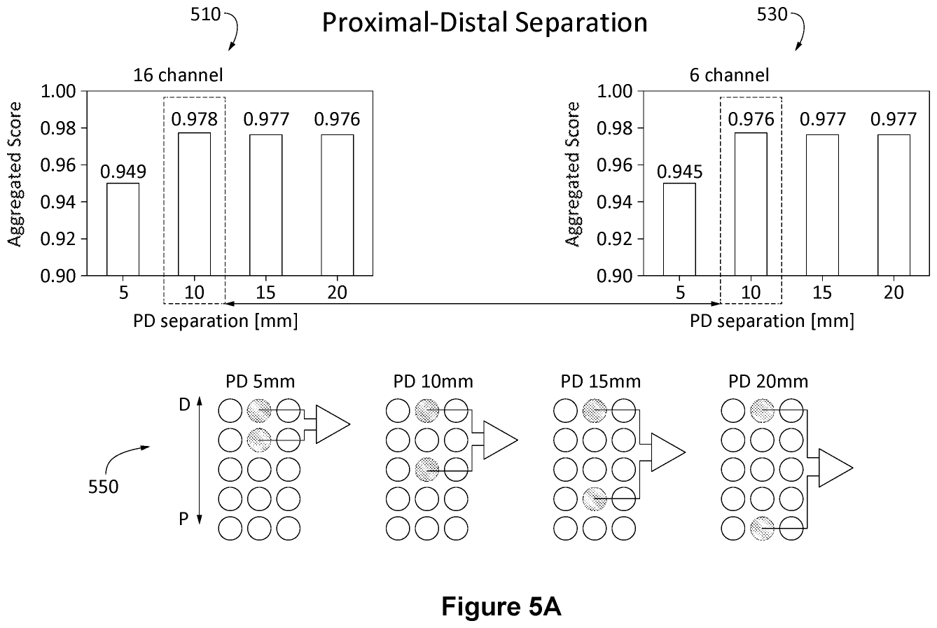

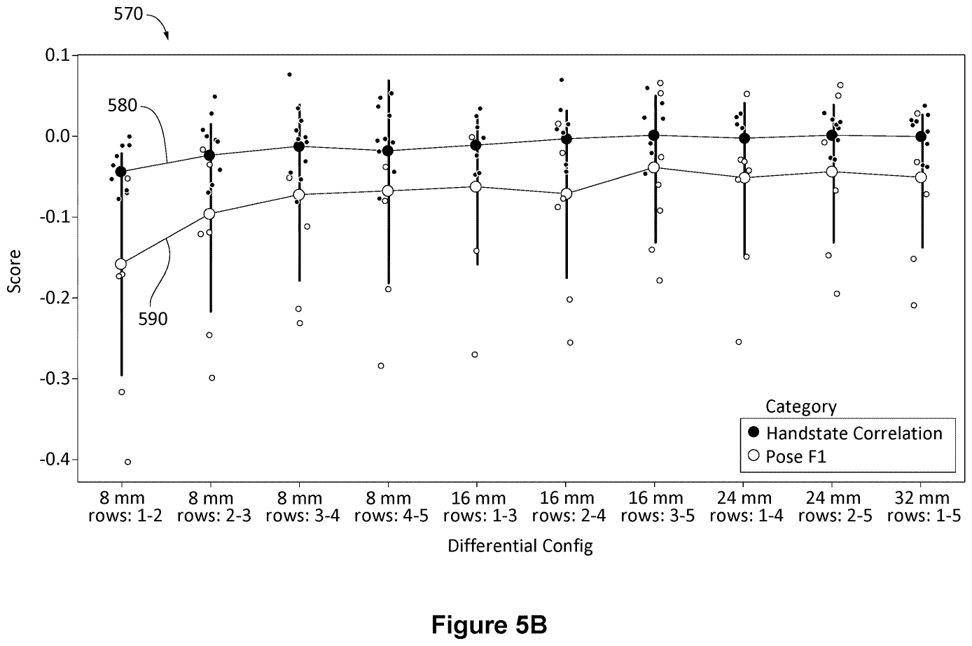

In some embodiments, by placing the sensors 118 in one channel close together (no more than 9 mm apart) and ensuring the pairs of sensors cover different neuromuscular pathways, it has been discovered that fewer pairs of sensors 118 can be utilized to accurately detect neuromuscular signals (e.g., user's hand gestures are accurately sensed at least 95% of the time). For example, for six pairs of sensors (with each sensor in a respective pair being separated by a distance of 9 mm center-to-center), the measured sensitivity was 0.95 (across 25 users) and achieved 0.5 false positives per minute. The plots in FIGS. 4A-5B also further demonstrate the importance of maintaining no less than 9 mm of separation distance between pairs of sensors. In particular, FIGS. 4A and 4B show a minimum number of pairs of sensors for accurately sensing neuromuscular signals and FIGS. 5A and 5B show the minimum separation between the sensors in a respective pair of pairs of sensors for accurately sensing neuromuscular signals.

Although the above examples describe the use of six pairs of sensors to ensure a low cost and socially acceptable form factor, other small numbers of pairs of sensors (that are each spaced apart by no more than the separation distance of 9 mm within sensors in each of the pairs) are also contemplated (such as 4, 5, 7, 8, 9, 10, 11, 12, 13, etc.) for other applications for which a larger form factor is acceptable (e.g., for use in conjunction with medical diagnostic applications).

In some embodiments, the pair of electrodes forming ground 120 and shield 210 are spaced apart by another intra-channel separation distance d4. The other intra-channel separation distance d4 can be between 15-30 mm. In some embodiments, the additional separation distance d4 can be approximately 18 mm (e.g., 18 mm+/−0.2 to 0.3 mm). The additional separation distance d4 is larger than the separation distance d2 between respective electrodes 118 of the first and second pairs of sensors. The additional separation distance d4 can be measured as the center-to-center distance between the ground 120 and shield 210 electrodes (e.g., separation distance between center of the ground 120 and shield 210 electrodes).

FIGS. 3A and 3B illustrate one or more components within a wearable structure of the wearable device, in accordance with some embodiments. In particular, FIG. 3A shows the wearable device 110 including a capsule 112, an exterior band surface 116a of the band portion 114 of the wearable structure, and an interior band surface 116b of the band portion 114 of the wearable structure. In some embodiments, the exterior band surface 116a of the includes a Velcro strap 310 and the interior band surface 116b includes an elastomer band 320. In some embodiments, the Velcro strap 310 and the elastomer band 320 (and the wearable structure overall) have a fixed size (e.g., circumferential size when the wearable structure is worn by the user) so that the respective locations of the six pairs of sensors over the neuromuscular pathways is the substantially constant for different users having a substantially same wrist circumference size. This is also discussed below in reference to FIGS. 6A-6D.

In some embodiments, the Velcro strap 310 is configured to provide an external cover for one or more components of the wearable device 110 (described below in FIG. 3B), while still allowing access (e.g., for maintenance or repair purposes) to those components by detaching the strap 310. While Velcro is the primary example discussed here for illustrative purposes, other removable adhesives could be used to allow for creating a removable strap 310 and permitting access to the components thereunder. In some embodiments, the pairs of sensors (FIG. 2D) extend through a portion of elastomer band 320. For example, the elastomer wearable structure 320 can be molded to include through holes (which can be threaded through holes) for connecting (e.g., removably connecting) the electrodes 118 (FIGS. 1A-2D) of the pairs of sensors.

FIG. 3B shows one or more components that can be protected by a portion of the band 114 (e.g., by the removable strap 310 portion of the band 114), in accordance with some embodiments. The one or more components include a rigid strap attachment 340, connectorized flex 350 (e.g., flexible printed circuits (FPC)), and one or more rigid printed circuit board assemblies PCBAs 360 (e.g., analog front-end (AFE)).

The rigid strap attachment 340 is configured to couple portions of the exterior band surface 116a and portions of the interior band surface 116b together to form a portion of the wearable structure. More specifically, the rigid strap attachment 340 is configured to couple the removable strap 310 and elastomer wearable structure (e.g., elastomer band 320) together. The rigid strap attachment 340 allows for the formation of a housing or protective cover for the connectorized flex 350 and the one or more rigid PCBA 360. For example, by coupling the exterior band surface 116a and the interior band surface 116b together, the rigid strap attachment 340 prevents or minimizes the chances of any accidental pulls or snags on the connectorized flex 350 or direct impacts on the rigid PCBA 360.

The connectorized flex 350 or FPC is configured to electrically couple at least one or more processors 1820 (e.g., housed within the capsule 112) to the one or more rigid PCBA 360 or AFEs. The connectorized flex 350 is configured to be fitted around user's wrist 135 or forearm 133 (FIGS. 1A-1C). More specifically, the connectorized flex 350 is configured to be wrapped and unwrapped around the around user's wrist 135 or forearm 133 while keeping the one or more processors 1820, the one or more rigid PCBA 360, and/or other components of the wearable device 110 electrically coupled. The connectorized flex 350 is configured to be durable such that it survives a number of different twists, pulls, or forces excreted on the connectorized flex 350 by regular use or due to everyday use. In some embodiments, the connectorized flex 350 is durable enough to be moved and/or flexed at least 500 million times without failure (e.g., loss or weakening of the electric connectivity between the one or more processors 1820, the one or more rigid PCBA 360, and/or other components of the wearable device 110). In some embodiments, the connectorized flex 350 is configured to operate for at least two years without failure.

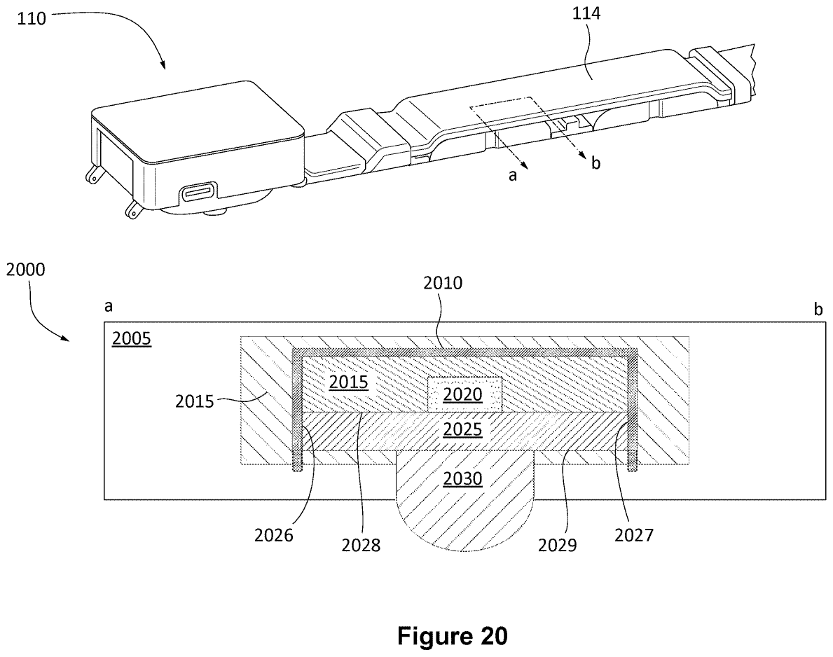

The one or more rigid PCBA 360 (or AFEs) are assemblies that form, in part, the pair of sensors. More specifically, the one or more rigid PCBA 360 are configured to operate in conjunction with the sensors (or electrodes 118) to detect or sense (analog) neuromuscular signals from the user's skin 137 (FIG. 1C). In some embodiments, each rigid PCBA 360 forms a channel for detecting (or sensing) neuromuscular signals. Each rigid PCBA 360 is aligned along a distinct widthwise segment of the interior band surface 116b of the wearable structure to form a respective channel for detecting (or sensing) neuromuscular signals (as described above in reference to the pair of sensors in FIGS. 1A-2D). In some embodiments, rigid PCBAs 360 are positioned along distinct widthwise segments of the interior band surface 116b of the wearable structure forming six-channels for detecting (or sensing) neuromuscular signals. Additional information of detecting the neuromuscular signals is provided above in reference to the pairs of sensors described in FIGS. 1A-2D. In some embodiments, each sensor of the pairs of sensors includes an internal shield enclosing one or more analog components configured to sense neuromuscular signals. Each respective internal shield is distinct from the shield in the pair of electrodes forming ground and shield. Examples of the internal shield are provided below in reference to FIGS. 20-26F.

FIGS. 4A and 4B illustrates that use of six channels of sensors performs better than four channels of sensors for accurately detecting neuromuscular signals, in accordance with some embodiments. In particular, FIG. 4A illustrates a four-channel performance plot 430 for a sample of 48 users. The four-channel performance plot 430 shows the effectiveness of a wearable device 110 including four channels (e.g., four pairs of sensors) compared to a wearable device 110 including sixteen channels. The Y axis of the four-channel performance plot 430 identifies the false positives (FP)/minute (Min.) (e.g., false positives of incorrectly detecting a gesture in which one digit moves to contact another digit when such a gesture did not occur) for the wearable device 110 with sixteen channels and the X axis of the four-channel performance plot 430 identifies the FP/Min for the wearable device 110 with four channels. The diagonal line 450 represents the target sensitivity of 0.95. A first shaded region 440 of the four-channel performance plot 430, corresponding to the wearable device 110 with four channels, shows the number of users (8 out of 48) detected at less than 1 FP/Min. A second shaded region 460 of the four-channel performance plot 430, corresponding to the wearable device 110 with sixteen channels, shows the number of users (19 out of 48) detected at less than 1 FP/Min. As shown in the four-channel performance plot 430, the wearable device 110 with four channels performed worse than the wearable device 110 with sixteen channels (i.e., the four channels only recognizing 8 users compared to the 19 identified by the sixteen channels).

FIG. 4A further provides positional diagrams 435a and 435b showing the relative positions of the pairs of sensors. A first positional diagrams 435a shows the relative positions of the pairs of sensors for a wearable device 110 with four channels. A second positional diagrams 435b shows the relative positions of the pairs of sensors for a wearable device 110 with sixteen channels.

FIG. 4B illustrates a six-channel performance plot 470 for a sample of 48 users. The six-channel performance plot 470 shows the effectiveness of a wearable device 110 including six channels (e.g., six pairs of sensors) compared to a wearable device 110 including sixteen channels. The Y axis of the six-channel performance plot 470 identifies the FP/Min. (e.g., false positives of incorrectly detecting a gesture in which one digit moves to contact another digit when such a gesture did not occur) for the wearable device 110 with sixteen channels and the X axis of the six-channel performance plot 470 identifies the FP/Min for the wearable device 110 with six channels. The diagonal line 450 represents the target sensitivity of 0.95. When comparing FIG. 4A to FIG. 4B, it is seen that the 6 channel arrangement of sensors achieves comparable performance to the 16 channel arrangement and also performs significantly better than the 4 channel sensor arrangement, thus demonstrating that a 6 channel arrangement of sensors can be utilized to accurately detect neuromuscular signals. A first shaded region 480 of the six-channel performance plot 470, corresponding to the wearable device 110 with six channels, shows the number of users (14 out of 48) detected at less than 1 FP/Min. A second shaded region 490 of the six-channel performance plot 470, corresponding to the wearable device 110 with sixteen channels, shows the number of users (19 out of 48) detected at less than 1 FP/Min. As shown in the six-channel performance plot 470, the wearable device 110 with six channels performs slightly worse than the wearable device 110 with sixteen channels; however better than the wearable device with four channels discussed above in FIG. 4A. The slight performance decrease of the wearable device 110 with six channels has been found to still allow the one or more processors 1820 to accurately determine a motor action based on detected neuromuscular signals. More specifically, it has been discovered that a minimum of six channels (or six pairs of sensors) allow for the accurate and efficient detection of neuromuscular signals.

FIGS. 5A and 5B illustrate the minimum separation distance d2 between the sensors in a respective pair of pairs of sensors (FIGS. 2A-2D) for accurately sensing neuromuscular signals. FIG. 5A includes a first plot 510 showing the performance of sensors (or electrodes 118; FIGS. 1A-2D) of a respective pair of sensors at different separation distances d2 in a sixteen channel wearable device 110, a second plot 530 showing the performance of sensors of a respective pair of sensors at different separation distances d2 in a six channel wearable device 110, and a proximal-distal diagram 550 showing a visual representation of the separation distances between the sensors of a respective pair of sensors.

As shown in the first plot 510, by placing the sensors less than 10 mm apart in a wearable device 110 with sixteen channels (or sixteen pairs of sensors) the user's hand gestures are accurately sensed slightly less than 95% of the time (e.g., 94.9% of the time). By placing the sensors 10 mm apart in the wearable device 110 with sixteen channels the user's hand gestures are accurately sensed more than 95% of the time (e.g., 97.8% of the time). By placing the sensors 15 mm apart in the wearable device 110 with sixteen channels the user's hand gestures are accurately sensed more than 95% of the time (e.g., 97.7% of the time). By placing the sensors 20 mm apart in the wearable device 110 with sixteen channels the user's hand gestures are accurately sensed more than 95% of the time (e.g., 97.6% of the time).

Similarly, as shown in the second plot 530, by placing the sensors less than 10 mm apart in a wearable device 110 with six channels (or six pairs of sensors) the user's hand gestures are accurately sensed slightly less than 95% of the time (e.g., 94.5% of the time). By placing the sensors 10 mm apart in the wearable device 110 with six channels the user's hand gestures are accurately sensed more than 95% of the time (e.g., 97.6% of the time). By placing the sensors 15 mm apart in the wearable device 110 with six channels the user's hand gestures are accurately sensed more than 95% of the time (e.g., 97.7% of the time). By placing the sensors 20 mm apart in the wearable device 110 with six channels the user's hand gestures are accurately sensed more than 95% of the time (e.g., 97.7% of the time). Based on these findings, it has been discovered that the optimal separation distance d2 between the sensors (e.g., electrodes 118) of a respective pair of sensors (as shown and described above in reference to FIGS. 2A-2D) is no more than 9 mm. In some embodiments, a separation distance d2 of approximately 9 mm (e.g., +/−0.2 to 0.3 mm of 9 mm) provides the greatest accuracy while improving comfort and anatomical conformity.

The proximal-distal diagram 550 provides a visual representation of the measured separation distances d2 between sensors of a respective pair of sensors. As further shown in the proximal-distal diagram 550, the separation distance d2 can be measured from the center of each sensor.

FIG. 5B illustrates the performance difference in the wearable device 110 as the separation distance d2 between the respective sensors of pairs of sensors is increased. The Y axis is an R2 score or coefficient of determination. Performance plot 870 includes a first performance line 580 and a second performance line 590. In some embodiments, the first performance line 580 is a handstate correlation and the second performance line 590 is pose detection. The first performance line 580 is based on an R2 score, the higher the R2 score the better the measured values are at reproducing the original model. The second performance line 590 is a classification score (a mean between the sensitivity and precision; a harmonic mean). The higher the classification score the better the classification of a pose. Handstate includes the position of the hand. Pose includes finger pinches (a total of 4; thumb to each of the medial digits), a closed fist, and/or an open hand. Each point in the FIG. 5B is a score for a given repetition. The first performance line 580 includes the performance of respective sensors of pairs of sensors when the separation distance d2 is 8 mm, increased to 16 mm, increased to 24 mm, and increased to 32 mm. In some embodiments, the rows represent the respective pairs in the pairs of sensors. For example, the first row may correspond to a first pair, the second row may correspond to a second pair, etc.

FIG. 5B, together with FIG. 5A, illustrates selection of an adequate separation distance d2 between sensors of a respective pair of sensors, including that a small intra-channel separation distance of about 8 mm performs reasonably well as compared to other separation distances. Use of a small intra-channel separation distance can also reduce bulkiness of the wearable structure/watch band with which some of the sensors can be coupled.

FIGS. 6A-6D illustrate the different fixed sizes used for the wearable structure of the wearable device 110 as shown in FIGS. 1A-2D, in accordance with some embodiments. In particular, a first measurement plot 610 shows a small wristband, a second measurement plot 630 shows a medium wristband, a third measurement plot 650 shows a large wristband, and a fourth measurement plot 670 shows an extra-large wristband. Each plot includes a maximum wrist circumference, nominal wrist circumference, and a minimum wrist circumference. The respective values of each plot are provided below in Table 1.

TABLE 1

| | Wrist | | | | | |
|---|---|---|---|---|---|---|
| | Circumference | Min | Nominal | Max | Channel-to-Channel | Compute Core (CC) |
| Wearable | (WC) Range | WC | WC | WC | (C-to-C) Spacing | C-to-C Spacing |
| device size | (mm) | (mm) | (mm) | (mm) | (mm) | (mm) |
| Small | 18 | 130 | 139 | 148 | 10.6 | 18 |
| Medium | 21 | 148 | 159 | 169 | 12.1 | 18 |
| Large | 24 | 169 | 181 | 193 | 13.8 | 18 |
| Extra Large | 27 | 193 | 207 | 220 | 15.7 | 18 |

Using FIG. 6A as an example, the small wearable device 610 (e.g., an instance of the wearable device 110 described above in FIGS. 1A-2D) has a WC range of 18 mm. Specifically, the WC range is the difference between the Maximum WC of the small wearable device 610 and the minimum WC of the small wearable device 610. The small wearable device 610 has a C-to-C spacing of 10.6 mm. The C-to-C spacing is the predetermined inter-channel separation distance d1 of adjacent pairs of sensors as described above in FIGS. 1C and 2D. For example, as shown in FIG. 6A, the C-to-C spacing is measured between electrode 118c (corresponding to a pair of sensors at a sixth widthwise segment 220f of the wearable structure (shown in FIG. 2D)) and 118d (corresponding to a pair of sensors at a fifth widthwise segment 220d of the wearable structure, distinct from the pair of sensors at the sixth widthwise segment 220f). The C-to-C spacing can also be measured between electrode 118e (corresponding to a pair of sensors at a fourth widthwise segment 220d, distinct from the pairs of sensors at the fifth and sixth widthwise segments 220e-220f) and 118f (corresponding to a pair of sensors at a third widthwise segment 220c, distinct from the pairs of sensors at fourth, fifth, and sixth widthwise segments 220d-220f).

The compute core (CC, which is a part of the capsule portion 112 discussed herein) C-to-C spacing is the additional predetermined distance d3 measured between pairs of sensors placed or coupled to the capsule 112 as described above in reference to FIGS. 1C and 2D. For example, as shown in FIG. 6A, the CC C-to-C spacing is measured between electrode 118a (corresponding to a pair of sensors at a second widthwise segment 220b of the structure, distinct from the pairs of sensors at the third, fourth, fifth, and sixth widthwise segments 220c-220f) and 118b (corresponding to a pair of sensors at a first widthwise segment 220a, distinct from the pairs of sensors at the second, third, fourth, fifth, and sixth widthwise segments 220b-220f). In some embodiments, the CC of the wearable devices 610, 630, 650, and 670 is centered at the top of a user's wrist 135a or forearm 133a (e.g., FIGS. 1A-1C). In some embodiments, the CC C-to-C spacing is slightly larger than the C-C spacing to allow for the placement of the ground 120 and shield 210 electrodes to be placed at the bottom of the capsule 112.

The different fixed sizes of the wearable device 110 are configured to position the pairs of sensors over the same or substantially constant neuromuscular pathways (e.g., first set of neuromuscular pathways 140a or the second set of neuromuscular pathways 140b; FIG. 1C) for different users having a substantially same wrist circumference size. By providing different fixed sizes of the wearable device 110 (but maintaining appropriate inter-channel separation distances discussed herein), the performance of the wearable device 110 can be optimized for each user's wrist size. Proportional sizing in the WC range (e.g., 3 mm increase per size increase) is utilized because muscles within the neuromuscular pathways scale linearly with wrist circumference.

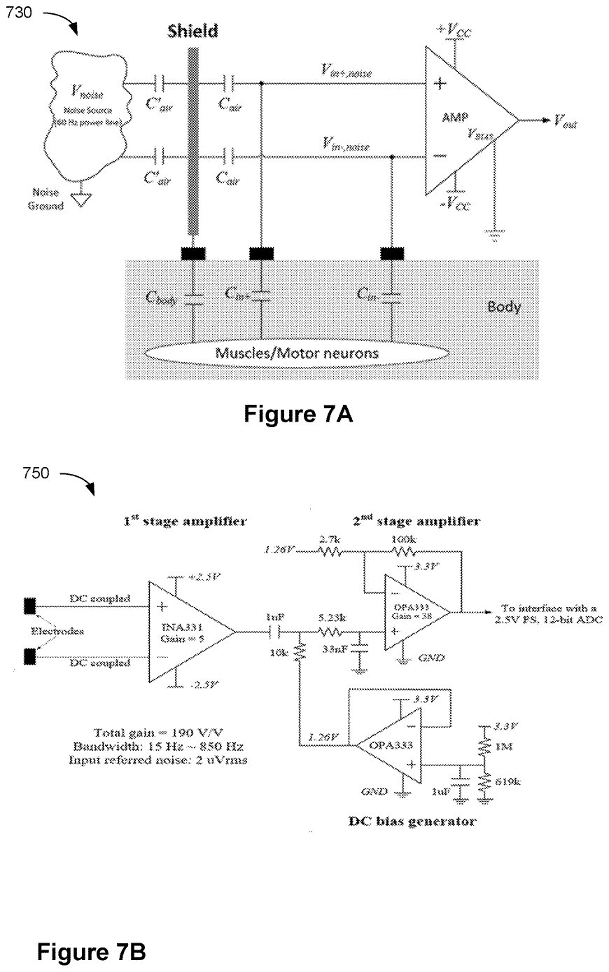

FIGS. 7A and 7B provide an electrical schematic of the wearable device 110 and the circuits created when the device is worn by a user, in accordance with some embodiments. First schematic 730 provides an overview of a single channel first stage analog-front-end circuit. In particular, the first schematic 730 shows the interaction of a single pair of the pair of sensors contacting and interfacing with a user's body, and the detected neuromuscular signals being provided to an amplifier. Second schematic 750 provides an overview of a single channel analog-front-end circuit with at least two stages. In particular, the second schematic 750 shows the interaction of a single pair of the pair of sensors contacting and interfacing with a user (via electrodes), and the detected neuromuscular signals going through at least a first and second stage amplifier.

Having discussed features related to intra-channel and inter-channel separation distances (particularly in the context of using 6 pairs of sensors), various advantageous features of electrodes that can be used as the neuromuscular sensors in the sensing channels of the wearable device are now described as well.

FIG. 8 provides a cross sectional view of a capsule 112 of a wearable device, in accordance with some embodiments. Cross sectional view 800 shows a pair of sensors including sensors (or a first electrode 118b and a second electrode 118h). As described above in reference to FIGS. 1A-2D, the first electrode 118b and the second electrode 118h are configured to detect (or sense) neuromuscular signals. The first electrode 118b and the second electrode 118h are coupled with the wearable device 110 and are gold-plated electrodes. In some embodiment, the electrodes include a hard gold plating, which is gold alloyed with cobalt, iron, or nickel for durability. Alternatively, in some embodiments, the electrodes include a soft gold plating, which is gold with high purity (e.g., 99% gold purity) without the addition of any alloying elements. The electrodes are formed such that there is a high percentage of gold (e.g. at least 80 percent) at the electrode-skin interface. As shown in cross sectional view 800, in some embodiments, a first electrode 118b is paired with a second electrode 118h having same structure to create a channel (e.g., pair of sensors) for sensing neuromuscular signals.

In some embodiments, the first electrode 118b has a first height h1 and the second electrode 118h has a second height h2. In some embodiments the first and second heights h1 and h2 are the same. Alternatively, in some embodiments, the first and second heights h1 and h2 are distinct. In some embodiments, the first height h1 and/or the second height h2 is approximately 2 mm (+/−0.02 to 0.03 mm). In some embodiments, the first electrode 118b has a first diameter w1 and the second electrode 118h has a second diameter w2. In some embodiments the first and second diameters w1 and w2 are the same. Alternatively, in some embodiments, the first and second diameters w1 and w2 are distinct.

In some embodiments, the first diameter h1 and/or the second diameter h2 is approximately 5 mm (+/−0.02 to 0.03 mm). In some embodiments, the first electrode 118b has a first spherical surface or curvature r1 and the second electrode 118h has a second spherical surface or curvature r2. In some embodiments the first and second curvatures r1 and r2 are the same. Alternatively, in some embodiments, the first and second curvatures r1 and r2 are distinct. In some embodiments, the curvature of the first electrode 118b r1 and the curvature second electrode 118h r2 is at least R5 mm. In some embodiments, the first electrode 118b and the second electrode 118h have an edge radius of 0.5 mm. In some embodiments, the first electrode 118b and the second electrode 118h have a contact area of approximately 24.4 mm2 (+/−0.2 to 0.5 mm2). As father shown in FIG. 8, the first electrode 118b and the second electrode 118h are separated by a separation distance d2. In some embodiments, the separation distance d2 is no more than 9 mm. In some embodiments, the separation distance d2 is 7 mm. Additional detail on the separation distance d2 is provided above in FIGS. 4A-5B. Further detail on the dimensions of the electrodes 118 is provided below in reference to FIGS. 9A-9C.

In some embodiments, the first electrode 118b and the second electrode 118h are removably coupled with the wearable device 110. In some embodiments, the first electrode 118b and the second electrode 118h further include a connection component configured to allow a removable connection between the electrodes and a wearable device 110. For example, the first electrode 118b and the second electrode 118h can be removably connected to a wearable device 110 such by use of a thread able connection).

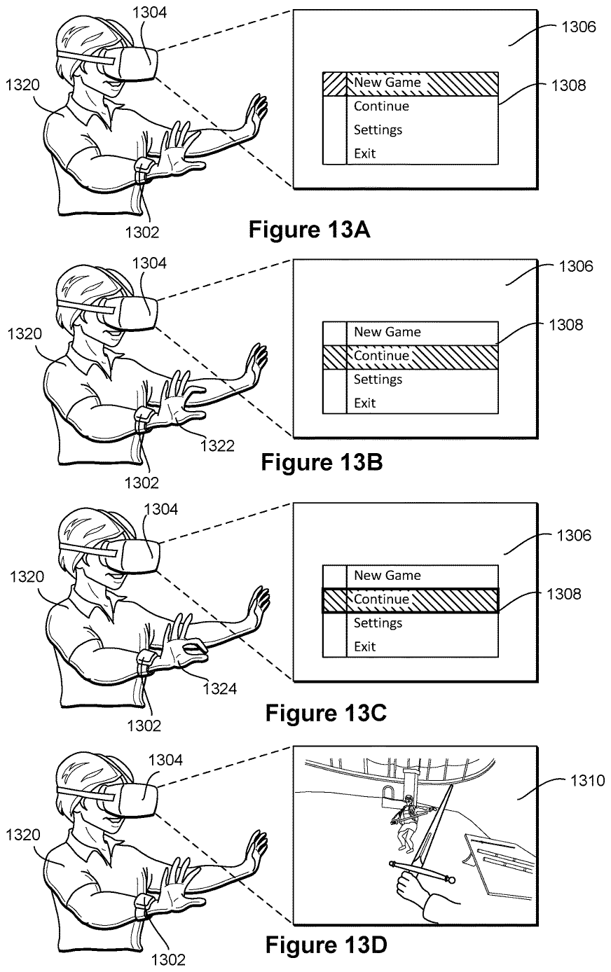

As shown in FIG. 18, in some embodiments, the wearable device 110 is in communication with one or more processors 1820 (local to the wearable device 110 or remotely located at a separate head-mounted display or other processing device), and the one or more processors 1820 configured to detect motor actions intended to be performed by the user based on the sensed neuromuscular signals (sensed or detected by the first and second electrodes 118b and 118h). In some embodiments, the detected motor actions can be interpreted by the one or more processors 1820 as gestures for causing performance of an action within (i) a display 1840 that is coupled with the exterior surface 116b of the wearable structure (FIG. 1A-2D) and/or (ii) an artificial reality environment being presented via a head-mounted display (e.g., as shown in FIGS. 13A-13D) that is separate from the wearable device 110.

FIGS. 9A-9C illustrate different cross sectional views of an individual electrode 118b of a wearable device 110, in accordance with some embodiments. In some embodiments, the electrode 118b includes an area of electrically conductive material shaped to have a cylindrical body shape 902 and a spherical cap shape 904 (described in detail below).

FIG. 9A provides a cross sectional view of the cylindrical body portion 902 of the electrode 118B. In some embodiments, an electrical shielding is placed on the cylindrical body 902 portion of the area of electrically conductive material, such that when the user's skin 137 (FIG. 1C) contacts the cylindrical body portion 902, an impedance value at the electrode is substantially unaffected. In some embodiments, “substantially unaffected” refers to a variation in the impedance value at the electrode of less than a detectable amount. The impedance value is used for detecting (sensing) neuromuscular signals travelling through the neuromuscular pathways within the user's wrist or forearm. In some embodiments, the electrode is configured to detect neuromuscular signals with an impedance value up to 10 MOhm for short periods of time (e.g., less than a minute, less than 30 seconds, less than 15 seconds, etc.). In some embodiments, the electrode is configured to detect neuromuscular signals with an impedance value up to 15 MOhm for short periods of time. In some embodiments, the electrode is configured to detect neuromuscular signals with an impedance value up to 5 MOhms for extended periods of time (or during regular use). In some embodiments, the electrode is configured to detect neuromuscular signals with an impedance value up to 3 MOhms for extended periods of time (or during regular use). In some embodiments, the electrode is configured to detect neuromuscular signals with an impedance value up to 2 MOhms for extended periods of time (or during regular use). In some embodiments, the cylindrical body portion 902 has a cylindrical body portion 902 to electrode height ratio of 66.5%. For example, in some embodiments, the cylindrical body portion 902 can have a height of approximately 1.33 mm (+/−0.02 to 0.03 mm)—66.5% of an electrode height of 2 mm describe above in FIG. 8. Alternatively, in some embodiments, the cylindrical body portion 902 has a cylindrical body portion to electrode height ratio of 50%.

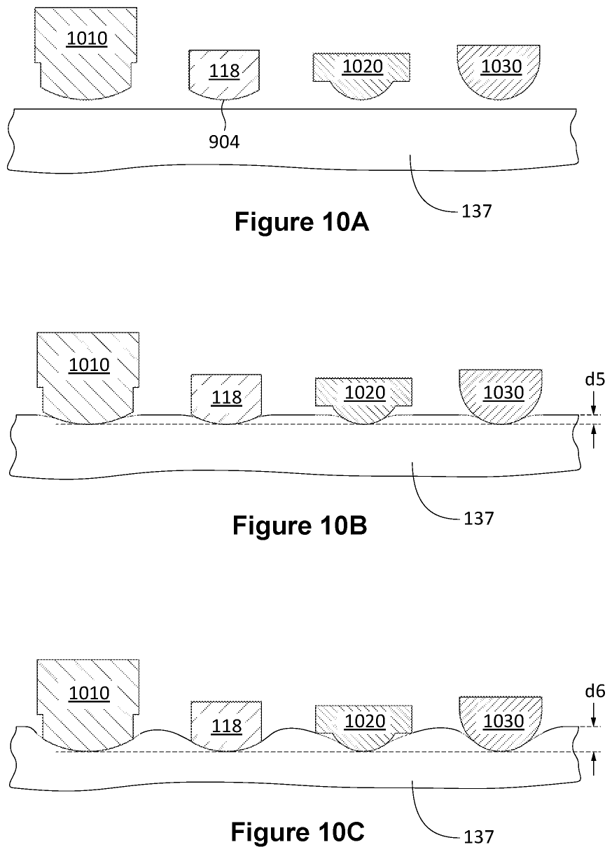

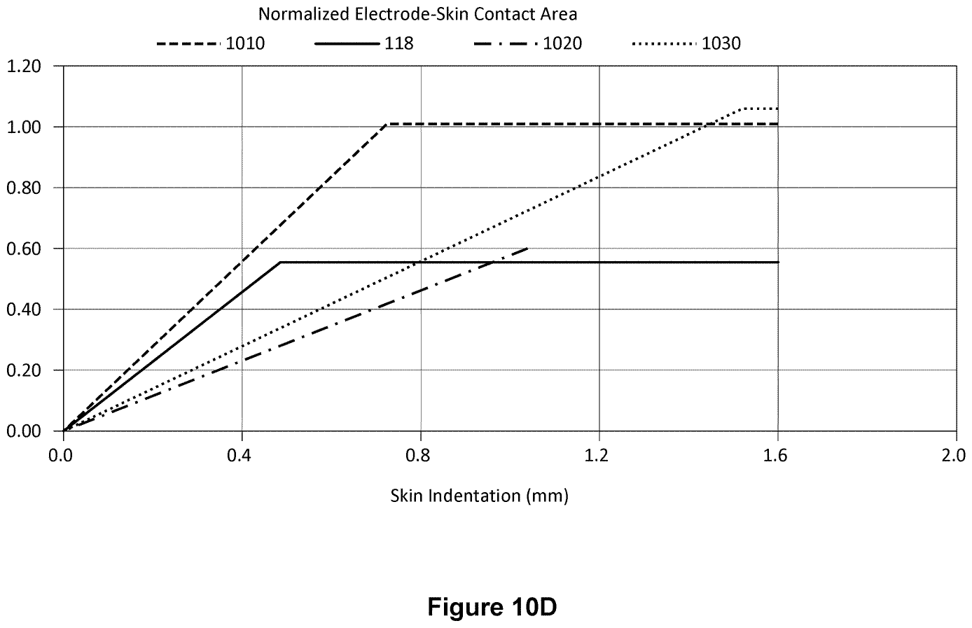

FIG. 9B provides a cross sectional view of the spherical cap shape 904 of the electrode 118b. In some embodiments, a portion of the area of the electrically conductive material that is shaped to have the spherical cap shape 904 is configured to contact the user's skin 137 to sense neuromuscular signals travelling to the user's hand (e.g., as shown and described above in reference to FIGS. 1A-1C). The portion of the area of the electrically conductive material that is shaped to have the spherical cap 904 shape, when contacting the user's skin 137, is configured to present impedance values between the electrode 118b and the user's skin 137 as described in detail below in FIGS. 10A-10D.

In some embodiments, the spherical cap shape 904 has a spherical cap height to electrode height ratio of 33.5%. For example, in some embodiments, the spherical cap shape 904 can have a height of approximately 0.67 mm (+/−0.02 to 0.03 mm)—33.5% of an electrode height of 2 mm describe above in FIG. 8. Alternatively, in some embodiments, the spherical cap shape 904 has a spherical cap height to electrode height ratio of 50%. A spherical cap height to electrode height ratio of 50% allows for the electrode 118b to be substantially flat (including a slight convex shape at the spherical cap shape 904 to contact the user's skin 137).

FIG. 9C provides a vertical cross sectional view 906 of the cylindrical body portion 902 and spherical cap shape 904 of the electrode 118b. The vertical cross sectional view 906 may include a curvature of R5 mm for the spherical cap shape 904 and an edge radius of 0.5 mm. In some embodiments, the radius of the cylindrical body portion 902 is approximately 2.5 mm (+/−0.01 to 0.015 mm).

Although the above examples provided in FIGS. 8-9C refer to electrodes 118b and 118a, the skilled artisan in this field will appreciate upon reading this disclosure that any of the electrodes 118a-1181, the ground 120 electrode, and/or shield 210 electrodes can includes similar features and/or dimension. In some embodiments, electrodes used with the arm-wearable devices discussed herein can also be flat electrodes (which can be used as alternatives for, or in addition to, one or more of the electrodes having the hemispherical cap shape that were described above).

FIGS. 10A-10D illustrate different sensors contacting a user's skin 137 and their associated performance. The contact surface area of a sensors is proportional to electrode-skin impedance. In order to improve the electrode-skin impedance, the electrode skin contact area should be maximized. In particular, an electrode should be designed so that vertical movement does not significantly change the contact surface area throughout the tissue indentation (i.e., the skin-depression depth). The electrodes 118 described herein satisfy this requirement while providing a comfortable skin contact area that does not discomfort a user.

In some embodiments, when a portion of the area of the electrically conductive material that is shaped to have the spherical cap shape 904 (of the electrode 118) is contacting the user's skin 137 (FIGS. 1A-1C) at a first skin-depression depth, a first impedance value is present between the electrode 118 and the user's skin 137. For purposes of this disclosure, a skin-depression depth is defined as a distance between a point on the user's skin 137 when that skin is not being depressed and the same point on the user's skin 137 when that skin 137 is being pushed down (e.g., depressed) by the portion of the area of the electrically conductive material that is shaped to have the spherical cap shape 904. For example, as shown in FIG. 10A, no skin-depression depth is visible as the user's skin 137 has not yet been depressed by the electrode 118. Alternatively, as shown in FIG. 10B, a skin-depression depth d5 is present after the skin has been depressed by the electrode 118. In some embodiments, the first skin-depression depth is between 0.001 to 0.079 mm as the electrode is depressed into the user's skin 137.

In some embodiments, when the portion of the area of the electrically conductive material that is shaped to have the spherical cap shape 904 is contacting the user's skin 137 at a second skin-depression depth d6 that is larger than the first skin-depression depth d4, a second impedance value is present between the electrode and the user's skin 137. In some embodiments, the second skin-depression depth d6 is 0.8 mm as shown in FIG. 10C. In some embodiments, the second skin-depression depth d6 is greater than 0.8 mm as the electrode 118 is further depressed into the user's skin. In some embodiments, a skin-depression depth of at least 0.8 mm stabilizes the impedance value at a shallow skin depth. In some embodiments, a skin-depression depth of at least 0.6 mm stabilizes the impedance value at a shallow skin depth. The second skin-depression depth d6 is also a comparatively shallow skin-depression depth as other known electrodes (e.g., first EMG sensors 1010, second EMG sensor 1020, and third EMG sensor 1030) operate with skin-depression depths much greater than 0.8 mm, such as 1.6 mm and greater. In some embodiments, when the portion of the area of the electrically conductive material that is shaped to have the spherical cap shape 904 is contacting the user's skin 137 at a third skin-depression depth that is larger than the first and second depths, the second impedance value remains present between the electrode and the user's skin 137. In some embodiments, the third skin-depression depth is any depth larger than the second skin-depression depth as the electrode 118 is even further depressed into the user's skin 137.

The electrode 118 is configures to maintain a stabilized impedance value at shallow skin-depression depths through deeper skin-depression depths (e.g., greater than 1.6 mm). By designing the electrode 118 to have the advantageous property of a stabilized impedance value at a shallow skin depth (e.g., approximately 0.8 mm+/−0.02 to 0.05 mm), it has been discovered that the electrode is able to more reliably sense the neuromuscular signals and remain relatively unaffected by movements from the user (e.g., jumping up and down, shaking their hand, rotating their wrist, etc.) that can cause other electrodes to see changes in impedance values that then cause unreliable detection of the neuromuscular signals.

FIG. 10D illustrates the performance of first EMG sensor 1010, second EMG sensor 1020, third EMG sensor 1030 and the electrode 118 at different skin-depression depths. The X axis illustrates the skin indentation (or skin-depression depths) in mm and the Y axis illustrates the impedance values. As shown in FIG. 10D, the impedance value of the first EMG sensor 1010 continues to increase until a skin indentation reaches approximately 1 mm at which point the impedance value stabilizes around 1. Alternatively, the impedance value of the second EMG sensors 1020 does not appear to stabilize at any particular skin indentation. More specifically, once the second EMG sensors 1020 reached a skin indentation of approximately 1.4 mm, second EMG sensors 1020's exact impedance value could not be determined. The impedance value of the third EMG sensor 1030 continues to increase until a skin indentation reaches approximately 1.8 mm at which point the impedance value stabilizes at a value slightly greater than 1.

In contrast to the first sensor 1010, second sensor 1020, third sensor 1030, the electrode 118 reaches a stable impedance value with a relatively shallow skin indentation (e.g. approximately 0.6 mm). The stable impedance value electrode 118 is slightly under 0.6; however, that value does not significantly impact performance. In particular, as shown above in FIGS. 4B, the use of at least six pairs of sensors (FIGS. 1A-2D) provides accurate results at a target sensitivity of 0.95.

In some embodiments, to ensure the contact around areas where anatomical features of the wrist 135 and/or forearm 133 protrude significantly, an electrode 118 with a height of approximately 2 mm is used. The wearable device 110 described herein is a kinematic chain constituted by an assembly of rigid sections connected by various types of flexible joints. This kinematic chain of the wearable device 110 allows the 2 mm height of the electrodes 118 to adequately detect any number of gestures with different protrusions including gestures that could cause a flexor tendon protrusion greater than 5 mm. In particular, the 2 mm height of the electrodes 118 along with the positioning of the pairs of sensors along the wearable structure of the wearable device 110 address different forces generated by users with different wrist sizes and shapes.

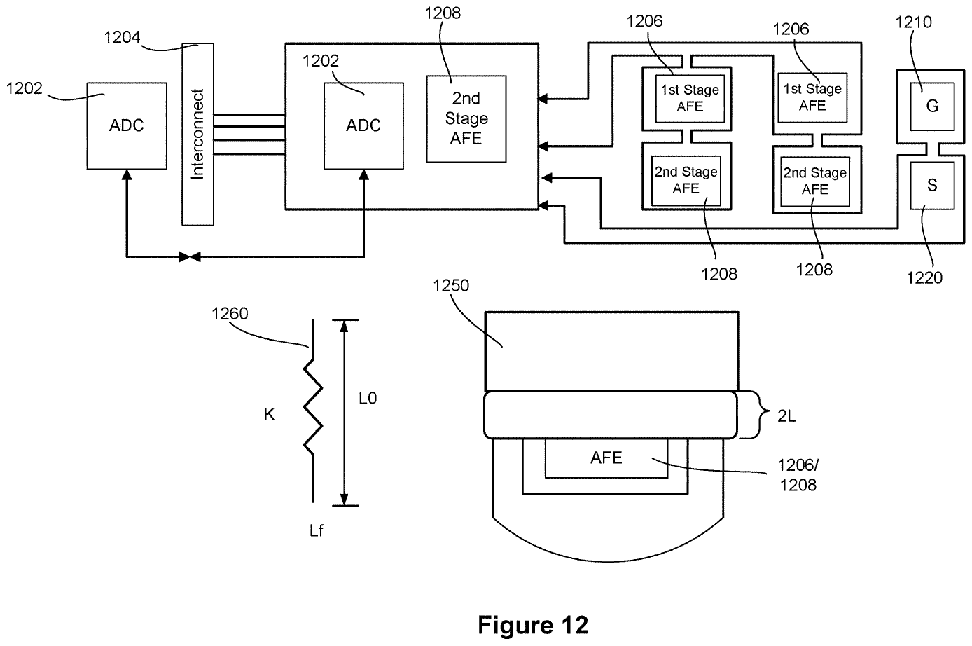

In some embodiments, the electrode 118 is configured to have some movement in the Z-direction (i.e., perpendicular to the surface of the wearable structure). This movement in the Z-direction is configured to remove some of the forces exerted on the electrode 118 by the soft tissue at the user's wrist 135 or by portions of the wrist that have harder structures like the ulna bone. For example, the soft tissue at the user's wrist 135 (FIG. 1A-1C) tends to relax at forces of approximately 5-10 grams (with a 5 mm diameter flat pin) and harder structures like the ulna bone, that force can increase to 100 grams. These added forces can cause discomfort to the user and/or affect measurements captures by the electrodes 118. In some embodiments, a spring structure (e.g., pogo-pins) is used to significantly lower this force on the user. This spring structure significantly improves comfort when the wearable device 110 is worn by the user. In some embodiments, the spring structure reduces the spring rate (e.g., pogo spring rate) from 260 g/mm to 60 g/mm. In some embodiments, spring structure with a spring rate of 5 g/mm can be used. The spring structure is shown below in FIG. 12.

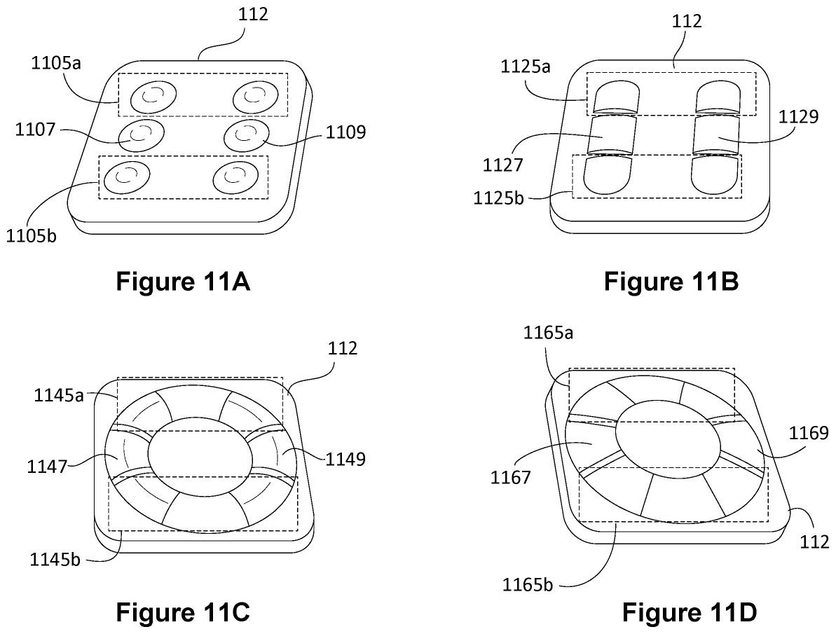

FIGS. 11A-11D illustrate alternate designs of the pairs of sensors, ground electrode, and shield electrode under the capsule 112. More specifically, each alternate design includes two pairs of sensors and respective ground and shield electrodes between the two pairs. For example, FIG. 11A includes two pairs of sensors 1105a and 1105b (in including at least two respective electrodes or sensors) and a ground electrode 1107 and shield electrode 1109 in between the two pairs of sensors 1105a and 1105b. FIG. 11B includes two pairs of sensors 1125a and 1125b (in including at least two respective electrodes or sensors) and a ground electrode 1127 and shield electrode 1129 in between the two pairs of sensors 1125a and 1129b. FIG. 11C includes two pairs of sensors 1145a and 1145b (in including at least two respective electrodes or sensors) and a ground electrode 1147 and shield electrode 1149 in between the two pairs of sensors 1145a and 1145b. FIG. 11D includes two pairs of sensors 1165a and 1165b (in including at least two respective electrodes or sensors) and a ground electrode 1167 and shield electrode 1169 in between the two pairs of sensors 1165a and 1165b. In some embodiments, the electrodes in FIGS. 11A-11D are similar to those described above in reference to FIGS. 1A-10D.

FIG. 12 illustrates an adequate electromechanical architecture of a wearable device. FIG. 12 includes one or more analog-to-digital converters (ADC) s 1202, an interconnect 1204, one or more first stage AFEs 1206, one or more second stage AFEs 1208, a ground electrode 1210, and a shield electrode 1220. In some embodiments, the one or more ADCs 1202 are included in a computing core or capsule 1250. In some embodiments, the one or more first stage AFEs 1206 and the one or more second stage AFEs 1208 are positioned along the bottom of the capsule 1250 or along the wearable structure of the wearable device (e.g., wearable structure FIGS. 1A-2D). Similarly, in some embodiments, the ground electrode 1210 and the shield electrode 1220 are positioned along the bottom of the capsule 1250. In some embodiments, the capsule 1250 includes two conductive layers (2L) of a flexible printed circuit and shielding.

The interconnect 1204 are configured to electrically couple the ADCs 1202, one or more first stage AFEs 1206, one or more second stage AFEs 1208, a ground electrode 1210, and a shield electrode 1220. In some embodiments, the interconnect 1204 coupled other components of the wearable device (for example the one or more components shown in FIG. 1820. In some embodiments, the ADCs 1202, one or more first stage AFEs 1206, one or more second stage AFEs 1208, a ground electrode 1210, and a shield electrode 1220 are electrically coupled via FPC.

FIG. 12 further shows a spring structure 1260. In some embodiments, the spring structure 1260 has a length L0 that is approximately 3 mm (+/−0.2 to 0.3 mm). In some embodiments, the spring structure 1260 has a free length (Lf) of 2 to 3 mm. In some embodiments, the spring structure has a spring rate (K) of 5 g/mm. In some embodiments, the spring structure mimics the structure of a pogo pin (60 g/mm) while also reducing the spring rate to 5 g/mm. A spring rate (K) of 5 g/mm provides an ideal level of comfort and pressure that allows users to wear the wearable device for extended periods of time (e.g., 5 hours, 8 hours, a full day, overnight, etc. In some embodiments, the spring structure is embedded within the capsule 1250 and configured to allow the one or more first stage AFEs 1206 and the one or more second stage AFEs 1208 move in the Z direction (perpendicular to the bottom surface of the capsule 1250 coupled the first and second stage AFEs 1206 and 1208). In some embodiments, a respective spring structure 1260 is coupled between each of the first and second stage AFEs 1206 and 1208 and the bottom surface of the capsule 1250. In some embodiments, a respective spring structure 1260 is coupled between each of the first and second stage AFEs 1206 and 1208 and the interior surface of the wearable structure (e.g., wearable structure; FIGS. 1A-2D). In this way, the first and second stage AFEs 1206 and 1208 can move in a Z direction at each of their respective positions along the wearable structure.

FIGS. 13A-13D illustrate a system for performing one or more commands at a computing device with a display (e.g., head-mounted display 1304) at which an action is performed based on the neuromuscular signals sensed by a wearable device 1302 (e.g., an arm-wearable device). The wearable device 1302 can be an instance of the wearable device 110 descried above in reference to FIGS. 1A-12.

In some embodiments, the system includes the wearable device 1302 and the computing device 1304. The computing device 13074 provides an augmented reality environment 1306 configured to perform one or more actions in the augmented reality environment based on the one or more commands provided by the arm-wearable device (e.g., moving a menu item 108 and/or initiating an application such as a game 1310).

The wearable device 1302 includes the wearable structure configured to be worn by a user 1320. As described above in reference to FIGS. 1A-2D, in some embodiments, the wearable structure has interior surface (e.g., interior band surface 116b and interior capsule surface 121b; FIGS. 1A-1C) and an exterior surface (e.g., exterior band surface 116a and exterior capsule surface 121a; FIGS. 1A-1C), the interior surface being configured to contact a user's skin when the wearable device 1302 is donned by the user 1320. The wearable device 1302 can include six pairs of sensors configured to detect neuromuscular signals. Each respective pair of the six pairs of sensors is aligned along a distinct widthwise segment of the interior surface to form a respective channel for detecting neuromuscular signals. In some embodiment, each pair of sensors of the six pairs of sensors is positioned such that when the wearable structure is worn by the user 1320 portion of each sensor of a respective pair of the six pairs of sensors extends beyond the interior surface of the wearable structure and contacts the user's skin above a particular neuromuscular pathway 140 of the user 1320. The wearable device 1302 further includes one or more processors configured to receive data about the neuromuscular signals and determine a motor action that the user 1320 intends to perform with their hand. The motor action can be associated with one or more commands. The one or more processors are further configured to provide the one or more commands associated with the motor action to the computing device to perform the action.

For example, as shown in FIG. 13A, the user 1320 is being displayed by the computing device 1304, the augmented reality environment 1306. The user 1320 moves a portion of his hands or intends to move a portion of his hands (e.g. his digits 1322) which generate neuromuscular signals that are detected by the wearable device 1302. The wearable device 1302, using the one or more processors, determines the motor action that the user 1320 (e.g., movement of the digits 1322 downward). The wearable device 1302 provides one or more commands associated with the motor action to the computing device 1304 to perform the action. For example, as shown in FIG. 13B, the movement of the digits 1322, cause the computing device 1304 to move the highlight in menu 1308 from “New Game” to “Continue.”

Different gestures and motor actions can be determined by the wearable device 1302. For example, as shown in FIG. 13C, the user 1320 creates a pinch 1324 with his hand. When the user 1320 creates the pinch 1324 (or intends to create the pinch 1324), the wearable device 1302 detects the neuromuscular signals generated by the user action and determines, using the one or more processors, the motor action (pinch 1324). The wearable device 1302 provides one or more commands associated with the motor action to the computing device 1304 to perform the action. For example, as shown between 13B and 13C, the pinch 1324, causes the computing device 1304 to “Continue” the user's 1320 game 1310 and initiates the game 1310. Since the pinch is performed in the air and without contacting a screen or any display portion, it can be referred to as an in-air gesture or in-air pinch gesture as well.

The user 1320 is then able to seamlessly begin playing the game 1310. While the user 1320 is playing the game, the wearable device 1302 continues to detect neuromuscular signals generated by the user's actions and provides the associated commands to the computing device 1304 to be performed. In some embodiments, the wearable device 1302 provides the motor action to the computing device 1304, and the computing device 1304 determines the associated commands to perform.

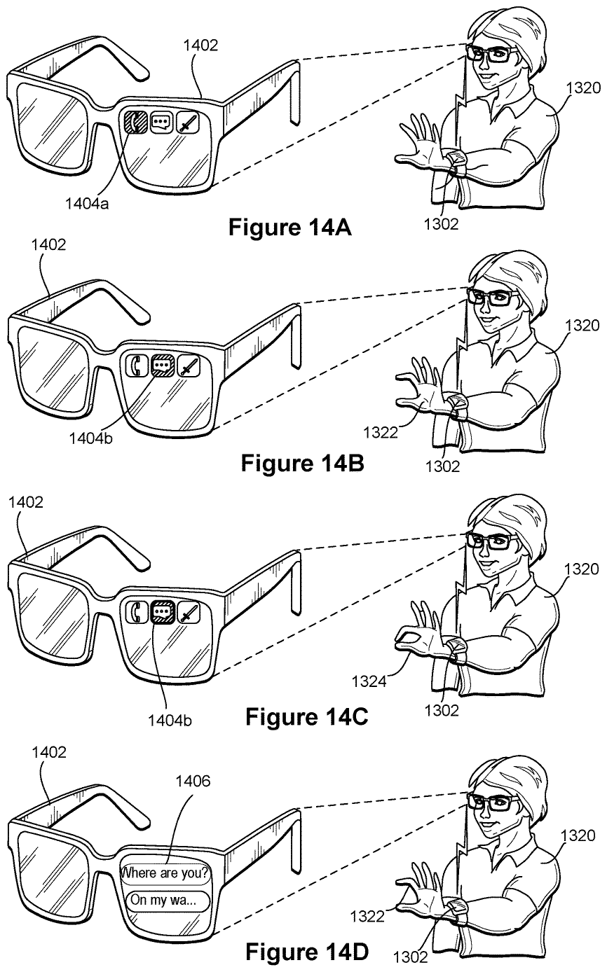

FIGS. 14A-14D illustrate another system for performing one or more commands at a computing device with a display (e.g., smart glassed 1402 or a smartwatch (e.g., a wearable device 110 with a display) at which an action is performed based on the neuromuscular signals sensed by a wearable device 1302.

As shown in FIGS. 14A-14D, the user 1320 is able to able to use the wearable device 1302 outside of an augmented reality environment. Specifically, the user 1320 can communicatively couple the wearable device 1302 with other computing devices to perform one or more actions at the computing device. The computing device can be a laptop, smart glasses, external or internal displays (e.g., a television or a display included on the capsule 112 (FIGS. 1A-2D), a phone, a table, etc. In FIG. 4A, the user 1320 is interacting with a display in his smart glasses 1402 to move between applications. As shown between FIGS. 14A and 14B, the user 1320 moves a portion of his hand (e.g. his digits 1320) to cause an action to be performed at the smart glasses 1402. Specifically, the user 1320 moves from a first applications 1404a to a second application 1404b. As described above, the action performed are based on the determined motor action based the detected neuromuscular signals by the wearable device 1302.

As shown between FIGS. 14B and 14C, user 1320 pinches his digits 1324, which causes the smart glasses 1402 to initiate the second application 1404b. When the application is initiated, the user 1320 is able to continue providing commands to the smart glasses. For example, as shown in FIG. 14D, after the user 1320 initiated the second application, a message 1406 for the application is displayed “where are you?” The user 1320 is able to quickly respond by providing commands to the smart glasses 1402 via the wearable device 1302. In this case, the user 1320 continues to move his digits 1324 which causes a response to be typed within the application “On my wa . . . ”

Although the above examples in FIGS. 13A-14D described gestures such as the movement of digits and pinches, the skilled artisan in this field will appreciate upon reading this disclosure that any number neuromuscular signals can be detected, such as movement of the arm, the elbow, the wrist, individual digits (e.g., the little finger or the thumb), portions of the digits, etc. Further, any number of gestures can be associated with the motor actions associated with each of the various neuromuscular signals. For example, instead of a pinch, a confirmation can be a fist, making an open circle with the digits, a double tap, etc.

The wearable device 1302 provides an improved man-machine interface that allows the user to interact with any number of electronic devices in a convenient and socially acceptable manner. Specifically, the wearable device 1302 includes a significantly lower number of sensors than existing solutions (e.g., 6 pairs or 8 pairs of sensors instead of 16), which allows the wearable device 1302 to be smaller, lighter, and more accessible. The wearable device 1302 can be any of the arm-wearable devices described herein.

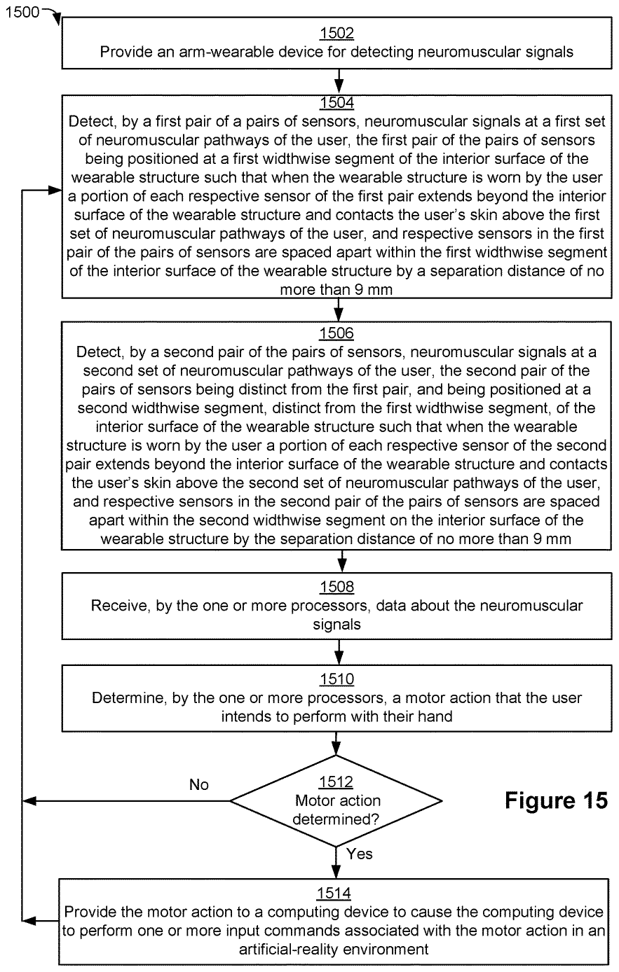

FIG. 15 is a flow diagram illustrating a method for sensing neuromuscular signals using pairs of sensors, in accordance with some embodiments. Operations (e.g., steps) of the method 1500 may be performed by one or more processors 1820 of a wearable device 110. At least some of the operations shown in FIG. 15 correspond to instructions stored in a computer memory or computer-readable storage medium (e.g., memory 1830 of the wearable device 110). Operations 1508-1514 can also be performed in part using one or more processors of a computing device (e.g., a head-mounted display device can perform operations 1508-1514 alone or in conjunction with the one or more processors of the wearable device 110).

The method 1500 includes providing (1502) an arm-wearable device for detecting neuromuscular signals (e.g., wearable device 110; FIGS. 1A-2D). The method 1500 includes detecting (1504), by a first pair of six pairs of sensors (e.g., pairs of sensors; FIGS. 1A-2D), neuromuscular signals at a first set of neuromuscular pathways of the user. The first pair of the six pairs of sensors is positioned at a first widthwise segment of the interior surface of the wearable structure (FIGS. 1A-2D) such that when the wearable structure is worn by the user a portion of each respective sensor of the first pair extends beyond the interior surface of the wearable structure and contacts the user's skin 137 (FIG. 1C) above the first set of neuromuscular pathways of the user. For example, as illustrated in FIGS. 1A-2D, the first pair of sensors can be positioned at a unique position of the wearable structure such that when the wearable structure is worn by the user the first pair of sensors make contact with either the first set of neuromuscular pathways 140a or the second set of neuromuscular pathways 140b. Respective sensors in the first pair of the six pairs of sensors are spaced apart within the first widthwise segment of the interior surface of the wearable structure by a separation distance of no more than 9 mm. Additional detail on the separation distances of the electrodes 118 (or sensors) of the pair of sensors is provided above in reference to FIGS. 4A-6D.

The method 1500 further includes detecting (1506), by a second pair of the six pairs of sensors, neuromuscular signals at a second set of neuromuscular pathways of the user. The second pair of the six pairs of sensors is distinct from the first pair, and is positioned at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin above the second set of neuromuscular pathways of the user. Additional information on the placement of the pair of sensors is provided above in reference to FIGS. 4A-6D. The respective sensors in the second pair of the six pairs of sensors are spaced apart within the second widthwise segment on the interior surface of the wearable structure by the separation distance of no more than 9 mm.

The method 1500 includes receive (1508), by the one or more processors, data about the neuromuscular signals and determining (1510), by the one or more processors, a motor action that the user intends to perform with their hand. The method 1500 then determines whether a motor action is determined (1512). If a motor action is not determined (1512), the method 1500 returns to operation (1504) and waits to detect additional neuromuscular signals. Alternatively, if a motor action is determined (1512), the method 1500 includes providing (1514) the motor action to a computing device to cause the computing device to perform one or more input commands associated with the motor action in an augmented reality (AR) or virtual reality (VR) environment. FIGS. 13A-14D provide different examples of input commands that can be performed at the computing device. After providing (1514) the motor action to a computing device, the method returns to operation (1504) and waits to detect additional neuromuscular signals.

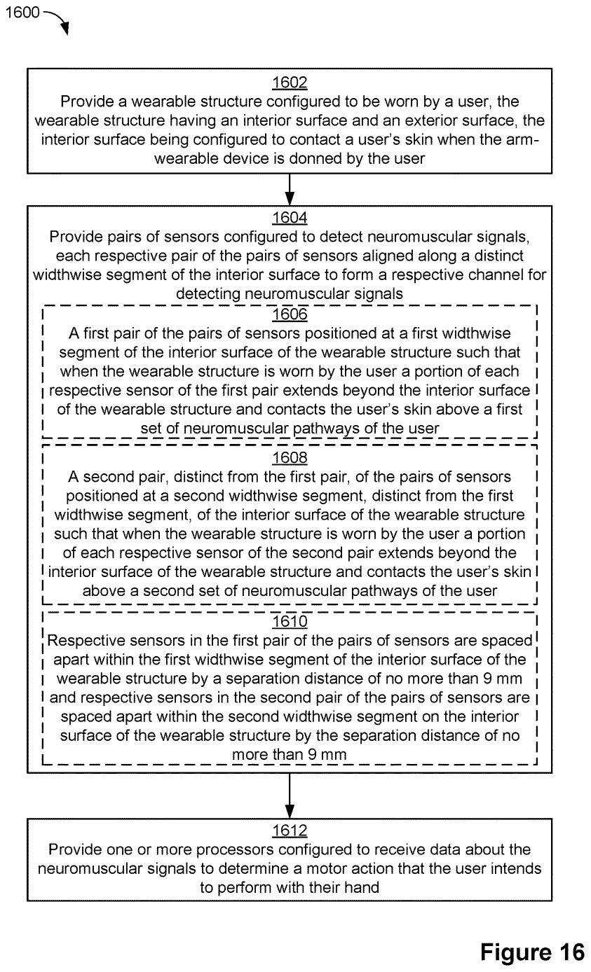

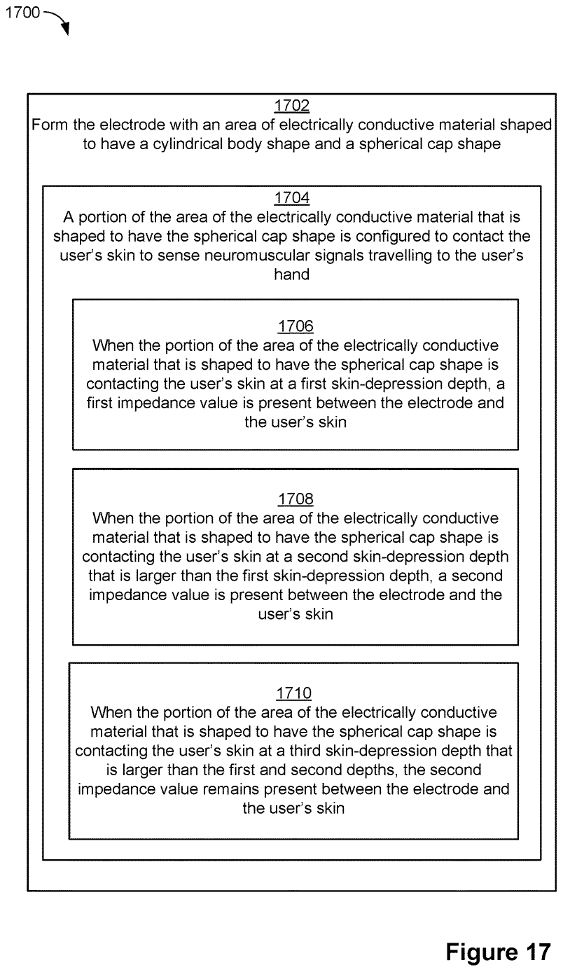

FIG. 16 is a flow diagram illustrating a method of manufacturing a wearable device for sensing neuromuscular signals using pairs of sensors, in accordance with some embodiments. Operations (e.g., steps) of the method 1600 can be performed in a different order. Some operations (e.g., steps) are optional and can be excluded.

The method 1600 includes providing a wearable structure (FIG. 1A-2D) configured to be worn by a user. The wearable structure having an interior surface and an exterior surface. The interior surface is configured to contact a user's skin 137 (FIGS. 1A-1C) when the arm-wearable device is donned by the user. The method includes providing (1602) six pairs of sensors configured to detect neuromuscular signals. Each respective pair of the six pairs of sensors aligned along a distinct widthwise segment of the interior surface to form a respective channel for detecting neuromuscular signals. For example, a pair of electrodes 118 form a channel or a first pair of sensors FIGS. 1A-2D.

In some embodiments, the method 1600 includes a first pair of the six pairs of sensors positioned (1606) at a first widthwise segment of the interior surface of the wearable structure such that when the wearable structure is worn by the user a portion of each respective sensor of the first pair extends beyond the interior surface of the wearable structure and contacts the user's skin 137 (FIG. 1C) above a first set of neuromuscular pathways of the user. In some embodiments, the method 1600 includes a second pair, distinct from the first pair, of the six pairs of sensors. The second pair is positioned (1608) at a second widthwise segment, distinct from the first widthwise segment, of the interior surface of the wearable structure such that when the wearable structure is worn by the user a portion of each respective sensor of the second pair extends beyond the interior surface of the wearable structure and contacts the user's skin 137 above a second set of neuromuscular pathways of the user. In some embodiments, respective sensors in the first pair of the six pairs of sensors are (1610) spaced apart within the first widthwise segment of the interior surface of the wearable structure by a separation distance of no more than 9 mm and respective sensors in the second pair of the six pairs of sensors are spaced apart within the second widthwise segment on the interior surface of the wearable structure by the separation distance of no more than 9 mm. Additional detail on the separation distance of the sensors and the spacing between the pairs of sensors is provided above in FIGS. 4A-6D.

The method 1600 includes providing (1612) one or more processors configured to receive data about the neuromuscular signals to determine a motor action that the user intends to perform with their hand. The determined motor action can be interpreted by the one or more processors as a gesture for causing performance of an action within (i) a display that is coupled with the exterior surface of the wearable structure and/or an artificial reality environment being presented via a head-mounted display that is separate from the wearable device) that the user intends to perform with their hand.

FIG. 17 is a flow diagram illustrating a method of manufacturing an electrode for sensing neuromuscular signals, in accordance with some embodiments. Operations (e.g., steps) of the method 1700 can be performed in a different order. Some operations (e.g., steps) are optional and can be excluded.

The method 1700 includes forming (1702) the electrode 118 (FIG. 1A-2D) with an area of electrically conductive material shaped to have a cylindrical body shape and a spherical cap shape. For example, the cylindrical body shape 902 and the spherical cap shape 904 shown above in reference to FIGS. 9A-9C. A portion of the area of the electrically conductive material that is shaped to have the spherical cap shape is configured (1704) to contact the user's skin 137 (FIG. 1C) to sense neuromuscular signals travelling to the user's hand.

When the portion of the area of the electrically conductive material that is shaped to have the spherical cap shape is contacting the user's skin at a first skin-depression depth, a first impedance value is present (1706) between the electrode and the user's skin. When the portion of the area of the electrically conductive material that is shaped to have the spherical cap shape is contacting the user's skin at a second skin-depression depth that is larger than the first skin-depression depth, a second impedance value is present (1708) between the electrode and the user's skin. When the portion of the area of the electrically conductive material that is shaped to have the spherical cap shape is contacting the user's skin at a third skin-depression depth that is larger than the first and second depths, the second impedance value remains present (1710) between the electrode and the user's skin. Additional examples of the skin-depression depth are provided above in FIGS. 10A-10D.

FIG. 18 is a block diagram illustrating a system 1800 including a wearable device 110 (FIGS. 1A-2D), in accordance with various embodiments. While some example features are illustrated, various other features have not been illustrated for the sake of brevity and so as not to obscure pertinent aspects of the example embodiments disclosed herein. To that end, as a non-limiting example, the system 1800 includes one or more wearable devices 110 (sometimes referred to as “armbands,” “wristbands,” “arm-wearable devices,” “wrist-wearable devices,” or simply “apparatuses”), which can be used in conjunction with one or more computing devices 1860. In some embodiments, the system 1800 provides the functionality of a virtual-reality device, an augmented-reality device, a mixed-reality device, hybrid reality device, or a combination thereof. In some embodiments, the system 1800 provides the functionality of a user interface and/or one or more user applications (e.g., games, word processors, messaging applications, calendars, clocks, etc.).

In some embodiments, the system 1800 provides the functionality to control or provide commands to the one or more computing devices 1860 based on a wearable device 110 determining motor actions or intended motor actions of the user. A motor action is an intended motor action when before the user performs the motor action or before the user completes the motor action, the detected neuromuscular signals travelling through the neuromuscular pathways can be determined to be the motor action. The one or more computing devices 1860 include one or more of a head-mounted display, smartphones, tablets, smart watches, laptops, computer systems, augmented reality systems, robots, vehicles, virtual avatars, user interfaces, the wearable device 110, and/or other electronic devices and/or control interfaces.

The wearable device 110 includes a wearable structure worn by the user (e.g., wearable structure; FIG. 1A-2D). In some embodiments, the wearable device 110 collects information about a portion of the user's body (e.g., the user's hand) that can be used as input to perform one or more command the computing device 1860. In some embodiments, the collected information about a portion of the user's body (e.g., the user's hand) can be used as input to perform one or more command at the wearable device 110 (e.g., selecting content to present on the electronic display 1840 of the wearable device 110 or controlling one or more applications 1838 locally stored on the wearable device 110). The information collected about the portion of the user's body include neuromuscular signals that can be used by the one or more processors 1820 of the wearable device 110 to determine a motor action that the user intends to perform with their hand.

In the illustrated embodiment, the wearable device 110 includes one or more of the one or more processors 1820, memory 1830, sensors (or electrodes 118), an electronic display 1840, a communication interface 1845, and a learning module 1850. In some embodiments, the memory 1830 includes one or more of user profiles 1832, motor actions 1834, user defined gestures 1836, and applications 1838. The wearable device 110 may include additional components that are not shown in FIG. 18, such as a power source (e.g., an integrated battery, a connection to an external power source), a haptic feedback generator, etc. In some embodiments, one or more of the components shown in FIG. 18 are housed withing the capsule 112 (FIGS. 1A-1C) of the wearable device.

In some embodiments, the electrodes 118 include one or more hardware devices that contact the user's skin 137 (FIG. 1C) detect neuromuscular signals from neuromuscular pathways (e.g., first set of neuromuscular pathways 140a or the second set of neuromuscular pathways 140b) under the user's skin 137. The electrodes 118 are configured to detect different digit movements, wrist movements, arm movements, thumb movements, hand movements, etc. from the different neuromuscular signals detected from the user's skins 137 (or neuromuscular pathways 140). In some embodiments, the electrodes 118 are used in pairs to form respective channels for detecting neuromuscular signals. Each channel is a pair of sensors (FIGS. 1A-2D). In some embodiments, the wearable device 110 includes six pairs of sensors. Addition information on the electrodes 118 is provided above in reference to FIGS. 8-9C.

The one or more processors 1820 are configured to receive the neuromuscular signals detected by the electrodes 118 and determine a motor action 1834. In some embodiments, each motor action 1834 is associated with one or more input commands. The input commands when provided to a computing device 1860 cause the computing device to perform an action. Alternatively, in some embodiments the one or more input commands can be used to cause the wearable device 110 to perform one or more actions locally (e.g., present a display on the electronic display 1840, operate one or more applications 1838, etc.). For example, the wearable device 110 can be a smartwatch and the one or more input commands can be used to cause the smartwatch to perform one or more actions. In some embodiments, the motor action 1834 and its associate input commands is stored in memory 1830. In some embodiments, the motor actions 1834 can include digit movements, hand movements, wrist movements, arm movements, pinch gestures, thumb movements, hand clenches (or fists), waving motions, and/or other movements of the user's hand or arm.

In some embodiments, the user can define one or more gestures using the learning module 1850. Specifically, in some embodiments, the user can enter a training phase in which a user defined gesture is associated with one or more input commands that when provided to a computing device 1860 cause the computing device to perform an action. Similarly, the one or more input commands associated with the user defined gesture can be used to cause the wearable device 110 to perform one or more actions locally. The user defined gesture, once trained, is stored in memory 1830. Similar to the motor actions 1834, the one or more processors 1820 can use the detected neuromuscular signals by the electrodes 118 to determine that a user defined gesture was performed by the user.

The one or more applications 1838 stored in memory 1830 can be productivity based applications (e.g., calendars, organizers, word processors), social applications (e.g., social platforms), games, etc. In some embodiments, the one or more applications 1838 can be presented to the user via the electronic display 1840. In some embodiments, the one or more applications 1838 are used to facilitate the transmission of information (e.g., to another application running on a computing device). In some embodiments, the user can provide one or more input commands based on the determined motor action to the applications 1838 operating on the wearable device 110 to cause the applications 1838 to perform the input commands. Additional information on one or more applications is provided below.

Additionally, different user profiles 1832 can be stored in memory 1830. The allows the wearable device 110 to provide user specific performance. More specifically, the wearable device 110 can be tailored to perform as efficiently as possible for each user.

The communication interface 1845 enables input and output to the computing device 1860. In some embodiments, the communication interface 1845 is a single communication channel, such as USB. In other embodiments, the communication interface 1845 includes several distinct communication channels operating together or independently. For example, the communication interface 1845 may include separate communication channels for sending input commands to the computing device 1860 to cause the computing device 1860 to perform one or more actions. In some embodiments, data from the electrodes 118 and/or the determined motor actions are sent to the computing device 1860, which then interprets the appropriate input response based on the received data. The one or more communication channels of the communication interface 1845 can be implemented as wired or wireless connections. In some embodiments, the communication interface 1845 includes hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document.

A computing device 1860 presents media to a user. Examples of media presented by the computing device 1860 include images, video, audio, or some combination thereof. Additional examples of media include executed virtual-reality applications and/or augmented-reality applications to process input data from the sensors 118 on the wearable device 110. In some embodiments, the media content is based on received information from one or more applications 1870 (e.g., productivity applications, social applications, games, etc.). The computing device 1860 includes an electronic display 1865 for presenting media content to the user. In various embodiments, the electronic display 1865 comprises a single electronic display 1865 or multiple electronic displays 1865 (e.g., one display for each eye of a user). The computing device 1860 includes a communication interface 1875 that enables input and output to other devices in the system 1800. The communication interface 1875 is similar to the communication interface 1845.

In some embodiments, the computing device 1860 receives instructions (or commands) from the wearable device 110. In response to receiving the instructions, the computing device 1860 performs one or more actions associated with the instructions (e.g., perform the one or more input commands in an augmented reality (AR) or virtual reality (VR) environment). Alternatively, in some embodiments, the computing device 1860 receives instructions from external device communicatively coupled to the wearable device 110, and in response to receiving the instructions, performs one or more actions associated with the instructions. In some embodiments, the computing device 1860 receives instructions from the wearable device 110, and in response to receiving the instructions, provides the instruction to an external device communicatively coupled to the computing device 1860 which performs one or more actions associated with the instructions. Although not shown, in the embodiments that include a distinct external device, the external device may be connected to the wearable device 110, and/or the computing device 1860 via a wired or wireless connection. The external device may be remote game consoles, additional displays, additional head-mounted displays, and/or any other additional electronic devices that can be could to be coupled in conjunction with the wearable device 110 and/or the computing device 1860.

In some embodiments, the computing device 1860 provides information to the wearable device 110, which in turn causes the wearable device to present the information to the user. The information provided by the computing device 1860 to the wearable device 110 can include media content (which can be displayed on electronic display 1840 of the wearable device 110), organizational data (e.g., calendars, phone numbers, invitation, directions), files (such as word processing documents, spreadsheets, or other documents that can be worked on locally from the wearable device 110).

The computing device 1860 can be implemented as any kind of computing device, such as an integrated system-on-a-chip, a microcontroller, a desktop or laptop computer, a server computer, a tablet, a smart phone or other mobile device. Thus, the computing device 1860 includes components common to typical computing devices, such as a processor, random access memory, a storage device, a network interface, an I/O interface, and the like. The processor may be or include one or more microprocessors or application specific integrated circuits (ASICs). The memory 1867 may be or include RAM, ROM, DRAM, SRAM and MRAM, and may include firmware, such as static data or fixed instructions, BIOS, system functions, configuration data, and other routines used during the operation of the computing device and the processor. The memory also provides a storage area for data and instructions associated with applications and data handled by the processor.

The storage device provides non-volatile, bulk, or long term storage of data or instructions in the computing device. The storage device may take the form of a magnetic or solid state disk, tape, CD, DVD, or other reasonably high capacity addressable or serial storage medium. Multiple storage devices may be provided or available to the computing device. Some of these storage devices may be external to the computing device, such as network storage or cloud-based storage. The network interface includes an interface to a network and can be implemented as either wired or wireless interface. The I/O interface interfaces the processor to peripherals (not shown) such as, for example and depending upon the computing device, sensors, displays, cameras, color sensors, microphones, keyboards, and USB devices.

In the example shown in FIG. 18, the computing device 1860 further includes applications 1870. In some embodiments, the applications 1870 are implemented as software modules that are stored on the storage device and executed by the processor 1880. Some embodiments of the computing device 1860 include additional or different components than those described in conjunction with FIG. 18. Similarly, the functions further described below may be distributed among components of the computing device 1860 in a different manner than is described here.

Each application 1870 is a group of instructions that, when executed by a processor, generates specific content for presentation to the user. For example, an application 1870 can include virtual-reality application that generates virtual-reality content (such as a virtual reality environment) and that further generate virtual-reality content in response to inputs received from the wearable devices 110 (based on determined user motor actions). Examples of virtual-reality applications include gaming applications, conferencing applications, and video playback applications. Additional examples of applications 1870 can include productivity based applications (e.g., calendars, organizers, word processors, etc.), social based applications (e.g. social media platforms, dating platforms, etc.), entertainment (e.g., shows, games, movies, etc.), travel (e.g., ride share applications, hotel applications, airline applications, etc.).

In some embodiments, the computing device 1860 allows the applications 1870 to operate in conjunction with the wearable device 110. In some embodiments, the computing device 1860 receives information from the sensors 118 of the wearable device 110 and provides the information to an application 1870. Based on the received information, the application 1870 determines media content to provide to the computing device 1860 (or the wearable device 110) for presentation to the user via the electronic display 1865 and/or a type of haptic feedback. For example, if the computing device 1860 receives information from the sensors 118 on the wearable device 110 indicating that the user has performed an action (e.g., performed a sword slash in a game, opened a file, typed a message, etc.), the application 1870 generates content for the computing device 1860 (or the wearable device 110) to present, the content mirroring the user's instructions based on determined motor actions by the wearable device 110. Similarly, in some embodiments, the applications 1870 receive information directly from the sensors 118 on the wearable device 110 (e.g., applications locally saved to the wearable device 110) and provide media content to the computing device 1860 for presentation to the user based on the information (e.g., determined motor actions by the wearable device 110)

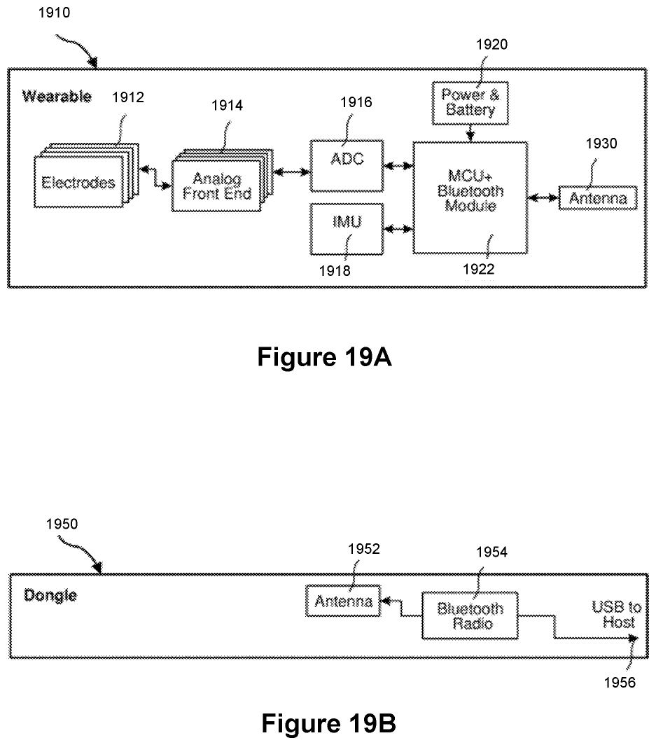

FIGS. 19A and 19B illustrate block diagrams of one or more internal components of an apparatus that may include one or more neuromuscular sensors (e.g., electrodes 118), such as EMG sensors. The apparatus may include a wearable device 1910, which can be an instance of wearable device 110 described above in reference to FIGS. 1A-2D, and a dongle portion 1950 (shown schematically in FIG. 19B) that may be in communication with the wearable device 1910 (e.g., using BLUETOOTH or another suitable short range wireless communication technology). In some embodiments, the function of the dongle portion 1950 (e.g., a similar circuit as that shown in FIG. 19B) is integrated in a device. For example, the function of the dongle portion 1950 may be included within a head-mounted device, allowing the wearable device 1910 to communicate with the head-mounted device. Alternatively, or additionally, in some embodiments, the wearable device 1910 is in communication with integrated communication devices (e.g., BLUETOOTH or another suitable short range wireless communication technology) of with one or more electronic devices, augmented reality systems, computer systems, robots, vehicles, virtual avatars, user interfaces, etc. In some embodiments, the dongle portion 1950 is optional.

FIG. 19A illustrates a block diagram of the wearable device 1910, in accordance with some implementations. In some embodiments, the wearable device 1910 includes one or more sensors 1912, an analog front end 1914 (e.g., pairs of sensors or rigid PCBAs 360 shown above in reference to FIGS. 1A-3B), an analog-to-digital converter (ADC) 1916, one or more (optional) inertial measurement unit (IMU) sensor 1918, a microcontroller (MCU) 1922, a power supply 1920, and an antenna 1930.

The one or more sensors 1912 can be an instance of the neuromuscular sensors or electrodes 118 described above in reference to FIGS. 1A-2D and 8-9C. In some embodiments, each sensor 1912 includes one or more electrodes 118 for detecting electrical signals originating from a body of a user (i.e., neuromuscular signals). In some embodiments, the sensor signals from the sensors 1912 are provided to the analog front end 1914. In some embodiments, the analog front end 1914 is configured to perform analog processing (e.g., noise reduction, filtering, etc.) of the sensor signals. The processed analog signals are provided to the ADC 1916, which converts the processed analog signals to digital signals. In some embodiments, the digital signals are further processed by one or more computer processors, such as the MCU 1922. In some embodiments, the MCU 1922 receives and processes signals from additional sensors, such as IMU sensors 1918 or other suitable sensors. The output of the processing performed by MCU 1922 may be provided to antenna 1930 for transmission to the dongle portion 1950 or other communicatively coupled communication devices.

In some embodiments, the wearable device 1910 includes or receives power from, the power supply 1920. In some embodiments, the power supply 1920 includes a battery module or other power source.

FIG. 19B illustrates a block diagram of the dongle portion 1950, in accordance with some embodiments. The dongle portion 1950 includes one or more of an antenna 1952, a radio 1954 (e.g., a BLUETOOTH radio (or other receiver circuit), and a device output 1956 (e.g., a USB output).

The antenna 1952 is configured to communicate with the antenna 1930 associated with wearable device 1910. In some embodiments, communication between antennas 1930 and 1952 occur using any suitable wireless technology and protocol, non-limiting examples of which include radiofrequency signaling and BLUETOOTH. In some embodiments, the signals received by antenna 1952 of dongle portion 1950 are received by the radio 1954 and provided to a host computer through the device output 1956 for further processing, display, and/or for effecting control of a particular physical or virtual object or objects.

In some embodiments, the dongle portion 1950 is inserted, via the device output 1956, into a separate computer device (e.g., a laptop, a phone, a computer, tablet, etc.), that may be located within the same environment as the user, but not carried by the user. This separate computer may receive control signals from the wearable device 1910 and further process these signals to provide a further control signal to one or more devices, such as a head-mounted device or other devices identified in FIG. 19A. For example, the control signals provided to the separate computer device may trigger the head-mounted device to modify the artificial reality view or perform one or more commands based on a sequence or a pattern of signals provided by the user (and detected by the one or more sensors 1912). In some embodiments, the dongle portion 1950 (or equivalent circuit in a head-mounted device or other device) may be network enabled, allowing communication with a remote computer (e.g., a server, a computer, etc.) through the network. In some embodiments, the remote computer may provide control signals to the one or more devices to trigger the one or more devices to perform one or more commands (e.g., modify the artificial reality view). In some embodiments, the dongle portion 1950 is inserted into the one or more devices to improve communications functionality. In some embodiments, when the dongle portion 1950 is inserted into the one or more devices, the one or more devices perform further processing (e.g., modification of the AR image) based on the control signal received from the wearable device 1910.

In some embodiments, the dongle portion 1950 is included in the one or more devices (e.g., a head-mounted device, such as an artificial reality headset). In some embodiments, the circuit described above in FIG. 19B is provided by (i.e., integrated within) components of the one or more devices. In some embodiments, the wearable device 1910 communicates with the one or more devices using the described wireless communications, and/or a similar schematic circuit, or a circuit having similar functionality.

Descriptions will now be provided of certain shielding designs/structures that can be used in conjunction with the neuromuscular sensors and, more generally, the arm-wearable devices discussed herein. This discussion of the shielding designs will be had with reference to FIGS. 20-28. Attention is first directed to FIG. 20. FIG. 20 illustrates a first embodiment of a system for shielding components used to detect neuromuscular signals, in accordance with various embodiments. The first embodiment 2000 of the system for shielding components shields at least one analog component 2020 for processing neuromuscular signals detected by a neuromuscular sensor 2030. The first embodiment 2000 of the shielding system can be included in any of the wearable devices described above in reference to FIGS. 1A-19. In some embodiments, the first embodiment 2000 of the shielding system includes an elastomer band 2005 configured to be worn by a user, a circuit board 2025, the at least one analog component 2020 coupled with the circuit board 2025, the neuromuscular sensor 2030 also coupled with the circuit board 2025, and an electromagnetic (EM) shield 2010 that is shaped to surround at least a portion of the circuit board 2025 (as described below). In some embodiments, an additional neuromuscular sensor 2030 is also coupled with the circuit board 2025 forming a respective pair of sensors as described above in reference to FIGS. 1A-3B. The one or more components of the first embodiment 2000 of the shielding system are described in detail below.

The elastomer band 2005 is an instance of the elastomer band 320 described above in reference to FIG. 3A. For example, the elastomer band 2005 can be part of a band portion 114 described above in reference to FIGS. 1A-3A. The elastomer band 2005 can fully or partially house one or more of the circuit board 2025, the at least one analog component 2020, the EM shield 2010, and a portion of the neuromuscular sensor 2030. In some embodiments, the at least one analog component 2020, the circuit board 2025, the EM shield 2010, and a portion of the neuromuscular sensor 2030 are assembled into a preformed elastomer (such as the elastomer band 2005). For example, the at least one analog component 2020, the circuit board 2025, the EM shield 2010, and a portion of the neuromuscular sensor 2030 are assembled within empty space or vacuum 2015 of the elastomer band 2005. In some embodiments, the elastomer band 2005 surrounds all of the circuit board 2025 and the at least one analog component 2020.

The elastomer band 2005 is configured to be worn around a portion of the user's arm and contact a portion of the user's skin. For example, the elastomer band 2005 can be worn around the user's wrist, forearm, bicep, or other portion of their arm. In some embodiments, the elastomer band 2005 separates the EM shield 2010 from the user's skin.

The circuit board 2025 can be FPC, PCBA, or other surface-mounted technology (SMT) assembly. The circuit board 2025 includes a bottom surface 2029 coupled with a neuromuscular sensor 2030; a top surface 2028, positioned opposite the bottom surface 2029, coupled with at least one analog component 2020 for at least partially processing neuromuscular signals detected by the neuromuscular sensor 2030; a first side surface 2026 disposed between the top and bottom surfaces, and a second side surface 2027, positioned opposite the first side surface 2026, disposed between the top and bottom surfaces 2028 and 2029.

In the depicted example of FIG. 20, the neuromuscular sensor 2030 extends beyond an interior surface of the elastomer band 2005 (the interior surface is the surface that would be in contact with the user's skin with the band is worn by a user) a predetermined distance and is depressed into the user's skin above the one or more neuromuscular pathways (when the elastomer band 2005 is worn by the user). In some embodiments, the neuromuscular sensor 2030 is an electrode. The neuromuscular sensor 2030 is configured to detect or sense one or more neuromuscular signals from the one or more neuromuscular pathways. The neuromuscular sensor 2030 detects the one or more neuromuscular signals in analog format and provides the detected neuromuscular signals to the at least one analog component 2020 for processing as discussed in detail below. Although not shown, in some embodiments, the neuromuscular sensor 2030 is part of a pair of neuromuscular sensors as described above in reference to FIGS. 1A-2D. Additional information on the neuromuscular sensor 2030 is provided above in reference to FIGS. 1A-2D, 7A-10D, and 12. And, while the example neuromuscular sensor 2030 is one that extends beyond the interior surface of elastomer band 2005, other configurations of neuromuscular sensors are also contemplated, include flat sensors/electrodes that do not extend beyond the interior surface of the elastomer band 2005 (e.g., an end of the sensor sits flush with the interior surface that is in contact with the user's skin, the end of the sensor sits slightly behind this interior surface (e.g., 0.01-0.1 mm behind this interior surface), or a combination of this configurations for the various sensors included with the wearable device as a whole).

The at least one analog component 2020 is configured to at least partially process the one or more neuromuscular signals sensed by the neuromuscular sensor 2030. More specifically, the at least one analog component 2020 is, in some embodiments, part of an AFE that can be configured to perform one or more processing operations on the sensed neuromuscular signals, the one or more processing operations can include buffering, filtering, amplifying, and converting the signals from an analog format to a digital format (different AFEs can be configured to perform one or all of these one or more processing operations). In some embodiments, the at least one analog component 2020 include one or more AFEs or other components described above in reference to FIGS. 7A, 7B, and 12. The at least one analog component 2020 can also be configured to provide processed neuromuscular signals to a common compute core that is coupled with the watch capsule/display portion of the wearable device (the common compute core can then analyze processed neuromuscular signals received from various instances of the various embodiments of the shielding systems described herein to determine motor action(s) that the user intends to perform with their hand). The determination of the motor action is described above in reference to FIGS. 1A-1C and 13A-16.

The EM shield 2010 is shaped to surround at least part of the first side surface 2026 of the circuit board 2025, at least part of the second side surface 2027 of the circuit board 2025, and the at least one analog component 2020. The EM shield 2010 is configured to mitigate power line interference present in the neuromuscular signals. In some embodiments, the EM shield 2010 surrounds all of the first side surface and all of the second side surface. In some embodiments, the EM shield 2010 further surrounds a portion of the additional neuromuscular sensor and the neuromuscular sensor 2035 (e.g., a pair of sensors 118 described above in reference to FIG. 2D, where such pairs are not limited to sensor configurations/shapes that depress into a user's skin but also include flat sensors or electrodes that be in close contact with a user's skin but do not necessarily depress into the user's skin). In some embodiments, the EM shield 2010 is stamped or formed sheet metal. In some embodiments, the EM shield 2010 extends beyond the circuit board 2025 (e.g., beyond the first side surface 2026 and the second side surface 2027 of the circuit board 2025 (represented by the unfilled rectangular boxes that extend beyond the filled in part of 2010 in FIG. 20)). For example, the EM shield 2010 can extend beyond a thickness of the circuit board 2025 surrounding a portion of the additional neuromuscular sensor and the neuromuscular sensor. In some embodiments, the EM shield 2010 extends beyond the circuit board 2025 and into a portion of the elastomer band 2005.

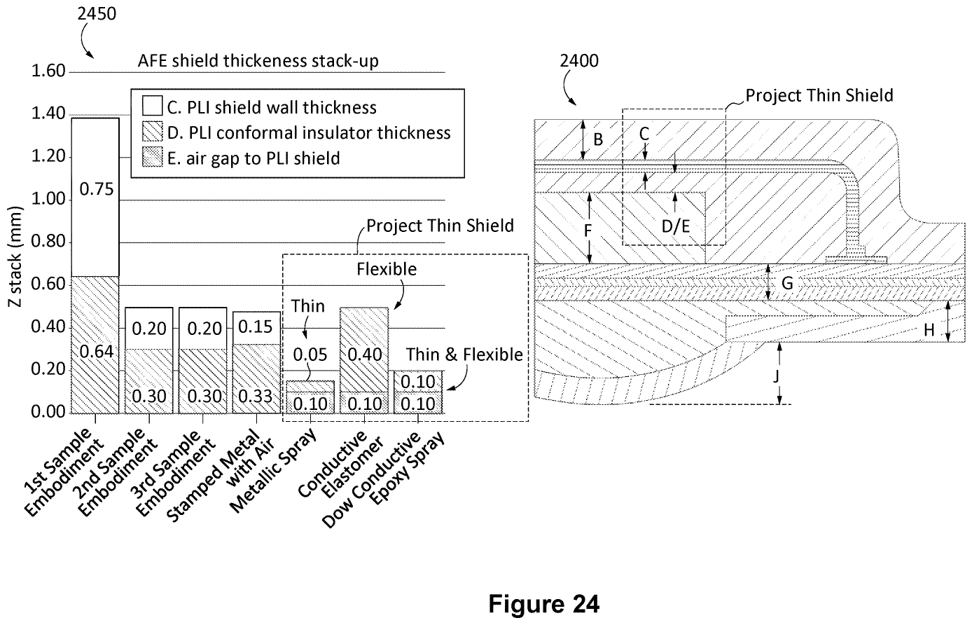

The EM shield 2010 is substantially adjacent to one or more electrical components (e.g., at least the at least one analog component 2020 and/or other electrical components coupled with or in communication with the circuit board 2025). In some embodiments, the EM shield 2010 almost contacts (e.g., is within 0.01-0.1 mm of making contact with the closest surface portion of the at least one analog component 2020) or contacts the one or more electrical components. In some embodiments, the EM shield 2010 is separated from the one or more electrical components by an insulative material (e.g., air or lack thereof in empty space or vacuum 2015). By placing the EM shield 2010 substantially adjacent to the one or more electrical components, the height occupied by the EM shield 2010 is reduced and thus overall height requirements for the band in which the EM shield is positioned can be reduced, which leads to a better, consumer-friendly shape and structure for the band portion (and for wearable devices, such as smart watches, that incorporate and use the band portion). More specifically, the EM shield 2010 makes up less than a predefined thickness of the elastomer band 2005. Sample measurements for the EM shield 2010, the elastomer band 2005, at least the at least one analog component 2020, and the circuit board 2025 are provided below in reference to FIG. 24.

As described above, the EM shield 2010 is configured to mitigate power line interference. In some embodiments, mitigating power line interference present in the neuromuscular signals includes reducing the power line interference present in the neuromuscular signals by at least 20% as compared to use of the neuromuscular sensor without the EM shield 2010. In some embodiments, the EM shield 2010 increases a neuromuscular signal signal-to-noise ratio by reducing interference. Additionally, the first embodiment 2000 of the system for shielding components incorporates established and industry standard shielding technology. The EM shield 2010 shape is limited due to the manufacturing processes used to create the EM shield 2010 and mount the EM shield 2010 to the circuit board 2025.

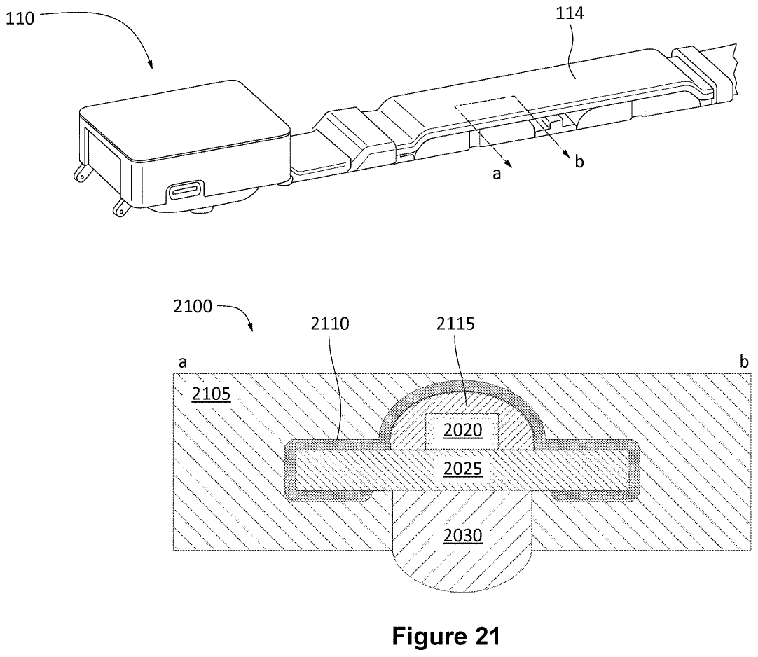

FIG. 21 illustrates a second embodiment of a shielding system for a wearable device, in accordance with various embodiments. The second embodiment 2100 of the shielding system shields at least one analog component 2020 for processing neuromuscular signals detected by a neuromuscular sensor 2030. The second embodiment 2100 of the shielding system can be included in any of the wearable devices described above in reference to FIGS. 1A-19. In some embodiments, the second embodiment 2100 of the shielding system includes an elastomer band 2105 configured to be worn by the user, a circuit board 2025, the at least one analog component 2020 coupled with the circuit board 2025, the neuromuscular sensor 2030 also coupled with the circuit board 2025, an EM shield 2110 that is shaped to surround at least a portion of the circuit board 2025, and an insulative material 2115. The elastomer band 2105, the circuit board 2025, the at least one analog component 2020, and the neuromuscular sensor 2030 are similar to the components described above in reference to FIG. 20.

In some embodiments, the EM shield 2110 is applied via a metallic spray and/or sputter. In some embodiments, the metallic spray material is one of acrylic, urethane, or silicone bases with fillers of carbon, graphite, nickel, silver, or silver coated copper. In some embodiments, the EM shield 2110 surrounds the at least one analog component 2020. More specifically, in some embodiments, the EM shield 2110 is a metallic layer formed by a metallic spray distributed over at least the top surface 2028 (FIG. 20) of the circuit board 2025, the at least one analog component 2020, all of the first side surface 2026 (FIG. 20) of the circuit board 2025, all of the second side surface 2027 (FIG. 20) of the circuit board 2025, and a portion of the bottom surface 2029 (FIG. 20) of the circuit board 2025; and an insulative material 2115 is disposed between the metallic layer and the at least one analog component 2020. The EM shield 2110 can further surround one or more electrical components of the circuit board 2025 (e.g., at least one analog component 2020 and/or other electrical components coupled with the circuit board 2025). Use of the metallic spray or sputter can require potting the at least one analog component 2020 (and other AFE components) and masking neuromuscular sensor area before application.

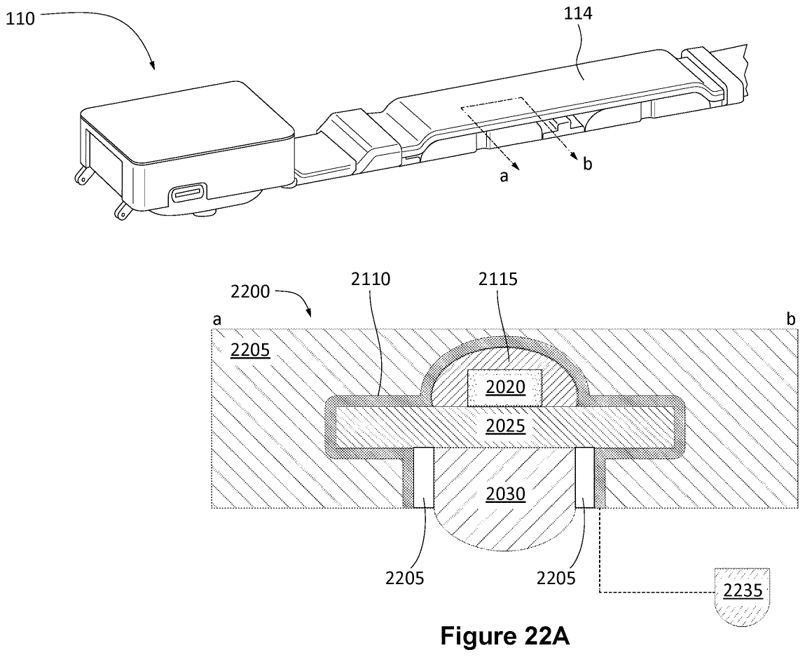

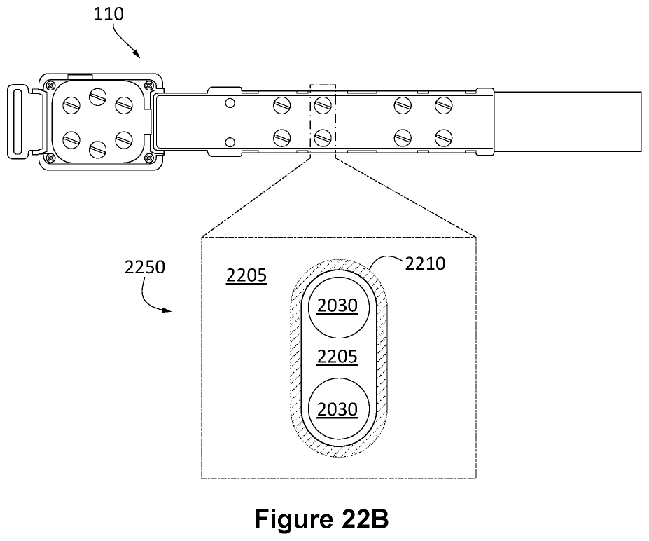

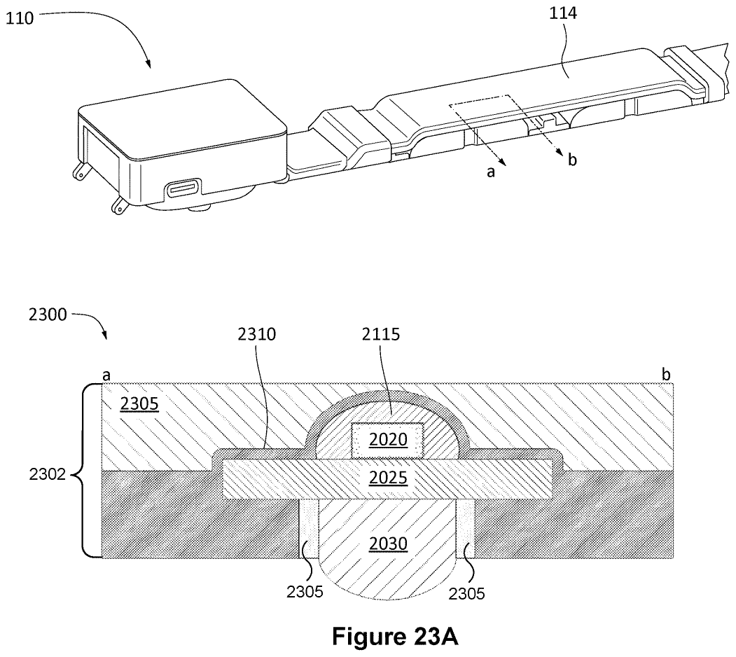

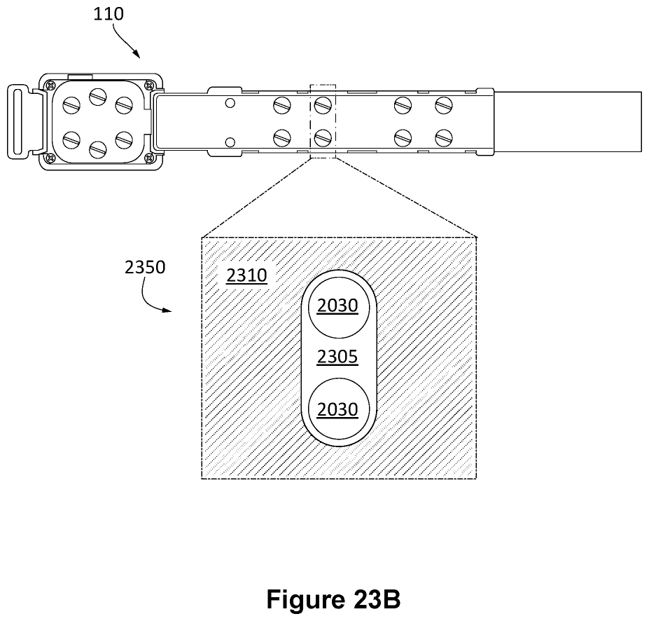

Additionally, in some embodiments, the metallic spray is distributed such that the EM shield 2110 surrounds a substantial portion (e.g., at least 80%) or all of the circuit board 2025. In some embodiments, a portion of the circuit board 2025 that is coupled with the neuromuscular sensor 2030 is left uncovered by the metallic layer (e.g., the EM shield 2110 is not placed directly on the neuromuscular sensor 2030). In some embodiments, the EM shield 2110 surrounds an area around the neuromuscular sensor 2030 (e.g., forming an island or racetrack as shown below in reference to FIGS. 22A-23B). The EM shield 2110 is configured to mitigate power line interference and increase a neuromuscular signal signal-to-noise ratio by reducing interference, similar to what was described above for the first embodiment described with reference to FIG. 20.

The insulative material 2115 separates the EM shield 2010 from one or more electrical components on the circuit board 2025 (e.g., at least the at least one analog component 2020 and/or other electrical components on the circuit board 2025). In particular, the insulative material 2115 is disposed between the metallic layer and the one or more electrical components. In some embodiments, the insulative material 2115 is a resin, adhesive, or other conformal coating. in some embodiments, the insulative material 2115 is made of acrylic, epoxy, polyurethane, silicon, fluorinated or non-fluorinated-poly-para-xylylene (parylene), amorphous fluoropolymer, or other material. In some embodiments, the insulative material 2115 is a non-conductive elastomer.

The EM shield 2110 includes analogous features to the EM shield 2010. For example, the EM shield 2110 is substantially adjacent to one or more electrical components. In some embodiments, the EM shield 2110 almost contacts or contacts the one or more electrical components. The EM shield 2110 is placed substantially adjacent to one or more electrical components such that the height occupied by the EM shield 2110 is reduced. The EM shield 2110 makes up less than a predefined thickness of the elastomer band 2105. Sample measurements for the EM shield 2110 and other components are provided below in reference to FIG. 24. The second embodiment 2100 of the system for shielding components can reduce the required band 114 thickness compared to the first embodiment 2000 of the system for shielding components. The second embodiment 2100 of the system for shielding components allows for more organic shapes of the assembly which can reduce encumbrance of the wearer.

FIGS. 22A and 22B illustrate a third embodiment of a shielding system for a wearable device, in accordance with various embodiments. The third embodiment 2200 of the system for shielding components shields at least one analog component 2020 for processing neuromuscular signals detected by a neuromuscular sensor 2030. The third embodiment 2200 of the shielding system can be included in any of the wearable devices described above in reference to FIGS. 1A-19. In some embodiments, the third embodiment 2200 of the shielding system includes an elastomer band 2205 configured to be worn by the user, a circuit board 2025, the at least one analog component 2020 coupled with the circuit board 2025, the neuromuscular sensor 2030 also coupled with the circuit board 2025, an EM shield 2210 that is shaped to surround at least a portion of the circuit board 2025, and an insulative material 2115. The elastomer band 2205, the circuit board 2025, the at least one analog component 2020, the neuromuscular sensor 2030, and insulative material 2115 are similar to the components described above in reference to FIGS. 20 and 21.

In some embodiments, the EM shield 2210 is a conductive elastomer that is formed over the top surface 2028 (FIG. 20) of the circuit board 2025, the at least one analog component 2020, all of the first side surface 2026 (FIG. 20) of the circuit board 2025, all of the second side surface 2027 (FIG. 20) of the circuit board 2025, and a portion of the bottom surface 2029 (FIG. 20) of the circuit board 2025; and an insulative material 2115 is disposed over the at least one analog component 2020 between the conductive elastomer (e.g., EM shield 2210) and the top surface 2028 of the circuit board 2025. In some embodiments, the conductive elastomer surrounds the neuromuscular sensor 2030 (and an additional neuromuscular sensor) such that a racetrack or island is formed around the neuromuscular sensor 2030 (and an additional neuromuscular sensor) as shown below in FIG. 22B. For example, the EM shield 2210 can surround a portion of the neuromuscular sensor 2030 such that a portion of the elastomer band 2205 is between the EM shield 2210 and the neuromuscular sensor 2030.

In some embodiments, a portion of the conductive elastomer extends to a portion of the elastomer band such that it contacts a portion of the user's skin when the elastomer band is worn around a user's wrist. Similar to the use of the metallic spray described above in reference to FIG. 21, use of the conductive elastomer can require potting at least one analog component 2020 (and/or other an AFE components) and masking a neuromuscular sensor area before application. The EM shield 2110 is configured to mitigate power line interference and increase a neuromuscular signal signal-to-noise ratio by reducing interference as described above. In some embodiments, the EM shield 2210 can be coupled to a (dedicated) shield electrode 2235. Examples of the shield electrode 2235 are provided above in reference to FIGS. 1A-2D and 11A-12.

The EM shield 2210 includes analogous features to those described above in reference to FIGS. 20 and 21. Sample measurements for the EM shield 2210 and other components are provided below in reference to FIG. 24. In some embodiments, the insulative material 2115 or the insulative material is disposed over the one or more electrical components (e.g., at least the at least one analog component 2020 and/or other electrical components on the circuit board 2025) between the conductive elastomer (i.e., the EM shield 2210) and the circuit board 2025. Additional information on the insulative material 2115 is provided above in reference to FIG. 21.

A bottom view 2250 of the third embodiment 2200 of the shielding system shows the placement of the neuromuscular sensor 2030 and an additional neuromuscular sensor 2030. The bottom view 2250 shows a racetrack or island formed by the EM shield 2210 that surrounds the bottom portions of the neuromuscular sensor 2030 and the additional neuromuscular sensor 2030. In some embodiments, the neuromuscular sensor 2030 and the additional neuromuscular sensor 2030 make up a pair of neuromuscular sensors configured to operate as a sensing channel (e.g., a differential sensing channel). The pair of neuromuscular sensors is within the EM shield 2210 (i.e., racetrack or island). In some embodiments, the pair of neuromuscular sensors is surrounded by a ground and/or shield. In some embodiments, the ground and/or shield are on the same raised island or racetrack for contact with the user's skin.

The third embodiment 2200 of the system for shielding components can reduce the required band 114 thickness compared to the first embodiment 2000 of the system for shielding components. Similar to the second embodiment of the second embodiment 2100 of the system for shielding components, the third embodiment 2200 of the system for shielding components allows for more organic shapes of the assembly which may reduce encumbrance of the wearer. Additionally, the third embodiment 2200 of the system for shielding components covers more circuitry than the first embodiment 2000 of the system for shielding components which can reduce power line interference. Further, the third embodiment 2200 of the system for shielding components reduces the amount of an unshielded neuromuscular sensor 2030 that is not in contact with the skin, which can further reduce power line interference in comparison to the second embodiment 2100 of the system for shielding components.

FIGS. 23A and 23B illustrate a fourth embodiment of a shielding system for a wearable device, in accordance with various embodiments. The fourth embodiment 2300 of the system for shielding components shields at least one analog component 2020 for processing neuromuscular signals detected by a neuromuscular sensor 2030. The fourth embodiment 2300 of the shielding system can be included in any of the wearable devices described above in reference to FIGS. 1A-19. In some embodiments, the fourth embodiment 2300 of the shielding system includes an elastomer band 2302 that is formed of a first portion and a second portion. The first portion is formed using a non-conductive elastomer 2305 (similar to the elastomer band described above in reference to FIGS. 20-22B) and the second portion is formed using a conductive elastomer 2310. The conductive elastomer 2310 forms an EM shield that surrounds a circuit board 2025, the at least one analog component 2020 coupled with the circuit board 2025, the neuromuscular sensor 2030 also coupled with the circuit board 2025. The EM shield (e.g., the conductive elastomer 2310) that shaped to surround at least a portion of the circuit board 2025 and an insulative material 2115. The elastomer band 2302 is configured to be worn by the user such that the conductive elastomer 2310 contacts a portion of the user's skin. The elastomer band 2105, the circuit board 2025, the at least one analog component 2020, the neuromuscular sensor 2030, and insulative material 2115 are similar to the components described above in reference to FIGS. 20-22B.

In some embodiments, the EM shield (i.e., the conductive elastomer 2310) makes up an inner surface of band portion 114 described above in reference to FIGS. 1A-3A. In some embodiments, the conductive elastomer 2310 surrounds the neuromuscular sensor 2030 (and an additional neuromuscular sensor) such that an island is formed around the neuromuscular sensor 2030 (and an additional neuromuscular sensor) as shown below in FIG. 23B. For example, the conductive elastomer 2310 can surround a portion of the neuromuscular sensor 2030 such that a portion of the non-conductive elastomer 2305 is between the EM shield and the neuromuscular sensor 2030. Similar to the use of the metallic spray described above in reference to FIG. 21 and the use of the conductive elastomer described above in reference to FIG. 22, use of the conductive inner band or EM shield 2310 can require potting at least one analog component 2020 (and/or other an AFE components) and masking a neuromuscular sensor area before application.

The EM shield 2310 includes analogous features to those described above in reference to FIGS. 20-22B. Sample measurements for the EM shield 2310 are provided below in reference to FIG. 24. In some embodiments, the insulative material 2115 or the insulative material is disposed over the one or more electrical components (e.g., at least the at least one analog component 2020 and/or other electrical components on the circuit board 2025) between the conductive inner band (i.e., the EM shield 2310) and the circuit board 2025. Additional information on the insulative material 2115 is provided above in reference to FIGS. 21 and 22.

A bottom view 2350 of the fourth embodiment 2300 of the shielding system shows the placement of the neuromuscular sensor 2030 and an additional neuromuscular sensor 2030. The bottom view 2350 shows an island formed by the EM shield 2310 that surrounds bottom portions of the neuromuscular sensors 2030. In some embodiments, the neuromuscular sensor 2030 and the additional neuromuscular sensor 2030 make up a pair of neuromuscular sensors. The pair of neuromuscular sensors is within the EM shield 2310 (e.g., within the formed island). In some embodiments, the pair of neuromuscular sensors is surrounded by a ground and/or shield. In some embodiments, the ground and/or shield are on the same raised island for contact with the user's skin.

The fourth embodiment 2300 of the system for shielding components can reduce the required band 114 thickness compared to the first embodiment 2000 of the system for shielding components. Similar to the second and third embodiment of the system for shielding components 2100 and 2200, the fourth embodiment 2300 of the system for shielding components allows for more organic shapes of the assembly which may reduce encumbrance of the wearer. Like the third embodiment 2200 of the system for shielding components, the fourth embodiment 2300 of the system for shielding components covers more circuitry than the first embodiment 2000 of the system for shielding components, which can reduce power line interference. The fourth embodiment 2300 of the system for shielding components reduces the amount of unshielded neuromuscular sensor 2030 that is not in contact with the skin, which can further reduce power line interference in comparison to the second embodiment 2100 of the system for shielding components. Further, the fourth embodiment 2300 of the system for shielding components increases the area of shielding material that contacts the skin, which can further reduce power line interference in comparison to the third embodiment 2200 of the system for shielding components. By having an entire half of the band 114 in contact with skin as a shielding material (e.g., the EM shield 2310), the fourth embodiment 2300 of the system for shielding components can reduce the complexity of tooling with respect to manufacturing wearable devices described herein as well as other wearable technology.

FIG. 24 illustrates a cross-section of a band portion 114 of a wearable device and a plot including measurements of different shielding systems, in accordance with various embodiments. Cross-section 2400 shows one or more components of a band portion 114 of a wearable device 110 (FIGS. 1A-1C) and respective thickness measurements for the one or more components of the band portion. In particular, cross-section 2400 shows thicknesses for different components of the different embodiments of the shielding systems described above in reference to FIGS. 20-23. In the cross-section 2400, “C” represents a thickness of an EM shield, “D” represents a thickness of an insulative material, and “E” represents a thickness of an air gap. For completeness, cross-section 2400 further shows a thickness for a top portion of an elastomer band “B,” a thickness for at least one analog component “F,” a thickness of FPC or a circuit board “G,” a thickness of a bottom portion of the elastomer band “H,” and a thickness of an neuromuscular sensor “J.”

Plot 2450 shows different thickness measurements for different shielding systems. The x-axis includes different shielding systems and the y-axis shows different thickness measurements for at least the thickness of an EM shield “C,” the thickness of an insulative material “D,” and/or the thickness of an air gap “E.” The first sample embodiment, the second sample embodiment, and the third sample embodiment represent comparison embodiments to illustrate certain advantages of the shielding system embodiments that were described above in reference to FIGS. 20-23B. The first sample embodiment has an EM shield thickness of 0.75 mm and an air gap of 0.64 mm, the second sample embodiment has an EM shield thickness of 0.20 mm and an air gap of 0.3 mm, the third sample embodiment has an EM shield thickness of 0.20 mm and an air gap of 0.3 mm.

The stamped metal with air embodiment represents the first embodiment 2000 of the shielding system described above in reference to FIG. 20. The stamped metal with air embodiment has an EM shield thickness of 0.15 mm (+/−0.2 mm) and an insulative material thickness of 0.33 mm (+/−0.2 mm). The metallic spray embodiment represents the second embodiment 2100 of the shielding system described above in reference to FIG. 21. The metallic spray embodiment has an EM shield thickness of 0.05 mm (+/−0.2 mm) and an insulative material thickness of 0.10 mm (+/−0.2 mm). The conductive epoxy spray embodiment represents the third embodiment 2200 of the shielding system described above in reference to FIG. 22. The conductive elastomer embodiment has an EM shield thickness of 0.10 mm (+/−0.2 mm) and an insulative material thickness of 0.10 mm (+/−0.2 mm). The conductive elastomer embodiment represents the fourth embodiment 2300 of the shielding system described above in reference to FIG. 23. The conductive elastomer embodiment has an EM shield thickness of 0.40 mm (+/−0.2 mm) and an insulative material thickness of 0.10 mm (+/−0.2 mm). As shown above in reference to FIG. 23, the conductive elastomer embodiment has a greater EM shield thickness than other embodiments because it makes up a portion of the band portion 114, so even though the EM shield can be thicker for this embodiment, the overall band thickness might still be as thin as when the other shielding system embodiments are utilized.

Each of the stamped metal with air embodiment, the metallic spray embodiment, the conductive epoxy spray embodiment, and the conductive elastomer embodiment reduce a total thickness (i.e., height) of a wearable device 110 while still reducing the power line interference present in the neuromuscular signals (e.g., by at least 20% as compared to use of the neuromuscular sensor without an EM shield). The above thicknesses have been discovered to improve a signal-to-noise ratio of the neuromuscular signals such that accurate and consistent values are measured by the electrodes while also reducing the size of the wearable device 110. This allows for the wearable device 110 to be designed with a smaller form factor that is lighter and more comfortable to users while still providing reliable detection of neuromuscular signals and accurate determination of motor actions that the user intends to perform with their hand.

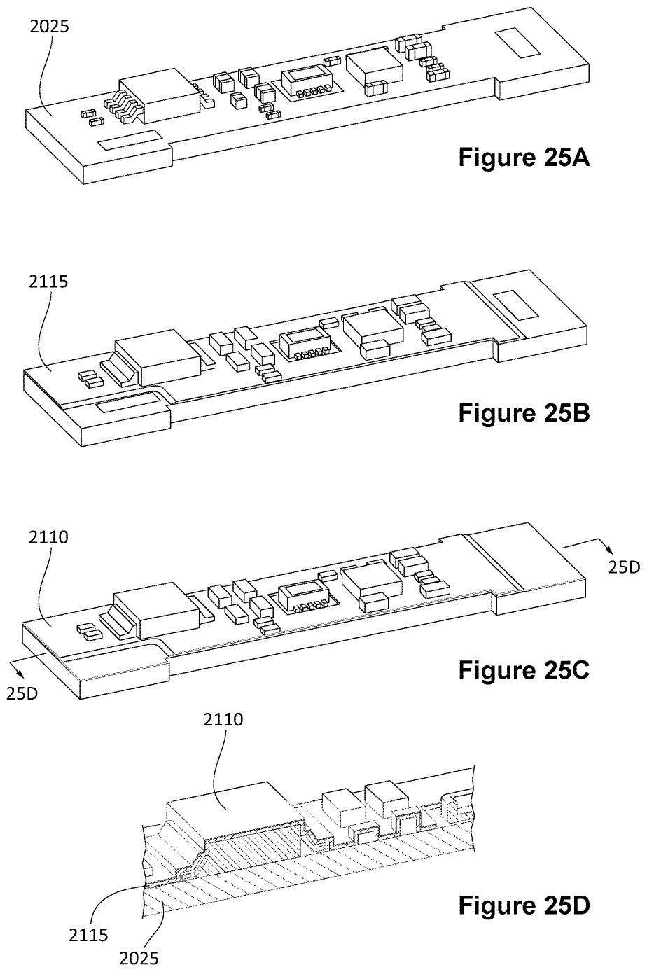

FIGS. 25A-25D illustrate a first process of applying a metal spray to at least one analog component and a circuit board. The second process of applying the metal spray can be used to form the second embodiment of a shielding system described above in reference to FIG. 21. FIG. 25A shows at least one analog component 2020 coupled with circuit board 2025. Additional information on the at least one analog component 2020 coupled with circuit board 2025 is provided above in reference to FIGS. 20-23.

FIG. 25B shows application of an insulating layer on the at least one analog component 2020 and a portion of the circuit board 2025. In some embodiments, applying the insulating layer (e.g., insulative material 2115) includes masking at least two pads and a connector. The insulating layer is formed by at least one material. Different examples of the insulating material are provided above in reference to FIG. 21. In some embodiments, the thickness of the insulating layer is approximately 0.1 mm to 0.2 mm (approximately meaning+/−0.02 mm).

FIG. 25C shows application of a metallic spray on the at least one analog component 2020 and the portion of the circuit board 2025. In some embodiments, the metallic spray connects at least two pads. In some embodiment, the metallic spray is formed of at least one material. Alternatively, in some embodiments, the metallic spray is formed of at least two materials. The metallic spray forms the EM shield 2110. Different examples of the metallic spray are provided above in reference to FIG. 21. In some embodiments, the thickness of the metallic spray is approximately 0.5 mm to 0.1 mm (approximately meaning+/−0.02 mm).

FIG. 25D shows a cross-section application of the second embodiment of a shielding system. FIG. 25D shows the different layers for the insulative material 2115 and the metallic layer 2110.

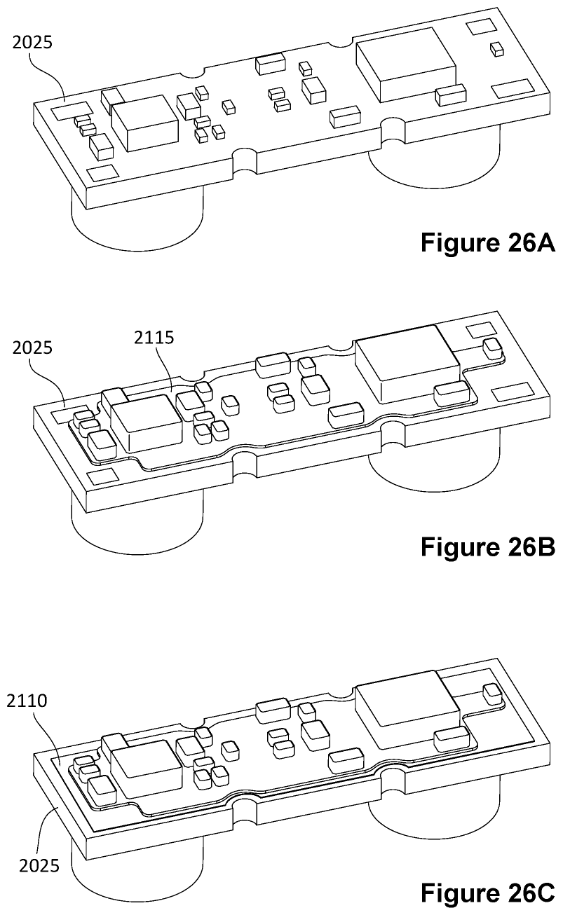

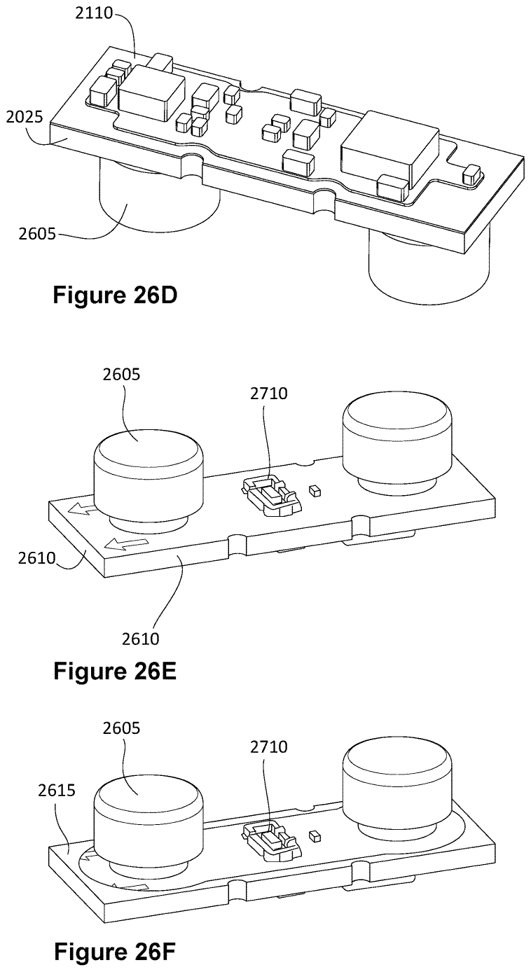

FIGS. 26A-26F illustrate a second process of applying a metal spray to at least one analog component and a circuit board. The second process of applying the metal spray is used to form another example of the second embodiment of a shielding system described above in reference to FIG. 21. FIG. 26A shows at least one analog component 2020 coupled with circuit board 2025. Additional information on the at least one analog component 2020 coupled with circuit board 2025 is provided above in reference to FIGS. 20-23B.

FIG. 26B shows application of an insulating layer on the at least one analog component 2020 and a portion of the circuit board 2025. In some embodiments, applying the insulating layer (e.g., insulative material 2115) includes masking four corners. The insulating layer is formed by at least one material. Different examples of the insulating material are provided above in reference to FIG. 21. In some embodiments, the thickness of the insulating layer is approximately 0.1 mm to 0.2 mm (approximately meaning+/−0.02 mm). In some embodiments, the insulating layer is applied via an insulative conformal spray coating.

FIG. 26C shows application of a conductive conformal spray coating on the at least one analog component 2020 and the portion of the circuit board 2025. The conductive conformal spray coating is analogous to the metallic spray described above in reference to FIGS. 21 and 25A-25D. The conductive conformal spray coating forms the EM shield 2110. Different examples of the conductive conformal spray coating are provided above in reference to FIG. 21. As shown in FIG. 26D in some embodiments, the conductive conformal spray coating is applied to the neuromuscular sensor 2605.

FIG. 26E illustrates a first bottom view of the circuit board with at least one coupled analog component. In FIG. 26E the conductive conformal spray coating is applied to the edges of the circuit board (e.g., edges 2610).

FIG. 26F illustrates a second bottom view of the circuit board with at least one coupled analog component. FIG. 26F shows an alternate application of the conductive conformal spray coating. In FIG. 26F, the conductive conformal spray coating is applied to a bottom portion 2615 of the circuit board.

In some embodiments, at least one analog component is embedded (i.e., housed) within a portion of the neuromuscular sensor. For example, the neuromuscular sensor can have a cavity and the at least one analog component can be housed within the cavity. In some embodiments, the at least one analog component is coupled with the same surface of the circuit board as the neuromuscular sensor.

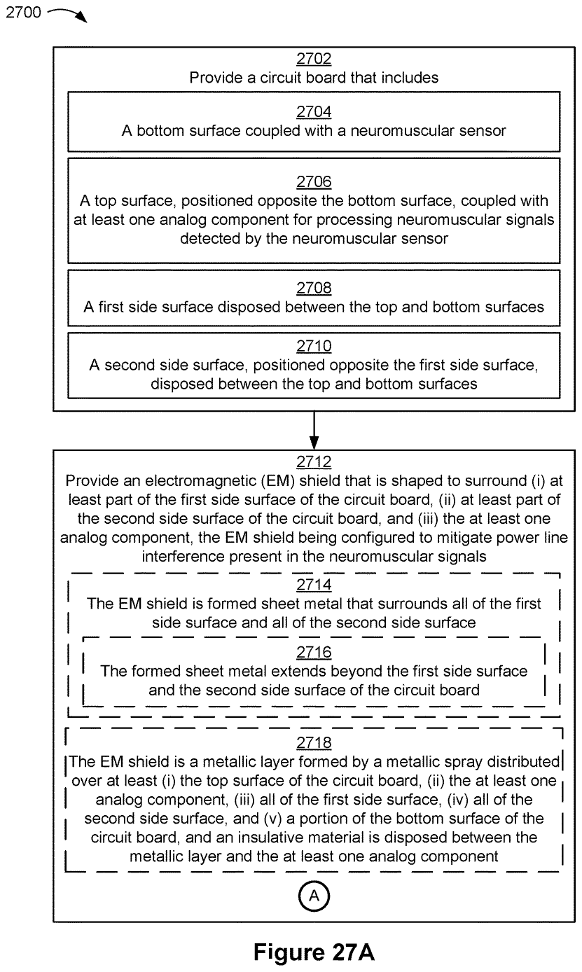

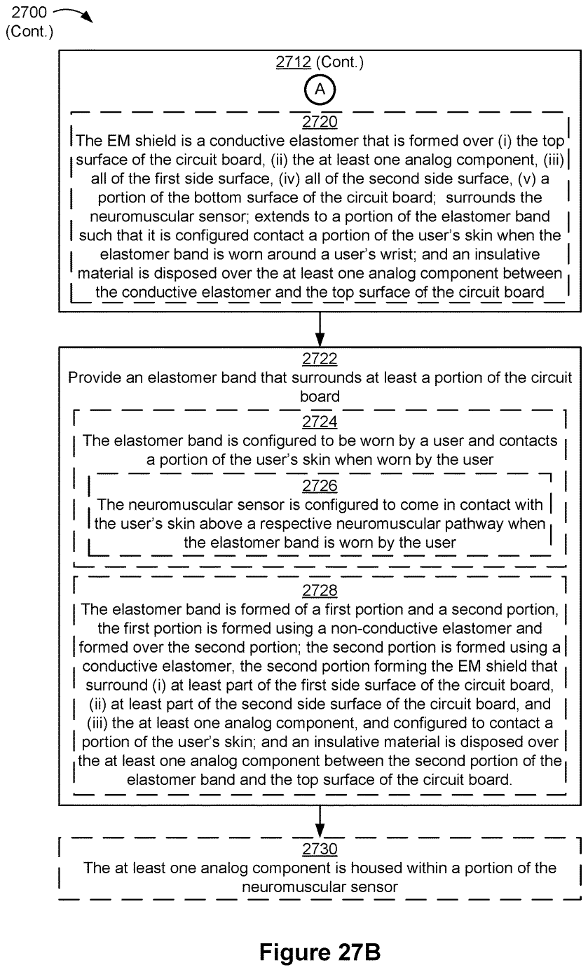

FIGS. 27A and 27B are flow diagrams illustrating a method of manufacturing a shielding system for a wearable device, in accordance with some embodiments. The shielding system (e.g., different shielding systems described above in reference to FIGS. 20-26F) is configured to shield components used to detect neuromuscular signals that cause motor actions to be performed by a user. Operations (e.g., steps) of the method 2700 can be performed in a different order. Some operations (e.g., steps) are optional and can be excluded.

The method 2700 includes providing (2702) a circuit board that includes a bottom surface (2704) coupled with a neuromuscular sensor; a top surface (2706), positioned opposite the bottom surface, coupled with at least one analog component for processing neuromuscular signals detected by the neuromuscular sensor; a first side surface (2708) disposed between the top and bottom surfaces; a second side surface (2710), positioned opposite the first side surface, disposed between the top and bottom surfaces.

The method 2700 further includes providing (2712) an electromagnetic (EM) shield that is shaped to surround at least part of the first side surface of the circuit board; at least part of the second side surface of the circuit board; and the at least one analog component, the EM shield being configured to mitigate power line interference present in the neuromuscular signals. In some embodiments, the EM shield is (2714) formed sheet metal that surrounds all of the first side surface and all of the second side surface. In some embodiments, the formed sheet metal extends (2716) beyond the first side surface and the second side surface of the circuit board.

In some embodiments, the EM shield is (2718) a metallic layer formed by a metallic spray distributed over at least the top surface of the circuit board; the at least one analog component; all of the first side surface; all of the second side surface; and a portion of the bottom surface of the circuit board. The method further includes providing an insulative material disposed between the metallic layer and the at least one analog component.

In some embodiments, the EM shield is (2720) a conductive elastomer that is formed over the top surface of the circuit board; the at least one analog component; all of the first side surface; all of the second side surface; a portion of the bottom surface of the circuit board. The conductive elastomer surrounds the neuromuscular sensor, extends to a portion of an elastomer band such that it is configured contact a portion of the user's skin when the elastomer band is worn around a user's wrist. The method further includes providing an insulative material disposed over the at least one analog component between the conductive elastomer and the top surface of the circuit board.

The method 2700 further includes providing (2722) an elastomer band (e.g., elastomer band 320 of a wearable device 110; FIGS. 3A and 3B) that surrounds at least a portion of the circuit board. In some embodiments, the elastomer band is (2724) configured to be worn by a user and contacts a portion of the user's skin when worn by the user. In some embodiments, the neuromuscular sensor is (2726) configured to come in contact with the user's skin above a respective neuromuscular pathway when the elastomer band is worn by the user.

In some embodiments, the elastomer band is (2728) formed of a first portion and a second portion. The first portion is formed using a non-conductive elastomer and formed over the second portion. The second portion is formed using a conductive elastomer and forming the EM shield that surround at least part of the first side surface of the circuit board; at least part of the second side surface of the circuit board; and the at least one analog component. The second portion is configured to contact a portion of the user's skin. The method further includes providing an insulative material disposed over the at least one analog component between the second portion of the elastomer band and the top surface of the circuit board.

In some embodiment, the at least one analog component is (2730) housed within a portion of the neuromuscular sensor (e.g., a cavity in the neuromuscular sensor). In some embodiments, one or more discrete components are built in the neuromuscular sensor. In some embodiments, the AFE is built in the neuromuscular sensor. Different examples of the shielding system are provided above in reference to FIGS. 20-26F.

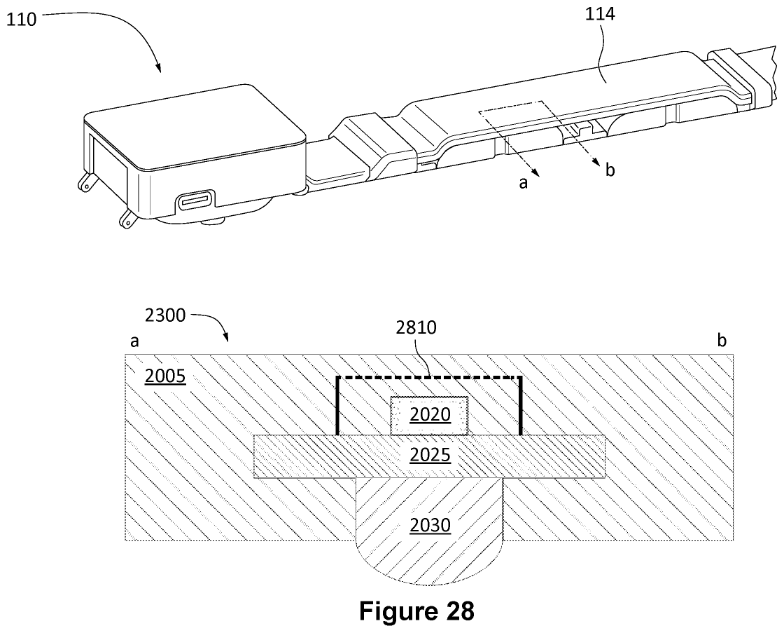

FIG. 28 illustrates a fifth embodiment of a system for shielding components used to detect neuromuscular signals, in accordance with various embodiments. The fifth embodiment 2800 of the shielding system can be included in any wearable device described above in reference to FIGS. 1A-19. The fifth embodiment 2800 of the shielding system is analogous to the first embodiment 2000. In some embodiments, as shown by the fifth embodiment 2800 the shielding system includes an EM shield 2810 with a plurality of openings or holes. The plurality of openings or holes allow for the elastomer band 2005 to enter or flow inside the EM shield 2810 when the elastomer of that is shaped to surround at least a portion of the circuit board 2025. In some embodiments, the pressure change caused by the flow of elastomer material entering the plurality of openings or holes does not cause deformation and/or a short of the at least one analog component 2020 and/or other electrical components on the circuit board 2025.

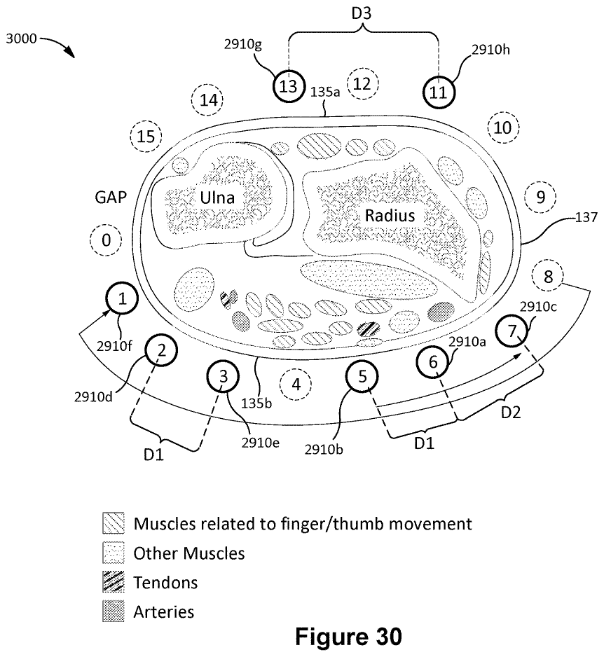

Now having described (i) intra-channel separation distances and inter-channel separation distances with the primary (but not only) example being a 6-channel arrangement of neuromuscular sensors, (ii) electrode shapes and designs that help achieve a stable impedance at a shallow skin-depression depth, and (iii) shielding designs/systems, attention will now be directed to a topology (e.g., selection of proper intra-channel and inter-channel separation distances around a circumference of a watch band or other wearable structure) that can be used for arranging neuromuscular sensors when an 8-channel arrangement is desired (e.g., to ensure that gestures such as a d-pad gesture can be more accurately detected). This discussion beings with FIG. 29, which is discussed first, followed by a discussion of FIGS. 30-35 in that order below.

FIG. 29 illustrates a first embodiment of an 8-channel wearable device for sensing neuromuscular signals in which the wearable device is worn around a user's wrist that is shown in cross-section in this figure, in accordance with various embodiments. More specifically, FIG. 29 illustrates a cross-section 2900 of a user's wrist (dorsal wrist portion 135a and ventral wrist portion 135b) and a position of one or more pairs of sensors (represented by reference numerals 2910a through 2910h, each pair including at least two electrodes 118 (FIGS. 1A-2D)) on the user's skin 137 when an 8-channel wearable device (e.g., an arm-wearable device) is worn by the user. Each pair of the one or more pairs of sensors forms a channel (e.g., channels 2, 3, 5-8, 11, and 13) for detecting neuromuscular signals as discussed below. Channels represented with dotted outlines (e.g., channels 0, 1, 4, 9, 10, 12, 14, and 15) are pairs of the one or more pairs of sensors that have been removed from wearable device (or which have been deactivated such that they can be present but are not turned on or otherwise being utilized for the sensing of neuromuscular signals). Because only a single side of the wearable structure is visible in FIG. 29, a single sensor of a pair of sensors is visible from the depicted viewpoint (e.g., 2910a through 2910h).

The first embodiment of the 8-channel wearable device is designed to improve anatomical conformity and improve comfort when worn by a user while providing accurate and reliable readings of detected neuromuscular signals. Further, the 8-channel wearable device is configured to improve the detection of neuromuscular signals associated with movement or actions performed by a user's thumb over the 6-channel wearable devices described as the primary (but not only) example above in reference to FIGS. 1-17. Similar to the wearable device described above in reference to FIGS. 2A-2D, the 8-channel wearable device includes a wearable structure configured to be worn by the user, the wearable structure having an interior surface that is configured to contact the user's skin 137 when the wearable device is donned by the user. The wearable structure can include a band portion 114, a capsule portion 112, and a cradle portion (not pictured) that is coupled with the band to allow for the capsule portion 112 to be removably coupled with the band portion 114 (FIGS. 1A-2D).

As shown in FIG. 29, a first subset of the one or more pairs of sensors are positioned along the dorsal wrist portion 135a (e.g., the seventh and eight pairs of sensors 2910g and 2910h) and a second subset of the one or more pairs of sensors are positioned along the ventral wrist portion 135b (e.g., the first through the sixth pairs of sensors 2910a-2910f). In some embodiments, the pairs of sensors of the first embodiment of the 8-channel wearable device include a first pair of sensors 2910a that is positioned near the interior surface of the wearable structure between a second pair of sensors 2910b and a third pair of sensors 2910c. The pairs of sensors of the first embodiment of the 8-channel wearable device can further include a fourth pair of sensors 2910d that is positioned near the interior surface of the wearable structure adjacent to a fifth pair of sensors 2910e. In some embodiments, a sixth pair of sensors 2910f is adjacent to the third pair of sensors 2910c. In some embodiments, seventh pair of sensors 2910g is positioned near a portion of an interior surface of the capsule 112 and an eighth pair of sensors 2910h is positioned near another portion of the interior surface of the capsule 112 adjacent to the seventh pair of sensors 2910g.

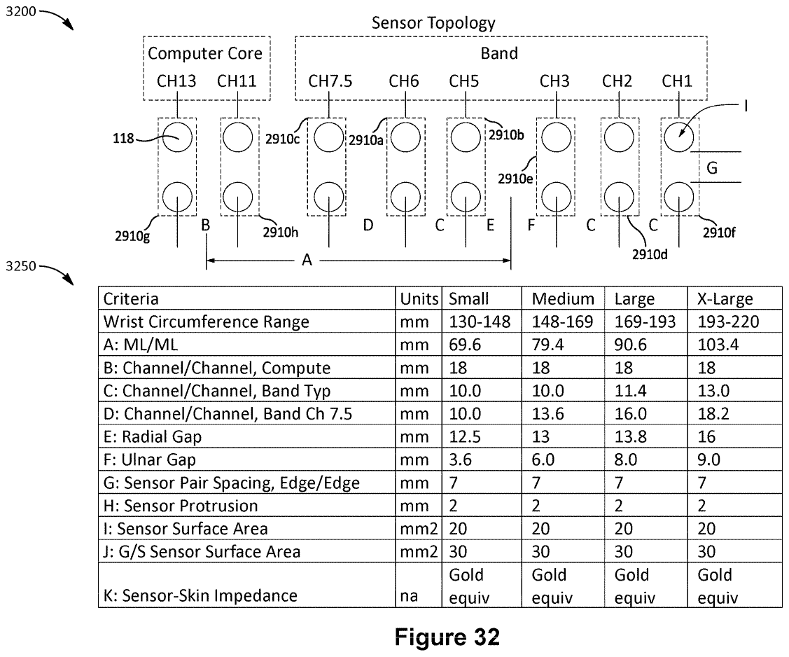

In some embodiments, the adjacent pairs of sensors (e.g., first and second pairs of sensors 2910a and 2910b) are separated along the interior surface of the wearable structure by a predetermined inter-channel separation distance. In some embodiments, the predetermined inter-channel separation distance is the same for one or more adjacent pairs of sensors (e.g., the predetermined inter-channel separation distance between 2910a and 2910b and between 2910c and 2910f are both D1). Alternatively, in some embodiments, the predetermined inter-channel separation distance is distinct between different adjacent pairs of sensors, as is the case for the depicted example of FIG. 29 since the inter-channel separation distance is greater between 2910a and 2910c (represented by D2) than it is between 2910a and 2910b (represented by D1) as well as 2910g and 2910g (represented by D3). For example, the predetermined inter-channel separation distance between the first and second pairs of sensors 2910a and 2910b can be less than the predetermined inter-channel separation distance between the first and third pairs of sensors 2910a and 2910c, which can help to ensure adequate placement of sensors over the depicted muscular groups within the rest while still allowing for a user of a smaller number (e.g., less than 14) of pairs of sensors. As depicted, the separation spacings and the omitted or turned-off sensor locations (e.g., positions 0, 1, 15, and 14) can be selected to ensure that there is sensor coverage over the muscular groups responsible for finger/thumb movements and to also avoid those areas around the circumference of the wrist where signals would need to travel through bone which can sometimes hinder detection accuracy levels (especially for smaller numbers of sensor pairs). Additional details on the predetermined inter-channel separation distances are provided below in reference to FIG. 32.

The different pairs of sensors of the first embodiment of the 8-channel wearable device are configured to detect neuromuscular signals (e.g., neuromuscular signals that travel through the neuromuscular pathways, muscle groups, tendons, and/or arteries within the user's wrist 135, as shown in FIG. 29). Additional information on the neuromuscular pathways is provided above in reference to FIG. 1C. As described above, the detected neuromuscular signals are used by one or more processors 1820 (FIG. 18) of the wearable device to determine a motor action that the user intends to perform with their hand.

FIG. 30 illustrates a second embodiment of an 8-channel wearable device for sensing neuromuscular signals, in accordance with various embodiments. FIG. 30 illustrates a cross-section 3000 of a user's wrist (dorsal wrist portion 135a and ventral wrist portion 135b) and a position of one or more pairs of sensors (represented by reference numerals 2910a through 2910h, each pair including at least two electrodes 118 (FIGS. 1A-2D)) on the user's skin 137 when an 8-channel wearable device (e.g., an arm-wearable device) is worn by the user. Each pair of the one or more pairs of sensors forms a channel (e.g., channels 2, 3, 5-8, 11, and 13) for detecting neuromuscular signals as discussed below. The second embodiment of the 8-channel wearable device is similar to the first embodiment of the 8-channel wearable device described in FIG. 29; however, the second embodiment of the 8-channel wearable device repositions the sixth pair of sensors 2910f along the ventral wrist portion 135b.

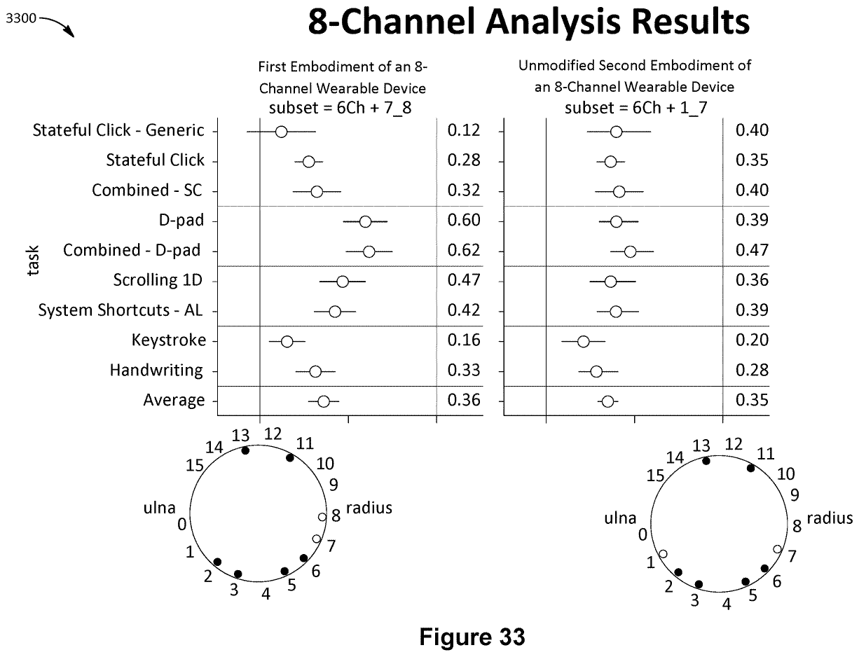

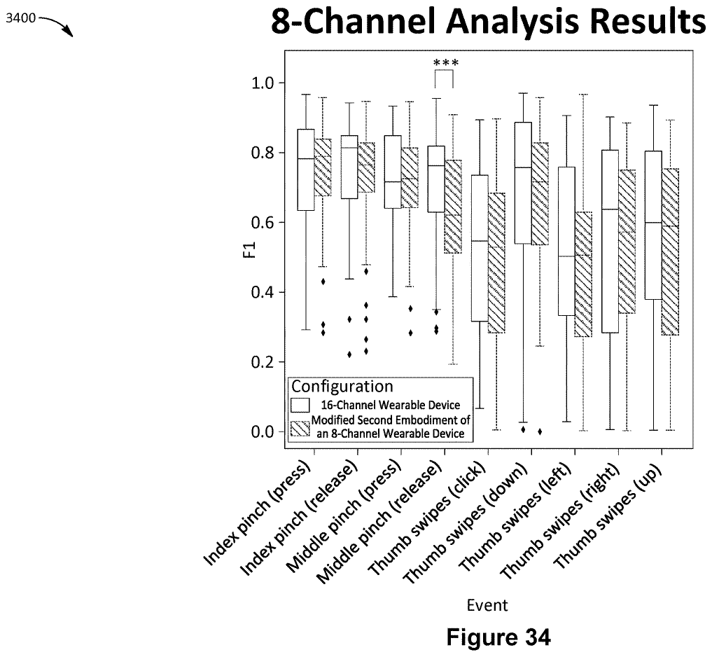

The adjusted position of the sixth pair of sensors 2910f further improves the anatomical conformity and comfort of the 8-channel wearable device when worn by the user by allowing the one or more pairs of sensors to be distributed symmetrically along the interior surface of the wearable structure. In some embodiments, the respective positions of the first, second, and/or third pairs of sensors 2910a, 2910b, and/or 2910c are left unchanged. Alternatively, in some embodiments, the respective positions of the first, second, and/or third pairs of sensors 2910a, 2910b, and/or 2910c are shifted or moved to the right (e.g., closer to the muscle groups near the Radius bone). The respective positions of the first, second, and/or third pairs of sensors 2910a, 2910b, and/or 2910c can be adjusted to improve the detection of neuromuscular signals (as described below in reference to FIGS. 33 and 34), improve user comfort, and/or anatomical conformity. Further, adjusting the position of the first, second, and/or third pairs of sensors 2910a, 2910b, and/or 2910c allows for the third pair of sensors 2910c to be positioned along what is described herein as a “channel 7.5” (as shown below in reference to FIG. 32), which has been determined by the inventors to further improve the detection of a user's thumb movements in relation to the first embodiment of the 8-channel wearable device described in FIG. 29 and the second embodiment of the 8-channel wearable device (without adjustments to the first, second, and/or third pairs of sensors 2910a, 2910b, and/or 2910c).

In some embodiments, the first and second pairs of sensors 2910a and 2910b are separated along the interior surface of the wearable structure by a first predetermined inter-channel separation distance (D1) and the first and third pairs of sensors 2910a and 2910c are separated by a second predetermined inter-channel separation distance (D2), distinct from the first predetermined inter-channel separation distance. In some embodiments, the first predetermined inter-channel separation distance is less than the second predetermined inter-channel separation distance. Alternatively, in some embodiments, the first predetermined inter-channel separation distance is the same as the second predetermined inter-channel separation distance. In some embodiments, the fourth and fifth pairs of sensors 2910d and 2910e are separated along the interior surface of the wearable structure by the first predetermined inter-channel separation distance and the fourth and sixth pairs of sensors 2910d and 2910f are also separated by the fifth predetermined inter-channel separation distance. In some embodiments, the seventh and eighth pairs of sensors 2910g and 2910h are separated along the interior surface of the capsule 112 (FIGS. 1A-2D) of the wearable structure by a third predetermined inter-channel separation distance (D3), distinct from the first and second predetermined inter-channel separation distances. Additional detail on the predetermined inter-channel separation distances is provided below in reference to FIG. 32.

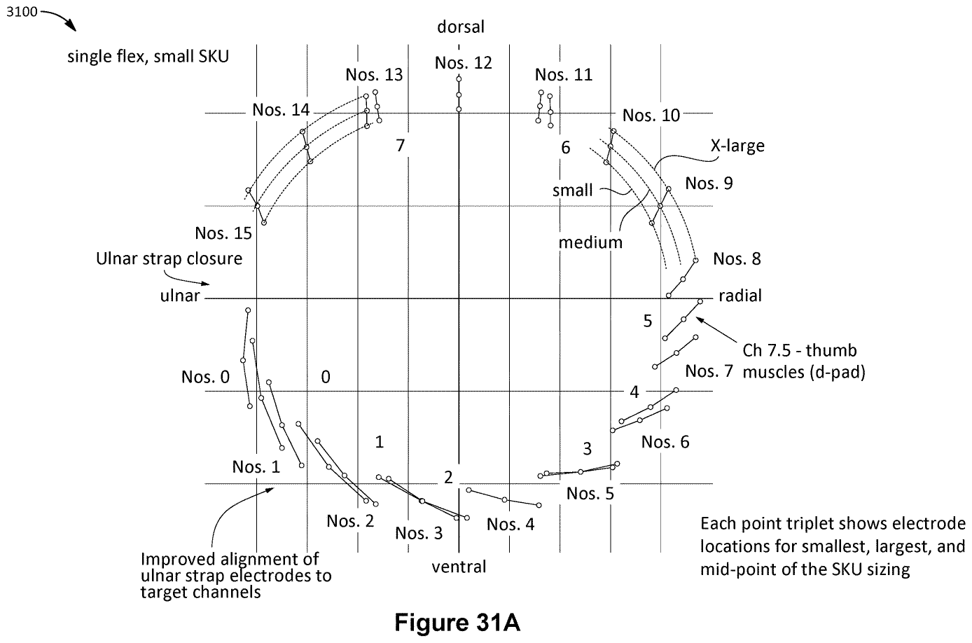

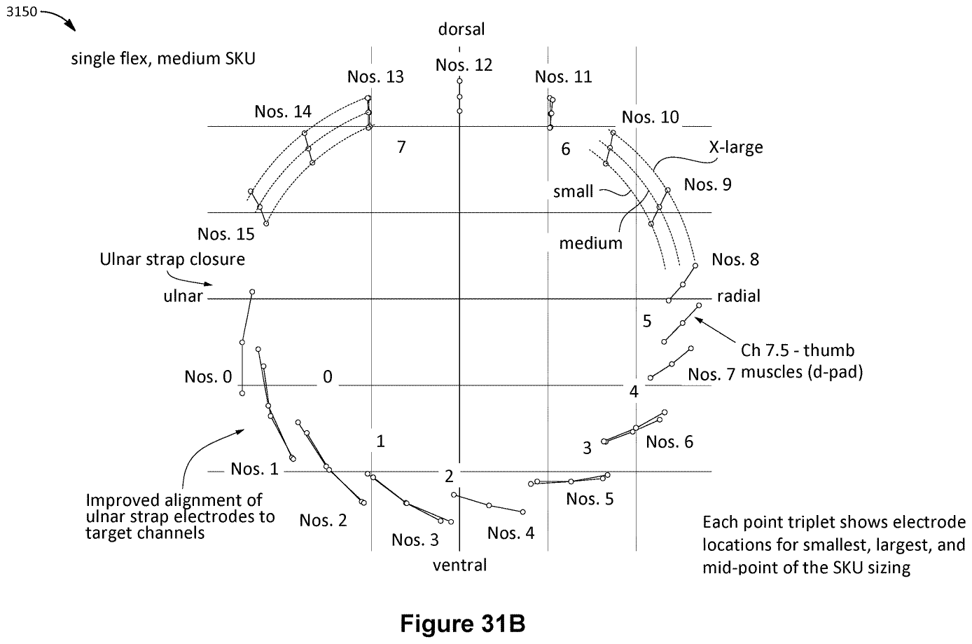

FIGS. 31A and 31B illustrate different sizes of an 8-channel wearable device for sensing neuromuscular signals and associated tolerances for relative positions of each of the sensor channels around the circumference of the wrist, in accordance with various embodiments. In particular, a first plot 3100 shows a small wristband including an 8-channel configuration and a second plot 3150 shows a medium wristband including an 8-channel configuration. Each point triplet shows sensor locations for smallest, largest, and mid-point of the wristband sizing (which can be adjustable or fixed sizes). For example, for the first plot 3100 shows the position of the sensors of the small wristband including an 8-channel when it is in its smallest size (e.g., strap fully tightened), its medium size (e.g., average or median tightening of the strap), or x-large size (e.g., strap in its release or largest position).

The different sizes of the 8-channel wearable device are configured to position the pairs of sensors over the same or substantially constant neuromuscular pathways (e.g., neuromuscular pathways and/or muscle groups shown in FIGS. 1C, 29, and 30) for different users having a substantially same wrist circumference size. By providing different fixed sizes of the 8-channel wearable device, the performance of 8-channel wearable device can be optimized for each user's wrist size, while still ensuring a high-level of gesture-detection accuracies. The different positions for the pairs of sensors are described below in reference to FIG. 32. It is also noted that the numbers (Nos. 0-15 in FIGS. 31A-31B) correspond to the use of those same numbers for the sensor channels in FIGS. 29-30 as well.

FIG. 32 illustrates sensor topology specification examples for an 8-channel wearable device for sensing neuromuscular signals, in accordance with various embodiments. FIG. 32 further shows a table 3250 defining one or more separation distances between one or more pairs of sensors 2910 (e.g., predetermined inter-channel separation distance measured from electrode center to electrode center across two adjacent sensor channels), separation distances between sensors within a pair of sensors (e.g., predetermined intra-channel separation distances between electrodes 118 withing a respective pair 2910 measured from adjacent edges of the electrodes of the respective pair 2910), average user wrist measurements, and other dimensions related to the sensor topology 3200.

As shown in FIG. 32 (and described above in reference to FIG. 30), in some embodiments, the pairs of sensors include a first pair of sensors 2910a that is positioned near the interior surface of the wearable structure of an 8-channel wearable device between a second pair of sensors 9210b and a third pair of sensors 2910c and a fourth pair of sensors 2910d that is positioned near the interior surface of the wearable structure of the 8-channel wearable device between a fifth pair of sensors 9210e and a sixth pair of sensors 2910f. The pairs of sensors further include a seventh pair of sensors 2910g that is positioned near a first portion of an interior surface of the capsule of the 8-channel wearable device and an eighth pair of sensors 2910h that is positioned near a second portion of the interior surface of the capsule of the 8-channel wearable device. The pairs of sensors are configured to detect neuromuscular signals, the detected neuromuscular signals are used by one or more processors of the 8-channel wearable device to determine a motor action that the user intends to perform with their hand.

In some embodiments, the first and second pairs of sensors 2910a and 2910b are separated along the interior surface of the wearable structure of the 8-channel wearable device by a first predetermined inter-channel separation distance (e.g., separation distance “C”) and the first and third pairs of sensors 2910a and 2910c are separated by a second predetermined inter-channel separation distance (e.g., separation distance “D”). In some embodiments, the first and second predetermined inter-channel separation distances are distinct. Alternatively, in some embodiments, the first and second predetermined inter-channel separation distances are the same (e.g. for small 8-channel wearable devices). In some embodiments, the first predetermined inter-channel separation distance is less than the second predetermined inter-channel separation distance. In some embodiments, the first predetermined inter-channel spacing range is between 10 mm and 13 mm and the second predetermined inter-channel spacing range is between 10 mm and 18.2 mm. In some embodiments, the fourth and fifth pairs of sensors 2910d and 2910e are separated along the interior surface of the wearable structure of the 8-channel wearable device by the first predetermined inter-channel separation distance and the fourth and sixth pairs of sensors 2910d and 2910f are separated by the first predetermined inter-channel separation distance. In some embodiments, the seventh and eight pairs of sensors 2910g and 2910h are separated along the interior surface of the capsule of the 8-channel wearable device by a third predetermined inter-channel separation distance (e.g., separation distance “B”), distinct from the first and second predetermined inter-channel separation distances. In some embodiments, the third predetermined inter-channel spacing range is 18 mm.

In some embodiments, the first, second, and third pairs of sensors 2910a, 2910b, and 2910c form a first group of sensors and the fourth, fifth, and sixth pairs of sensors 2910d, 2910e, and 2910f form a second group of sensors. The first and second groups of sensor are separated along the interior surface of the wearable structure of the 8-channel wearable device by a fourth predetermined inter-channel separation distance (e.g., separation distance “E” plus “F”), distinct from the first, second, and third predetermined inter-channel separation distances. More specifically, the fourth predetermined inter-channel separation distance is equal to the radial gap and the ulnar gap measured from the second pair of sensors 2910b and the fifth pair of sensors 2910e. In some embodiments, the fourth predetermined inter-channel spacing range is between 16.1 mm and 25 mm.

In some embodiments, the sensors of respective pairs of sensors 2910 are spaced apart within respective portions of the interior surface of the wearable structure by one predetermined intra-channel spacing range that applies to all of the respective pairs of sensors. In some embodiments, the predetermined intra-channel spacing range (e.g., separation distance “G”) is between 4 mm and 10 mm. In some embodiments, the predetermined intra-channel spacing range is 7 mm. Alternatively, in some embodiments, different pairs of sensors 2910 can have distinct separation distances between sensors.

Table 3250 further provides average wrist circumference ranges for the different sized of an 8-channel wearable device, a midline to midline distance (“A,” which defines the distance between the center of the seventh and eight pairs of sensors 2910g and 2910h and the center between the first and second groups of sensors), a sensor protrusion length, a sensor surface area, a ground and shield sensor (ground 120 and shield 210 as shown in FIG. 2D) surface area, an ulnar gap distance, and a radial gap distance. Although table 3250 includes measurements in relation to the second embodiment of an 8-channel wearable device with adjusted sensor positions, the same and/or similar values can be used for the second embodiment of an 8-channel wearable device without adjusted sensor positions and the first embodiment of an 8-channel wearable device.

FIG. 33 illustrates measured improvements in gesture-detection accuracies of different 8-channel wearable device configurations over a wearable device configuration that includes 6 pairs of sensors for sensing neuromuscular signals, in accordance with various embodiments. In particular, plot 3300 shows the improved performance of the first embodiment of an 8-channel wearable device (shown and described above in FIG. 29) over a wearable device with 6 channels and the improved performance of the second embodiment of an 8-channel wearable device (without adjusted sensor positions; shown and described above in FIG. 30) over a wearable device with 6 channels.

For example, the first embodiment of the 8-channel wearable device (on the left), shows an average improvement across the tested gesture samples shown in the plot of FIG. 33 over a 6-channel wearable device of 36 percent. In some embodiments, the first embodiment of the 8-channel wearable device has an improved detection of direction pad (D-pad) inputs of at least 60 percent over the over a 6-channels wearable device (a D-pad gesture can be a movement of the user's thumb on top of their index finger in a directional manner, e.g., up, down, left, right etc.). The second embodiment of the 8-channel wearable device (on the right) shows an average improvement over the 6-channel wearable device of 35 percent. In some embodiments, the second embodiment of the 8-channel wearable device has an improved detection of direction pad (D-pad) inputs of at least 39 percent over the over a 6-channels wearable device. While the second embodiment of the 8-channel wearable device has a lower average improvement over the 6-channel wearable device than the first embodiment of the 8-channel wearable device, the second embodiment of the 8-channel wearable device has improved consistency of gesture-detection improvements over a greater number of detectable inputs as compared to a 6-channel wearable device. For example, the second embodiment of the 8-channel wearable device has consistent improvement for detected click gestures and keystroke gestures over the first embodiment of the 8-channel wearable device.

FIG. 34 illustrates a comparison of the performance of a device with a small number of sensing channels (e.g., an 8-channel wearable device configuration) over a wearable device configuration that includes a larger number of sensing channels (e.g., 16 pairs of sensors for sensing neuromuscular signals), in accordance with various embodiments. More specifically, FIG. 34 shows a plot 3400 comparing the performance of the second embodiment of an 8-channel wearable device (with adjusted sensor positions such that a sensor is on channel 7.5, as shown and described above in FIG. 30) and a wearable device with 16-channels for detecting neuromuscular signals. Plot 3400 shows the relative F1 score (measure of a test's accuracy) of the wearable device with 16-channels and the second embodiment of an 8-channel wearable device. Although the wearable device with 16-channels performs better overall than the 8-channel wearable device, use of the 7.5 channel allows the 8-channel wearable device to perform with an F1 score within 0.1 of the wearable device with 16-channels. The second embodiment of the 8-channel wearable device with a pair of sensors on channel 7.5 allows for performance comparable to a wearable device with 16-channels while improving anatomical conformity and comfort of the wearable device when worn by a user.

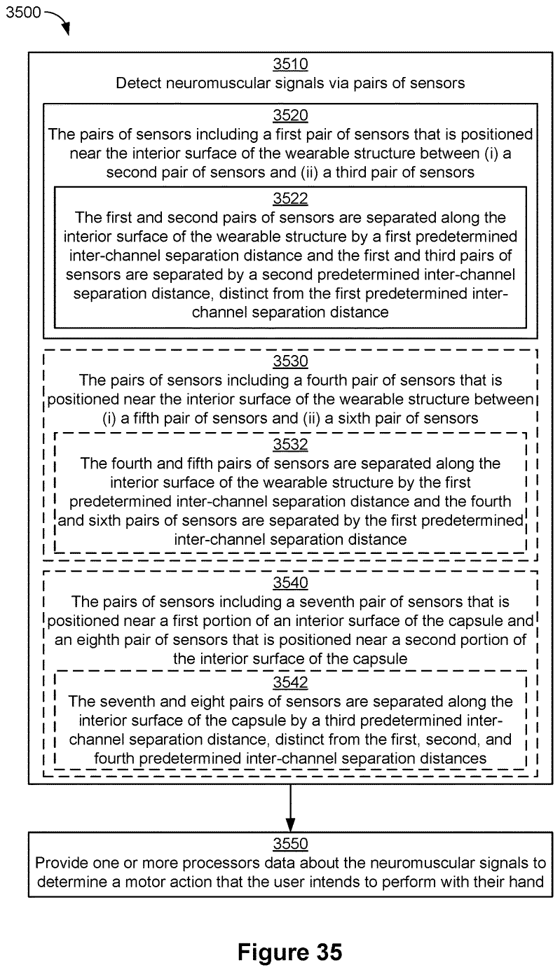

FIG. 35 is a flow diagram illustrating a method for sensing neuromuscular signals using pairs of sensors using an 8-channel wearable device, in accordance with some embodiments. Method 3500 is performed at a wearable device (e.g., arm-wearable device) for sensing neuromuscular signals using pairs of sensors. The wearable device includes a wearable structure configured to be worn by a user, the wearable structure having an interior surface that is configured to contact a user's skin when the wearable device is donned by the user. Operations (e.g., steps) of the method 3500 may be performed by one or more processors 1820 of a wearable device 110. At least some of the operations shown in FIG. 3500 correspond to instructions stored in a computer memory or computer-readable storage medium (e.g., memory 1830 of the wearable device 110). Operations 3510-3550 can also be performed in part using one or more processors of a computing device (e.g., a head-mounted display device can perform operations 3510-3550 alone or in conjunction with the one or more processors of the wearable device 110).

Method 3500 includes detecting (3510) neuromuscular signals via pairs of sensors. The pairs of sensors include (3520) a first pair of sensors that is positioned near the interior surface of the wearable structure between (i) a second pair of sensors and (ii) a third pair of sensors. The first and second pairs of sensors are (3522) separated along the interior surface of the wearable structure by a first predetermined inter-channel separation distance and the first and third pairs of sensors are separated by a second predetermined inter-channel separation distance, distinct from the first predetermined inter-channel separation distance. In some embodiments, the first predetermined inter-channel separation distance is less than the second predetermined inter-channel separation distance. In some embodiments, the first predetermined inter-channel spacing range is between 10 mm and 13 mm and the second predetermined inter-channel spacing range is between 10 mm and 18.2 mm. Additional information on the different separation distances is provided above in reference to FIG. 32.

In some embodiments, the pairs of sensors include (3530) a fourth pair of sensors that is positioned near the interior surface of the wearable structure between (i) a fifth pair of sensors and (ii) a sixth pair of sensors. In some embodiments, the fourth and fifth pairs of sensors are (3532) separated along the interior surface of the wearable structure by the first predetermined inter-channel separation distance and the fourth and sixth pairs of sensors are separated by the first predetermined inter-channel separation distance.

In some embodiment, the wearable device includes a capsule that forms a portion of the interior surface of the wearable structure such that, when the wearable structure is worn by the user, a portion of the capsule contacts the user's skin and the pairs of sensors include (3540) a seventh pair of sensors that is positioned near a first portion of an interior surface of the capsule and an eighth pair of sensors that is positioned near a second portion of the interior surface of the capsule. In some embodiments, the seventh and eight pairs of sensors are (3542) separated along the interior surface of the capsule by a third predetermined inter-channel separation distance, distinct from the first, second, and fourth predetermined inter-channel separation distances. In some embodiments, the third predetermined inter-channel spacing range is 18 mm. In some embodiments, the portion of the capsule that contacts the user's skin is the interior surface of the capsule, and the capsule further includes an exterior portion opposite the interior surface, the exterior portion including a display configured to present a user interface.

In some embodiments, the first, second, and third pairs of sensors are a first group of sensors and the fourth, fifth, and sixth pairs of sensors are a second group of sensors and the first and second groups of sensor are separated along the interior surface of the wearable structure by a fourth predetermined inter-channel separation distance, distinct from the first and second predetermined inter-channel separation distances. In some embodiments, the fourth predetermined inter-channel spacing range is between 16.1 mm and 25 mm.

In some embodiments, the sensors of respective pairs of sensors are spaced apart within respective portions of the interior surface of the wearable structure by one predetermined intra-channel spacing range that applies to all of the respective pairs of sensors. Alternatively, different pairs can have distinct separation distances between sensors. In some embodiments, the predetermined intra-channel spacing range is between 4 mm and 10 mm. In some embodiments, the predetermined intra-channel spacing range is 7 mm.

Method 3500 further includes providing (3550) one or more processors data about the neuromuscular signals to determine a motor action that the user intends to perform with their hand. In some embodiments, the data received about the neuromuscular signals from the predetermined number of pairs of sensors is used to determine, by the one or more processors, a motor action that the user intends to perform with their thumb. In some embodiments, the data received about the neuromuscular signals from the predetermined number of pairs of sensors is used to determine, by the one or more processors, an input at a virtual directional pad (d-pad), a virtual key stroke, a click gesture, and handwriting. In some embodiments, the pairs of sensors number eight pairs, and the one or more processors determine an input at the virtual d-pad with an improved accuracy of at least 47 percent over a configuration that includes 6 pairs of sensors for sensing neuromuscular signals. In some embodiments, the pairs of sensors number eight pairs, and the one or more processors determine a virtual key stroke with an improved accuracy of at least 20 percent over a configuration that includes 6 pairs of sensors for sensing neuromuscular signals. In some embodiments, the pairs of sensors number eight pairs, and the one or more processors determine a click gesture with an improved accuracy of at least 40 percent over a configuration that includes 6 pairs of sensors for sensing neuromuscular signals. In some embodiments, the pairs of sensors number eight pairs, and the one or more processors determine handwriting with an improved accuracy of at least 28 percent over a configuration that includes 6 pairs of sensors for sensing neuromuscular signals. Sample improvements of the 8-channel wearable device configuration are provided above in reference to FIGS. 33 and 34.

Although the examples provided with reference to FIGS. 1A-2D and 8-9C, FIGS. 19A and 19B and FIGS. 29-34 are discussed in the context of interfaces with EMG sensors, examples may also be implemented in control devices, such as wearable interfaces, used with other types of sensors including, but not limited to, mechanomyography (MMG) sensors, sonomyography (SMG) sensors, and electrical impedance tomography (EIT) sensors. The approaches described herein may also be implemented in wearable interfaces that communicate with computer hosts through wires and cables (e.g., USB cables, optical fiber cables).

Further embodiments also include various subsets of the above embodiments including embodiments in FIGS. 1A-35 combined or otherwise re-arranged.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A wearable device to detect neuromuscular signals from a user, the wearable device comprising:
a wearable structure configured to be worn around a user's limb; and
a plurality of electrode sets coupled to the wearable structure and configured to detect neuromuscular signals, wherein electrodes of each electrodes set are spaced apart along a widthwise segment of the wearable structure by a center-to-center intra-channel separation distance less than or equal to 9 mm and are configured to provide a neuromuscular signal sensing channel.

2. The wearable device of claim 1, wherein the intra-channel separation distance is less than or equal to 7 mm.

3. The wearable device of claim 1, wherein the intra-channel separation distance is the same for each electrode set.

4. The wearable device of claim 1, wherein the intra-channel separation distance is distinct for at least two electrode sets of the plurality of electrode sets.

5. The wearable device of claim 1, wherein the plurality of electrode sets includes six electrode sets.

6. The wearable device of claim 1, wherein the plurality of electrode sets includes eight electrode sets.

7. The wearable device of claim 1, wherein two adjacent electrode sets of the plurality of electrode sets are spaced apart by an inter-channel separation distance.

8. The wearable device of claim 7, wherein the inter-channel separation distance is between 10 mm to 16 mm.

9. The wearable device of claim 1, the wearable structure comprising:
a band comprising an interior surface configured to be in contact with a user's skin, wherein at least a portion of the electrode sets are coupled to the band of the wearable structure.

10. The wearable device of claim 9, the wearable structure comprising:
a capsule housing a compute core, wherein the compute core is configured to process neuromuscular signals from the plurality of electrode sets and at least a portion of the electrode sets are coupled to the capsule of the wearable structure.

11. The wearable device of claim 10, wherein two electrode sets of the plurality of electrode sets are coupled to the capsule.

12. The wearable device of claim 11, wherein the two electrode sets coupled to the capsule are spaced apart by a capsule inter-channel separation distance of approximately 18 mm.

13. The wearable device of claim 10, further comprising:
a ground electrode coupled to the capsule; and
a shield electrode coupled to the capsule and spaced apart from the ground electrode by an additional intra-channel separation distance greater than the intra-channel separation distance.

14. The wearable device of claim 13, wherein the additional intra-channel separation distance is between 15 mm and 30 mm.

15. The wearable device of claim 1, wherein each electrode of the plurality of electrode sets includes a spherical cap.

16. A wearable device to detect neuromuscular signals from a user, the wearable device comprising:
a wearable structure configured to be worn around a user's limb; and
a plurality of electrode sets coupled to the wearable structure and configured to detect neuromuscular signals, the plurality of electrode sets comprising:
a first group of electrode sets; and
a second group of electrode sets spaced apart from the first group of electrode sets, wherein electrodes of each electrodes set are spaced apart by an intra-channel separation distance less than or equal to 9 mm and are configured to provide a neuromuscular signal sensing channel.

17. The wearable device of claim 16, wherein two adjacent electrode sets of the plurality of electrode sets are spaced apart by an inter-channel separation distance.

18. The wearable device of claim 17, wherein the inter-channel separation distance is between 10 mm to 16 mm.

19. A wearable device to detect neuromuscular signals from a user, the wearable device comprising:
a wearable structure configured to be worn around a user's limb;
a first electrode pair coupled to the wearable structure and configured to detect neuromuscular signals, wherein electrodes of the first electrode pair are spaced apart by a first intra-channel separation distance less than or equal to 9 mm; and
a second electrode pair coupled to the wearable structure and configured to detect neuromuscular signals, wherein electrodes of the second electrode pair are spaced apart by a second intra-channel separation distance less than or equal to 9 mm and distinct from the first intra-channel separation distance.

20. The wearable device of claim 19, wherein the first and second electrode pairs are spaced apart by an inter-channel separation distance between 10 mm to 16 mm.
